(19) United States
(12) Patent Application Publication
(10) Pub. No.: US 2022/0387248 A1
(43) Pub. Date: Dec. 8, 2022

(54) EXTERNAL COUNTERPULSATION DEVICE

(71) Applicant: Life Pulse LLC, Orrville, OH (US)

(72) Inventors: David Anthony Pickett, Orrville, OH (US); James Russell Lusk, Costa Mesa, CA (US)

(21) Appl. No.: 17/776,189

(22) PCT Filed: Nov. 12, 2020
(86) PCT No.: PCT/US2020/060269

§ 371 Date: May 11, 2022

Related U.S. Application Data
(60) Provisional application No. 62/934,993, filed on Nov. 13, 2019.

(51) Int. Cl. A61H 9/00; A61H 31/00

(52) U.S. Cl. CPC A61H 9/0078; A61H 31/004; A61H 2201/0103

(57) ABSTRACT

Disclosed herein are systems, methods, and device for performing external counterpulsation. The external counterpulsation device can include a cuff including a body, a first end, and a second end. In some examples, the external counterpulsation device includes a removable tubular connector, a removably attached bladder, and a securing material extending across a length of the body of the cuff. The external counterpulsation device also includes a u-shaped buckle having a first arm, a second arm, and an opening. The first arm is configured to extend through the opening of the first end of the cuff and the second arm is configured to form a roller. The opening of the buckle is formed between the first arm and the second arm and is configured to allow the body of the cuff to extend through the u-shaped buckle.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

This disclosure relates to external counterpulsation devices configured to provide medical and therapeutic treatments. In certain embodiments, this disclosure relates to systems and methods for external counterpulsation treatments.

### Description of the Related Art

Cardiac disease remains a significant health problem in the United States and in the world. A 2010 Update of the Heart and Disease and Stroke Statistics found that approximately 10.2 million people in the United States alone suffer from angina pain where conventional treatment such as surgical or medicinal treatment no longer provides any benefit. Despite enormous advances in medical therapy and revascularization procedures, a growing number of patients with stable angina pectoris struggle to cope with disabling symptoms caused by myocardial ischemia. Refractory angina (RA) is defined as a persistent painful condition characterized by the presence of coronary artery disease (CAD) that is resistant to medical therapy, percutaneous interventions and bypass surgery. This refractoriness is due to diffuse atherosclerosis, prior surgical procedures, lack of conduits, and comorbidities such as chronic kidney disease, heart failure and diabetes. RA affects 1.0-1.8 million people in the US and results in poor quality of life, restricted daily activities and psychological distress. These patients also have increased rates of hospitalization with an annual economic burden of ˜$22,000 per person.

Although there are a variety of pharmacological and interventional therapies to treat cardiac disease, many patients are not adequately helped by traditional treatments. In particular, the impaired health of many cardiac disease patients create a substantial risk of morbidity and mortality for interventional therapies such as coronary bypass surgery. Unsuitable coronary anatomy, prior revascularization attempts or other comorbid conditions may still preclude less-invasive therapies such as percutaneous transluminal coronary angioplasty and stent(s). Thus, the development of non-invasive therapies may provide additional health benefits to patient populations that cannot tolerate or have gained limited benefits from traditional treatments.

External counterpulsation (ECP) is a technique that has demonstrated effectiveness in treating angina and potentially congestive heart failure (CHF). ECP is an outgrowth of research from the 1950's directed at augmenting the low cardiac output of patients with advanced cardiac disease. External counterpulsation is a noninvasive procedure whereby cuffs are placed around the lower, and infrequently upper, extremities of the body. The cuffs are then inflated during the filling phase (diastole) of the heart, and rapidly deflated during and commonly before the contractile (systole) phase. ECP acts similar to an intra-aortic balloon pump by administering a strong pressure (200-350 mmHg) pulse via external blood pressure cuffs during diastole. This translates into increased coronary blood flow during diastole and over time, stimulates the formation of new collateral vessels. During the filling or diastolic phase of the heart, the chambers of the heart are passively filled with venous blood before the next contraction. By rapidly inflating the cuffs during diastole, venous pressure is increased in the peripheral regions of the body and venous blood return to the heart is enhanced. This increased ventricular filling or preloading results in an increased ejection fraction of blood from the ventricles during the next systolic phase, which can enhance the cardiac output. Increased arterial pressure during diastole may also enhance filling of the coronary arteries. The rapid deflation of the cuffs during the period of systole or contraction lowers the peripheral vascular resistance (PVR) which the heart pumps against and further enhances cardiac output. A reduction in PVR lessens the workload of an impaired heart by decreasing the effort used to maintain the forward flow of blood. To further enhance limb compression, portions of the limbs may be compressed sequentially from the distal limbs to the proximal limbs, rather than all portions simultaneously, to increase venous return of blood to the heart. The synchronization of inflation and deflation with the resting and contractile phases of the heart has been shown to increase blood flow to many vascular beds, including the coronary arteries. Furthermore, by increasing the diastolic pressure component of the mean perfusion pressure of the body tissues, the systolic pressure component used to maintain mean perfusion pressure may be reduced to further lowering the workload of the heart, and improving perfusion to the body other than specifically the heart. When external counterpulsation is performed, plethysmographic tracings of the blood pressure waveform will show a decrease in the systolic peak and an increase in the diastolic peak. A diastolic-to-systolic effectiveness ratio, calculated by dividing the peak diastolic amplitude by the peak systolic amplitude, is commonly used to measure the hemodynamic changes induced by external counterpulsation.

Interestingly, although the standard ECP treatment consists of thirty-five hours of treatment over seven weeks, the benefits of ECP persist beyond the thirty-five hours during which ECP is applied to a patient and may benefit more than just the cardiovascular system. It has been hypothesized that the limited duration of enhanced blood flow may increase the shear stress in the endothelial walls of the vasculature. Shear stress is considered a major stimulus for angiogenesis and may upregulate the production of growth factors such as Vascular Endothelial Growth Factor and Hepatocyte Growth Factor. This shear stress also increases endothelial release of nitric oxide, which may have vasodilatory, anti-platelet, anti-thrombotic, anti-proliferative and anti-inflammatory effects on the vasculature. Research also suggests that nitric oxide may have beneficial antioxidant effects. Several clinical trials have provided evidence that ECP is both safe and efficacious in ameliorating angina pectoris, long-term left ventricular function, exercise capacity, and quality of life over a period of five years post-therapy. ECP also substantially decrease total annual hospitalization rates with significant projected cost savings.

Despite these clinical benefits, provider preference and patient compliance remains suboptimal. Existing ECP systems are uncomfortable to the patient, noisy, large, heavy, and complicated to operate. Patients who require existing ECP systems are frequently fragile with reduced mobility due to age or heart-related condition. The procedure is painful because of the high pressure required to create retrograde flow. The uncomfortable characteristics inherent in existing ECP treatments also further reduces patient's treatment compliance (i.e., failure to complete the required number of treatments) and many patients fail to complete the full number of recommended sessions (e.g., a thirty-five session procedure). It is not uncommon for a patient to discontinue treatment because of discomfort or the inconvenience of traveling to a treatment location. As well, the size of existing devices and the size of the bulky equipment (i.e., 550 lbs) limits ECP use to specialized centers and space restrictions in the primary care setting.

The embodiment described herein permits a more comfortable treatment, a physically smaller system, and an ability to conduct treatments at a patient's home. These benefits increases treatment compliance reduces healthcare costs, reduces dependence on angina related drugs, reduces hospital visits, and improves a patient's health and quality of life.

### SUMMARY

Embodiments for a method for performing external counterpulsation are provided. The method comprises providing an external counterpulsation device having a first compression member, a second compression member, and a third compression member, and a compression member controller. The method further comprises attaching the first compression member, the second compression member, and the third compression member to three different portions of a body of a patient. The method comprises compressing the first compression member and compressing the second compression member. The method includes discontinuing compression of the first compression member while continuing compressing the second compression member. The third compression member is compressed. The method includes compressing the third compression member. Compression of the second compression member is discontinued while continuing compressing the third compression member.

In some embodiments, the external counterpulsation device comprises a physiological sensor. The method may comprise sensing heart activity in the patient. Compression of the first, second, and third compression members may occur in synchrony with the heart activity of the patient.

Embodiments of a method for performing external counterpulsation are provided. The method comprises providing an external counterpulsation device having a plurality of compression members and a compression member controller. The method includes attaching the compression members to a body of a patient. The method comprises compressing a first compression member of the plurality of compression members and compressing a second compression member of the plurality of compression members. The method comprises discontinuing compression of the first compression member while continuing compressing the second compression member. In an embodiment, one compression member may be placed in the area immediately just above and behind the knee and a second member in the upper inguinal area of the upper thigh. At least one study performed by the inventors show this location can achieve equivalent diastolic-to-systolic effectiveness ratio using lower pressure when compared to an existing FDA cleared external counter pulsation device; though the study did not include the exact technologies described herein.

In some embodiments, a method for performing external counterpulsation is disclosed. In some examples, the method can include providing an external counterpulsation apparatus having a first compression member, a second compression member, and a third compression member. In some examples, the method can include attaching the first compression member, the second compression member, and the third compression member to three treatment locations on a patient. In some examples, the method can include pressurizing the first compression member for a first period of time. In some examples, the method can include depressurizing the first compression member for a second period of time and pressurizing the second compression member for a third period of time, wherein the second period of time is longer than the first period of time. In some examples, the method can include depressurizing the second compression member for a fourth period of time and pressurizing the third compression member, wherein the fourth period of time is longer than the third period of time. In some examples, the method can include depressurizing the third compression member for a fifth period of time.

In other embodiments, the method for performing external counterpulsation is configured such that pressurizing the second compression member can occur while the first compression member is pressurized, and wherein the third period of time of pressurizing the second compression member overlaps more with the second period of time of depressurizing the first compression member than the first period of time of pressurizing the first compression member.

In other embodiments, the method for performing external counterpulsation is configured such that pressurizing the third compression member can occur while the second compression member is pressurized, and wherein the fifth period of time of pressurizing the third compression member overlaps more with the fourth period of time of depressurizing the second compression member than the third period of time of pressurizing the second compression member.

In other embodiments, the method for performing external counterpulsation is configured such that pressurizing the second compression member can overlap with the first period of time of pressurizing the first compression member and with the fifth period of time of pressurizing the third compression member.

In other embodiments, the method for performing external counterpulsation is configured such that at least two of the first, second, and third compression members are pressurized at the same time, and wherein at least two of the first, second, and third compression members are depressurized at the same time.

In some embodiments, a method for performing external counterpulsation is disclosed. The method for performing external counterpulsation can include providing an external counterpulsation apparatus having at least one compression member and a blood pressure monitor. In some examples, the method can include activating the blood pressure monitor to obtain a measured diastolic pressure and a measured systolic pressure of the patient. In some examples, the method can include storing the measured diastolic pressure and the measured systolic pressure. In some examples, the method can include preloading the at least one compression member to a pressure less than or equal to the measured diastolic pressure. In some examples, the method can include pressurizing the at least one compression member to a treatment pressure approximately equal to the measured systolic pressure.

In other embodiments, in the method for performing external counterpulsation, the blood pressure monitor is integrated with the external counterpulsation apparatus. In other embodiments, in the method for performing external counterpulsation, the blood pressure monitor is integrated into the at least one compression member. In other embodiments, in the method for performing external counterpulsation, the blood pressure monitor is external to the counterpulsation apparatus.

In some embodiments, a method for performing external counterpulsation is disclosed. In some examples, the method can include providing an external counterpulsation apparatus having a first compression member, a second compression member, and a third compression member. In some examples, the method can include attaching the first compression member to a first location on a patient. In some examples, the method can include attaching the second compression member to a second location on the patient. In some examples, the method can include attaching the third compression member to a third location on the patient, wherein the first location is more proximal to the heart than the second location, and wherein the second location is more proximal to the heart than the third location. In some examples, the method can include inflating the first compression member to a first pressure. In some examples, the method can include inflating the second compression member to the first pressure. In some examples, the method can include inflating the third compression member to the first pressure. In some examples, the method can include deflating the first compression member. In some examples, the method can include deflating the second compression member. In some examples, the method can include deflating the third compression member. In some embodiments, the above described inflating of the plurality of the compression members and the deflating of the compression members in succession is configured to produce an antegrade flow.

In other embodiments, in the method for performing external counterpulsation, the first location of the first compression member is at an upper thigh. In other embodiments, in the method for performing external counterpulsation, the second location of the second compression member is at a lower thigh. In other embodiments, in the method for performing external counterpulsation, the third location of the third compression member is at a calf. In other embodiments, in the method for performing external counterpulsation, the third location of the third compression member is at the buttocks. In other embodiments, in the method for performing external counterpulsation, at least one of the compression members is attached to the groin and at least one of the compression members is attached behind the knee.

In other embodiments, the method for performing external counterpulsation can include partially inflating the first compression member, second compression member, and third compression member to a pressure at or below a measured diastolic pressure. In other embodiments, the method for performing external counterpulsation can include inflating the third compression member to a second pressure. In other embodiments, the method for performing external counterpulsation can include inflating the second compression member to the second pressure. In other embodiments, the method for performing external counterpulsation can include inflating the first compression member to the second pressure. In other embodiments, the method for performing external counterpulsation can include deflating the third compression member. In other embodiments, the method for performing external counterpulsation can include deflating the second compression member. In other embodiments, the method for performing external counterpulsation can include deflating the first compression member.

In other embodiments, in the method for performing external counterpulsation, the first pressure is greater than the second pressure. In other embodiments, the method for performing external counterpulsation is used during cardiopulmonary resuscitation.

In some embodiments, a method for performing external counterpulsation is disclosed. The method for performing external counterpulsation can include providing an external counterpulsation apparatus having a first compression member, a second compression member, and a third compression member. In some examples, the method can include attaching the first compression member to a first location on a patient. In some examples, the method can include attaching the second compression member to a second location on the patient. In some embodiments, the method can include attaching the third compression member to a third location on the patient, wherein the first location is more distal to the heart than the second location, and wherein the second location is more distal to the heart than the third location. In some examples, the method can include partially inflating the first compression member, second compression member, and third compression member to a pressure at or below a measured diastolic pressure. In some examples, the method can include inflating the first compression member. In some examples, the method can include inflating the second compression member. In some examples, the method can include inflating the third compression member. In some examples, the method can include deflating the first compression member. In some examples, the method can include deflating the second compression member. In some examples, the method can include deflating the third compression member.

In other embodiments, in the method for performing external counterpulsation, the first location of the first compression member is at a calf. In other embodiments, in the method for performing counterpulsation, the first location of the first compression member is at the buttocks. In other embodiments, in the method for performing external counterpulsation, the second location of the second compression member is at a lower thigh. In other embodiments, in the method for performing external counterpulsation, the third location of the third compression member is at an upper thigh. In other embodiments, in the method for performing external counterpulsation, the method is used during cardiopulmonary resuscitation. In other embodiments, the method for performing external counterpulsation can include monitoring a patient's blood pressure to obtain a measured diastolic pressure.

In some embodiments, an external counterpulsation device is disclosed. In some examples, the external counterpulsation device can include a cuff comprising a body, a first end, and a second end, wherein the first end comprises an opening extending along an end of the cuff. In some examples, the external counterpulsation device can include an opening extending through the body of the cuff. In some examples, the external counterpulsation device can include a tubular connector having a first end and a second end and configured to extend through the opening, wherein the first end of the tubular connector is configured to be removably attached to a bladder; wherein the second end of the tubular connector is configured to be removably attached to an external fluid source; and wherein the tubular connector is configured to provide a fluid connection between the bladder and the external fluid source. In some examples, the external counterpulsation device can include a securing material extending across a length of the body of the cuff. In some examples, the external counterpulsation device can include a u-shaped buckle having a first arm, a second arm, and an opening, wherein the first arm is configured to extend through the opening of the first end of the cuff, wherein the second arm is configured to form a roller, wherein the opening is formed between the first arm and the second arm, and the opening is configured to allow the body of the cuff to extend through the u-shaped buckle.

In other embodiments, in the external counterpulsation device, the second end of the cuff further comprises a handle. In other embodiments, in the external counterpulsation device, at least the tubular connector, bladder, and buckle are removable. In other embodiments, in the external counterpulsation device, the cuff is washable or made of biodegradable materials, or recyclable materials, so as to be disposable and compatible with the environment. In other embodiments, in the external counterpulsation device, the first arm is retained within the opening of the first end of the cuff by a removable securing portion. In other embodiments, in the external counterpulsation device, the removable securing portion is threaded to a first end of the first arm. In other embodiments, in the external counterpulsation device, the removable securing portion is friction fit to a first end of the first arm.

In some embodiments, a method for performing external counterpulsation on a patient is disclosed. In some examples, the method for performing external counterpulsation can include providing an external counterpulsation apparatus having a first compression member, a second compression member, and a third compression member. In some examples, the method for performing external counterpulsation can include attaching the first compression member on a lower thigh of the patient, attaching the second compression member on an upper thigh of the patient, and attaching the third compression member on a buttock of the patient. In some examples, the method for performing external counterpulsation can include pressurizing the first compression member for a first period of time. In some examples, the method for performing external counterpulsation can include depressurizing the first compression member for a second period of time and pressurizing the second compression member for a third period of time, wherein the second period of time is longer than the first period of time. In some examples, the method for performing external counterpulsation can include depressurizing the second compression member for a fourth period of time and pressurizing the third compression member, wherein the fourth period of time is longer than the third period of time. In some examples, the method for performing counterpulsation can include depressurizing the third compression member for a fifth period of time.

In other embodiments, in the method for performing external counterpulsation, pressurizing the second compression member can occur while the first compression member is pressurized, and the third period of time of pressurizing the second compression member overlaps more with the second period of time of depressurizing the first compression member than the first period of time of pressurizing the first compression member. In other embodiments, in the method for performing external counterpulsation, pressurizing the third compression member can occur while the second compression member is pressurized, and the fifth period of time of pressurizing the third compression member overlaps more with the fourth period of time of depressurizing the second compression member than the third period of time of pressurizing the second compression member. In other embodiments, in the method for performing external counterpulsation, pressurizing the second compression member can overlap with the first period of time of pressurizing the first compression member and with the fifth period of time of pressurizing the third compression member. In other embodiments, in the method for performing external counterpulsation, at least two of the first, second, and third compression members are pressurized at the same time, and at least two of the first, second, and third compression members are depressurized at the same time. In other embodiments, in the method for performing external counterpulsation, a first delay interval exists between sequential inflation of the first compression member, a second delay interval exists between sequential inflation of the second compression member, and a third delay interval exists between sequential inflation of the third compression member. In other embodiments, in the method for performing external counterpulsation, at least one of the first delay interval, the second delay interval, and the third delay interval is a percentage of the patient's heartrate. In other embodiments, in the method for performing external counterpulsation, at least one of the first delay interval, the second delay interval, and the third delay interval changes with a decrease or increase of the patient's heartrate. In other embodiments, in the method for performing external counterpulsation, the patient has a heart rate less than 90 beats per minute. In other embodiments, in the method for performing external counterpulsation the pressurization of the first compression member is to a pressure less than 240 mmHg. In other embodiments, in the method for performing external counterpulsation, the pressurization of the second compression member is to a pressure less than 240 mmHg. In other embodiments, in the method for performing external counterpulsation, the pressurization of the third compression member is to a pressure less than 240 mmHg.

In some embodiments, an external counterpulsation system for performing external counterpulsation on a patient is disclosed. In some examples, the external counterpulsation system can include a plurality of cuffs, wherein each of the plurality of cuffs comprises at least one bladder. In some examples, the external counterpulsation system can include an air compressor configured to pressurize each of the at least one bladder. In some examples, the external counterpulsation system can include at least one air tank fluidly connected to the air compressor. In some examples, the external counterpulsation system can include a pod fluidly connected to the air compressor comprising. In some examples, the pod of the external counterpulsation system can include a plurality of valves. In some examples, the pod of the external counterpulsation system can include a plurality of connectors, wherein each of the plurality of connectors is fluidly connected to one of the plurality of valves. In some examples, the pod of the external counterpulsation system can include a plurality of hoses, wherein each of the plurality of hoses fluidly connects one of the plurality of connectors with one of the at least one bladder of one of the plurality of cuffs. In some examples, the external counterpulsation system can include an ECG signal from an ECG monitor connected to the patient. In some examples, the external counterpulsation system can include an ECG signal receiver configured to receive the ECG signal from the ECG monitor. In some examples, the external counterpulsation system can include a programmable logic controller configured to receive the ECG signal and generate valve timing signals from peaks in the ECG signal. In some examples, each of the plurality of valves of the external counterpulsation system is configured to receive the valve timing signals from the programmable logic controller.

In other embodiments, in the external counterpulsation system, the plurality of cuffs can include a first cuff positioned at a lower thigh of the patient, a second cuff positioned at an upper thigh of the patient, and a third cuff positioned at the buttocks of the patient. In other embodiment, in the external counterpulsation system, the second cuff is positioned in the upper inguinal area of the upper thigh. In other embodiments, in the external counterpulsation system the third cuff is positioned at the superior-posterior knee region. In other embodiments, the external counterpulsation system is configured to pressurize each of the plurality of cuffs at a rate consistent with the heartrate of the patient when the ECG signal from the ECG monitor indicates that the patient has a heartrate less than or equal to 90 beats per minute. In other embodiments, the external counterpulsation system is configured to pressurize each of the plurality of cuffs at a rate half of the heartrate of the patient when the ECG signal from the ECG monitor indicates that the patient has a heartrate greater than 90 beats per minute. In other embodiments, the external counterpulsation system includes at least one bladder of each of the plurality of cuffs is pressurized to a pressure less than 240 mmHg. In other embodiments, the external counterpulsation system weighs less than 100 lbs. In other embodiments, in the external counterpulsation system, the at least one bladder of each of the plurality of cuffs is pressurized to a pressure less than 240 mmHg. In other embodiments, in the external counterpulsation system, a delay exists between the pressurization of each of the plurality of cuffs. In other embodiments, in the external counterpulsation system, the delay is calculated based on the patient's heart rate. In other embodiments, in the external counterpulsation system, the delay is configured to change based on the patient's heart rate. In other embodiments, in the external counterpulsation system, the air tank is between 2.0 gallons and 3.0 gallons. In other embodiments, the external counterpulsation system has a supply voltage between 100 VAC and 120 VAC. In other embodiments, in the external counterpulsation system, the pod is configured to be movable relative to the patient. In other embodiments, in the external counterpulsation system, each of the at least one bladder of the plurality of cuffs are configured to be partially inflated to a pressure at or below a measured diastolic pressure. In other embodiments, in the external counterpulsation system, the at least bladder comprises a notch on the bladder, the notch configured to allow the bladder to be placed closer to the inguinal area of the patient. In other embodiments, in the external counterpulsation system, the notch is a semi-circle.

Further features and advantages of the presently disclosed devices and system will become apparent to those of skill in the art in view of the disclosure herein, when considered together with the attached drawings and claims.

### BRIEF DESCRIPTION OF THE DRAWINGS

These and other features, aspects, and advantages of the present disclosure will now be described with reference to the drawings of embodiments, which embodiments are intended to illustrate and not to limit the disclosure. One of ordinary skill in the art would readily appreciate that the features depicted in the illustrative embodiments are capable of combination in manners that are not explicitly depicted, but are both envisioned and disclosed herein.

FIG. 1 illustrates an embodiment of a patient undergoing ECP treatment. As shown, illustrated is an embodiment of the ECP device attached to a patient while connected to the ECP system;

FIG. 2A illustrates a posterior view of an embodiment of an ECP device placed on compression areas of a patient in one example use of the device.

FIG. 2B illustrates a side view of the ECP device of FIG. 1A placed on the left leg of a patient.

FIG. 2C illustrates an anterior view of an embodiment of an ECP device placed on alternative compression areas of a patient while connected to the ECP system.

FIG. 3 illustrates a schematic of the ECP device attached to an ECP system and integrated ECP monitor;

FIG. 4 illustrates a schematic of an embodiment of a compressed fluid system configured to supply fluid to the bladders of the ECP device;

FIG. 5 illustrates a schematic of an embodiment of a 120-volt electrical system configured to power an embodiment of the ECP system;

FIG. 6 illustrates a schematic of an embodiment of a 24-volt electrical system configure to power some components of an embodiment of the ECP system;

FIGS. 7, 7A, and 7B illustrates a schematic of an embodiment of a programmable logic controller.

FIG. 8 illustrates a schematic of an embodiment of a mini air compressor configured to provide air pilot assist to the valves of an embodiment of the ECP system;

FIGS. 9A and 9B illustrate superior and side views of an embodiment of an inflatable bladder;

FIG. 9C illustrates an alternate embodiment of the inflatable bladder of FIGS. 9A and 9B.

FIG. 9D illustrates another embodiment of the inflatable bladder of FIGS. 9A and 9B.

FIGS. 10A and 10B illustrate outer and inner surfaces of an embodiment of a leg cuff;

FIG. 10C illustrates the leg cuff of FIG. 10B without a bladder;

FIG. 10D illustrates an inner surface of an embodiment of a leg cuff with the inflatable bladder of FIG. 9C.

FIGS. 11A and 11B illustrate outer and inner surfaces of another embodiment of a buttock cuff;

FIG. 11C illustrates the buttock cuff of FIG. 11B without a bladder;

FIGS. 12A and 12B illustrate outer and inner surfaces of another embodiment of a leg cuff;

FIGS. 13A and 13B illustrate outer and inner surfaces of another embodiment of a buttock cuff;

FIGS. 14A and 14B illustrate inner surfaces of another embodiment of a leg and a buttock cuff with padding attached to the inner surface;

FIGS. 15A and 15B illustrate another embodiment of an inflatable bladder configured to be used in a buttock cuff;

FIGS. 16A and 16B illustrate outer and inner surfaces of another embodiment of a leg cuff with a pocket to receive an inflatable bladder;

FIGS. 17A and 17B illustrate outer and inner surfaces of another embodiment of a buttock cuff with a pocket to receive an inflatable bladder;

FIG. 18 illustrates a patient connected to another embodiment of an ECP system with an inlet for connecting an external pressurized air supply;

FIG. 19 illustrates a schematic of an embodiment of a pressurized fluid system that can be configured to be used in the ECP system of FIG. 18;

FIG. 20 illustrates a schematic of a 120-volt electrical system that can be configured to be used in the ECP system of FIG. 18;

FIG. 21 illustrates a schematic of a 24-volt electrical system that can be configured to be used in the ECP systems of FIGS. 18A-18B;

FIG. 22 illustrates a schematic of an embodiment of the ECP system of FIGS. 18A-18B wherein an external compressed air supply provides air pilot assist to the valves of the ECP system;

FIG. 23 illustrates another embodiment of the ECP system wherein the air valves are integrated into the system such that a table is not required;

FIG. 24 illustrates another embodiment of the ECP system with an integrated ECG monitor wherein the air valves are integrated into the system such that a table is not required;

FIG. 25 illustrates a schematic of an alternative embodiments of an ECP system.

FIG. 26 illustrates a schematic representation of another embodiment of an ECP system comprising a staggered pressurization and depressurization of a plurality of compression members.

FIG. 27A illustrates a schematic representation of another embodiment of an ECP system comprising a staggered pressurization and depressurization of a plurality of compression members.

FIG. 27B illustrates a graph illustrating a compression cycle between heartbeats of an ECP system in a patient with a target heart rate of 90 bpm where the plurality of compression members do not have a staggered pressurization and depressurization.

FIG. 27C illustrates a graph illustrating an embodiment of a compression cycle between heartbeats of the ECP system of FIG. 27A in a patient with a target heart rate of 90 bpm where the plurality of compression members has a staggered pressurization and depressurization.

FIG. 27D illustrates a graph illustrating a compression cycle between heartbeats of an ECP system in a patient with a target heart rate of 45 bpm where the plurality of compression members do not have a staggered pressurization and depressurization.

FIG. 27E illustrates a graph illustrating an embodiment of a compression cycle between heartbeats of the ECP system of FIG. 27A in a patient with a target heart rate of 45 bpm where the plurality of compression members has a staggered pressurization and depressurization.

FIG. 28 illustrates a graphical representation of a comparison of treatment pressure and preloaded bladder pressure across the duration of a plurality of QRS waves.

FIG. 29 illustrates a graphical representation of the cuff preload pressure across the duration of a plurality of QRS waves.

FIGS. 30A-30B illustrate a plurality of views of another embodiment of a cuff with a split roller buckle for use in an ECP system.

FIG. 31A illustrates an examples of ECG placement of the ECP system.

FIG. 31B illustrates an example of cuff placement of the ECP system.

FIG. 32 illustrates a flow chart of the multiple hemodynamic and peripheral effects of ECP treatment.

FIGS. 33A-33D illustrate an embodiment of a portable ECP system;

FIG. 33A illustrates the portable ECP with a lid attached and FIG. 33B illustrates the portable ECP system with the lid removed.

FIG. 33E illustrates the embodiment of the portable ECP system of FIGS. 33A-33D wherein the cuffs of the portable ECP system are secured to a patient.

FIG. 33F illustrates a schematic of a pod of the portable ECP system of FIGS. 33A-33D.

FIGS. 34A-34F illustrate and compare mid-cuff and lower cuff pressures and pressure-delays over time in the embodiment of the ECP system wherein the ECP system includes a 2.6-gallon tank wherein the patient heart rate is approximately 47 beats per minute.

FIGS. 34G-34L illustrate lower and upper cuff pressures and pressure-delays over time in the embodiment of the ECP system wherein the ECP system includes a 2.6-gallon tank wherein the patient heart rate is approximately 47 beats per minute.

FIGS. 35A-35F illustrate and compare mid-cuff and lower cuff pressures and pressure-delays over time in the embodiment of the ECP system wherein the ECP system includes a 2.6-gallon tank wherein the patient heart rate is approximately 60 beats per minute.

FIGS. 35G-35L illustrate lower and upper cuff pressures and pressure-delays over time in the embodiment of the ECP system wherein the ECP system includes a 2.6-gallon tank wherein the patient heart rate is approximately 60 beats per minute.

FIGS. 36A-36F illustrate and compare mid-cuff and lower cuff pressures and pressure-delays over time in the embodiment of the ECP system wherein the ECP system includes a 2.6-gallon tank wherein the patient heart rate is approximately 75 beats per minute.

FIGS. 36G-36L illustrate lower and upper cuff pressures and pressure-delays over time in the embodiment of the ECP system wherein the ECP system includes a 2.6-gallon tank wherein the patient heart rate is approximately 75 beats per minute.

FIGS. 37A-37F illustrate and compare mid-cuff and lower cuff pressures and pressure-delays over time in the embodiment of the ECP system wherein the ECP system includes a 2.6-gallon tank wherein the patient heart rate is approximately 87 beats per minute.

FIGS. 37G-37L illustrate lower and upper cuff pressures and pressure-delays over time in the embodiment of the ECP system wherein the ECP system includes a 2.6-gallon tank wherein the patient heart rate is approximately 87 beats per minute.

### DETAILED DESCRIPTION

Despite the availability of ECP systems for several, over 40, years and its reimbursable status under Medicare and health insurance plans, use of ECP has been hindered by several limitations in the existing technologies and the methods used to perform ECP. Existing ECP systems are large, noisy and complicated to operate. The air pressures used to inflate the existing systems are high and can cause discomfort or even pain to the limbs of patients undergoing treatments. The high pressures also cause the air in the ECP system to heat up, further adding to patient discomfort. The high pressures also cause a rapid jerking of patients' limbs during inflation, as well as a repetitive chaffing that can worsen skin conditions and cause musculoskeletal pains. Additional patient injuries are also possible. For example, as recent as 2016, existing ECP healthcare providers have reported to the U.S. Food and Drug Administration of at least one patient injury event involving mitigating factors that have contributed to a patient's injury which include, for example: low heart rate, skin fragility, and even a patient's choice of positioning on a table. Patient discomfort may result in noncompliance with the treatment and discontinuation of ECP before the conclusion of the standard seven-week treatment.

Existing ECP machines require high inflation pressures for several reasons. These machines use large inflation bladders placed against a large surface area of the limbs to attempt the greatest degree of limb compression. Larger bladders require higher volumes and higher pressures of air to obtain adequate airflow rates and limb compression. The high pressures can cause excessive skin irritation that an operator may attempt to alleviate by providing padding between the patient and the bladder. This additional protective padding in turn requires even higher pressures in the ECP system to provide sufficient compression of the limbs. The larger bladders of existing ECP systems also require larger air fill lines to provide satisfactory inflation and deflation airflow rates. Large air fill lines are additional air reservoirs that necessitate increased fluid volumes and pressures to operate the system and increase the noise and heat generated.

Another consequence of the high pressures in existing ECP systems is the required detection of premature ventricular contractions and the subsequent premature deflation of the ECP machine. A premature ventricular contraction (PVC) is an abnormal heartbeat that occurs earlier than expected when compared to regular heart activity. During an ECP treatment, a PVC causes the heart to pump against a high peripheral vascular resistance or afterload created by inflation of the ECP system. This can severely increase the workload of the heart such that existing ECP systems avoid compression during PVC's by detecting PVC's and prematurely deflating the bladders. A typical patient undergoing treatment using the ECP system, however, can have advanced heart disease with an increased frequency of PVC's in their heart rhythms. In patients with frequent PVC's, the efficacy of ECP is reduced by frequent deflation caused by frequently detected PVC's.

The high cost of existing ECP systems has also limited the availability of these systems. Existing ECP systems have built-in electrocardiogram (ECG) modules for providing a synchronization signal to the system and built-in plethysmographs for monitoring the pulse waveform. Treatment centers, however, likely have pre-existing stand-alone ECG monitors that can provide the synchronization signal. Using a stand-alone ECG monitor would allow the operator to use a machine that he or she is already familiar with using and provides a synchronization signal that is updateable as the stand-alone ECG monitor is replaced. Likewise, treatment centers already have stand-alone plethysmograph devices, but the waveform information provided by plethysmographs is not needed if the operating parameters of the ECP machine are not derived from the waveforms. Alternatively, in some embodiments, a pulse oximeter can be used with the ECP system (e.g., any of the above described counterpulsation systems) to noninvasively measure a patient's oxygen saturation. In some embodiments, the pulse oximeter or other device can display or output a pulse waveform in lieu of a plethysmograph.

Existing ECP systems are also complicated to operate. Existing ECP systems require the operator to take several steps and make several decisions before the initiation of an ECP treatment. These ECP systems require the operator to set several timing intervals on the machine, including the delay interval between a heartbeat and the onset of bladder inflation and the duration of the inflation. Operators also have to set the bladder inflation pressure. Setting all these parameters may delay the start of a treatment session and can make a treatment session less efficient or effective if the operator sets the wrong parameters on the machine.

Use of existing ECP systems is also made difficult by the numerous cuffs and air lines that must be connected to operate the system. Errors in connecting cuffs to the air lines or attaching cuffs to the limbs may delay the start of the treatment session and reduce the effectiveness of treatment. High pressure ECP systems also require cuffs designed to handle high bladder inflation pressures. These cuffs are not designed for patient comfort or ease-of-use by the operator. Because cuffs designed for high inflation pressures are also expensive to manufacture, the same set of cuffs have to be used by several patients in order to lower the usage cost of an ECP system, potentially increasing cross contamination between patients or requiring disinfection between patients.

To address these limitations in existing ECP systems, one embodiment of the disclosed ECP system includes small bladders that inflate at lower pressures and include bladders that are positioned at limited sites of the body but are still configured to produce effective circulatory augmentation despite the smaller body surface area compressed. By using smaller bladders with smaller cuffs, effective compression of these sites can be increased. In some embodiments, the smaller sizes can allow deeper and more tightly fitted contact of targeted body areas. Also, because of anatomical narrowing or creasing, some anatomical sites are not effectively reached by large bladders fastened to large cuffs. The term “contact”, as used herein, shall be given its ordinary meaning and shall also include the ability to transmit force to a patient through other layers or media, if any, between a bladder and a patient. Advantageous areas to compress with a smaller cuff and bladder system include the superior-posterior knee and inguinal regions of the body. The compressibility of the femoral vein, the principal deep vein trunk in the leg, is greatest at these two sites, but the use of the disclosed ECP system is not limited to this particular purpose or rationale.

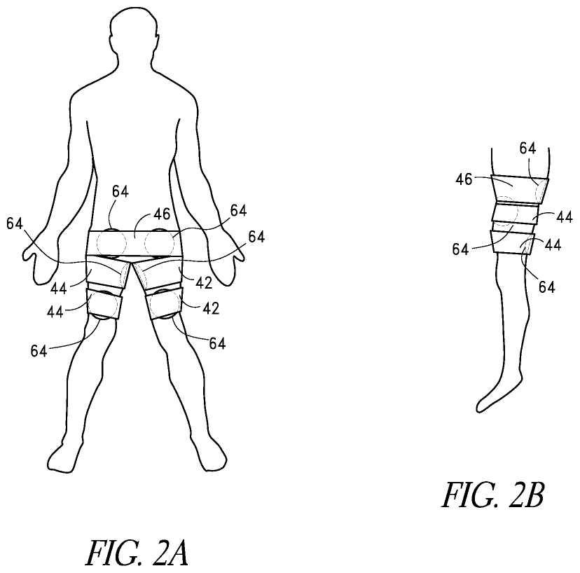

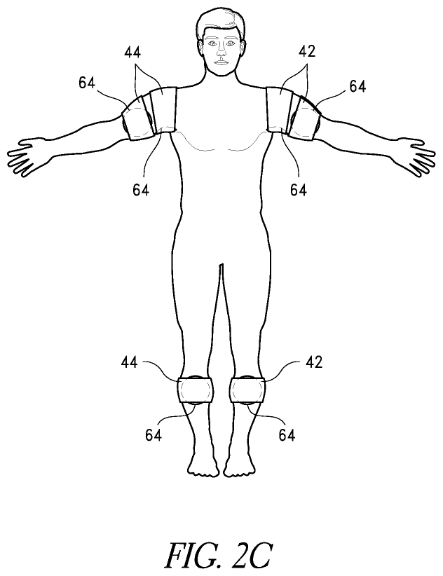

FIGS. 2A and 2B illustrate one embodiment of an ECP device with inflatable bladders 64 and cuffs 42, 44, 46 placed against the preferred compression sites at the superior-posterior knee regions, the inguinal regions and the buttocks. The bladders 64 and cuffs 42, 44, 46 are described in greater detail below. In some embodiments, six bladders 64, each having approximately thirty-six square inches of compression area, are used to compress the preferred body areas. Other compression sites are also contemplated. FIG. 2C illustrates another embodiment of an ECP device with inflatable bladders 64 and cuffs 42, 44 placed against alternative compression sites. In some embodiments, as illustrated in FIG. 2C, the cuffs and the attached inflatable bladders can be located in the upper extremities. As discussed above, each of the cuffs and attached inflatable bladders are placed near vessels close to the surface of the skin. In some embodiments, the bladder 64 and cuffs 42, 44 can be located on the upper arm. For example, the bladder 64 and cuffs 42, 44 can be located inside the elbow notch at a distal end of the bicep. In another example, the bladder 64 and cuffs 42, 44 can be located inside the armpit near the inside of the arm region. The placement of the bladder 64 and cuffs 42, 44 inside the armpit can be used to aid in lymph node drainage (e.g., after a mastectomy). As well, the placement of the bladder 64 and cuffs 42, 44 can also be used to reduce tissue edema. In another example (not illustrated), the bladder 64 and cuffs 42, 44 can be located near the wrist on the inside of the arm. In some examples, compression of the sites in the upper extremities can be configured to provide circulation to the head (e.g., the brain). In some embodiments, the disclosed ECP system can be coupled with a patient's existing therapy. For example, in treating depressing, the ECP system in the upper extremities can be configured to increase blood flow to the brain.

In some embodiments, the bladders 64 and cuffs 42, 44 at the superior-posterior knee region are placed on the inside of the legs. In some examples, the bladders 64 and cuffs 42, 44 are located behind the kneecap (i.e., above the knee). In some embodiments, the bladders 64 and cuffs 42, 44 can be located on the calf (e.g., on the upper inside of the calf or on the Achilles tendon on the lower calf).

In some embodiments, compression of the upper extremities (i.e., the bladders 64 and cuffs 42, 44 in FIG. 2C) and compression of the lower extremities (i.e., the bladders 64 and cuffs 42, 44, 46 in FIG. 2A-2B) can be synced. For example, compression of the upper extremity can be synced with compression of a corresponding part in the extremity. As an example, the bladders 64 and cuffs 42, 44 on the bicep can be compressed at the same time as the bladders 64 and cuffs 42, 44 behind the knee. As another example, the bladders 64 and cuffs 42, 44 under the armpit can be compressed at the same time as the bladders 64 and cuffs 42, 44 at the groin region.

In some embodiments, other numbers of cuffs and bladders may be used. Additional body areas may also be compressed, but are not necessary to achieve effective counterpulsation. Furthermore, increasing the body surface area compressed may increase the air volumes used and therefore increase patient discomfort and increase the generation of noise and heat. In some embodiments, existing ECP devices, using a plurality of bladders for compressing the lower limb, could be modified to have the capability of selectively inactivating a number of bladders during the treatment of a patient. In some examples, the remaining active bladders are located at the preferred compression sites and the effective total surface area of the remaining active bladders used to compress the body is limited to about 240 square inches. In some embodiments, the active bladders used to compress the body can be greater or smaller than the above-reference 240 square inches depending on treatment requirements and the person's physical characteristics, (e.g., body mass index (BMI)).

In some examples, an ECP system employing lower inflation volumes, not only can lower pressures be used, but the timing of the inflation and deflation cycles can be simplified. Timing intervals can be easier to maintain because there is less need to move large volumes of compressed air in and out of the bladders in a short time interval. This can allow the duration of bladder inflation and the delay intervals between sequential inflation of the bladders to be preset in a low-volume ECP system.

Another benefit of an ECP system using lower volumes and pressures is that bladder deflation during PVC's is unnecessary. With an inflation pressure of about 160 mm Hg to about 220 mm Hg, an ECP system does not need to deflate the bladders when a PVC occurs because the heart is no longer contracting against a supra-physiological blood pressure. Furthermore, the ECP system is simplified because there is no need to differentiate between a sinus beats from PVC's. More importantly, a low-pressure ECP system eliminates the inefficiency of the ECP session caused by excessive deflation from detected PVC's.

In addition to angina and congestive heart failure, other uses for an ECP system may include but are not limited to adult and pediatric congenital heart disorders, pregnancy-related heart failure, ischemic bowel disease, peripheral vascular disease including carotid insufficiency and skin ulceration, Alzheimer's, cerebrovascular accidents, dementia, acute renal failure, chronic renal insufficiency and failure, liver disease, weight loss, alopecia, limb ischemia, sepsis and shock. Those skilled in the art are familiar with other conditions that may benefit from use of ECP.

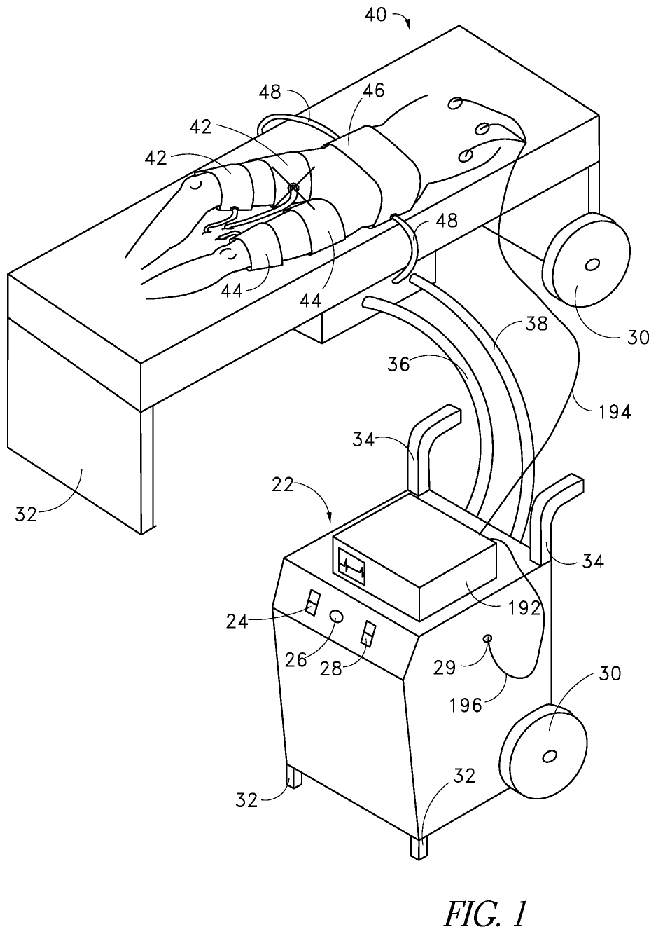

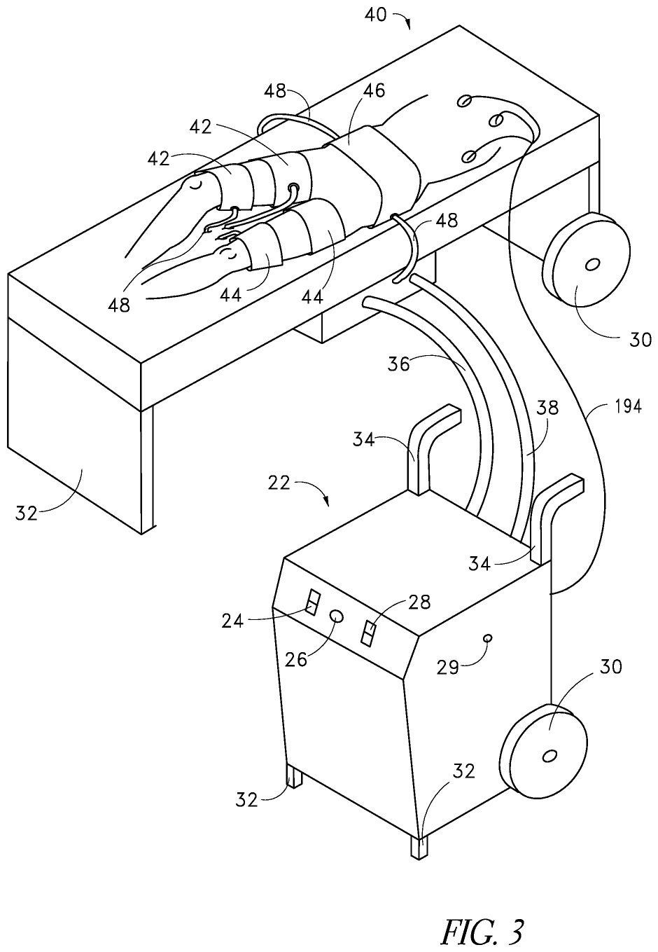

FIG. 1 illustrates an embodiment of an ECP system 22 and a table 40. In some examples, the ECP system 22 comprises a pressurized air system, a controller and a plurality of bladders attached to cuffs 42, 44 and 46. The controller can include, an ECG signal connector 29 that accepts an ECG signal from an external ECG signal source 192 and an ECG signal processor to generate at least one control signal from the ECG signal. An external ECG signal connector 29 can allow a patient to undergo ECP treatment concurrently with any ongoing ECG monitoring being performed on the patient without attaching a duplicate set of chest leads to the patient. This can be useful in an Intensive Care Unit (ICU) setting where a patient is already connected to an ECG monitor. An example embodiment of an ECG signal processor is described in further detail below. FIG. 3 shows another embodiment of an ECG monitor integrated into the ECP system 22 where unprocessed ECG chest lead signals are provided to the ECG monitor by chest leads attached to the patient. The chest signal can processed by the ECG monitor and relayed to the ECG signal processor to generate the control signal. In some examples, the ECG monitor output is optionally provided in this embodiment for providing ECG output to the telemetry monitors available in some hospital wards.

In some embodiments the control signal is transmitted through a control line 38 to table 40 for controlling the opening and closing of air valves that inflate and deflate the bladders. Pressurized air from the ECP system 22 can be transmitted to the table 40 by an air line 36. In some examples, the air is directed to the air valves from table 40 which distribute the pressurized air using bladder air lines 48 to the right leg cuffs 42, left leg cuffs 44 and buttock cuffs 46 that hold inflatable bladders. In some embodiments, the controller may optionally have an on/off power switch 24 to control power to the ECP system 22 and/or a timer switch 26 that sets the treatment time.

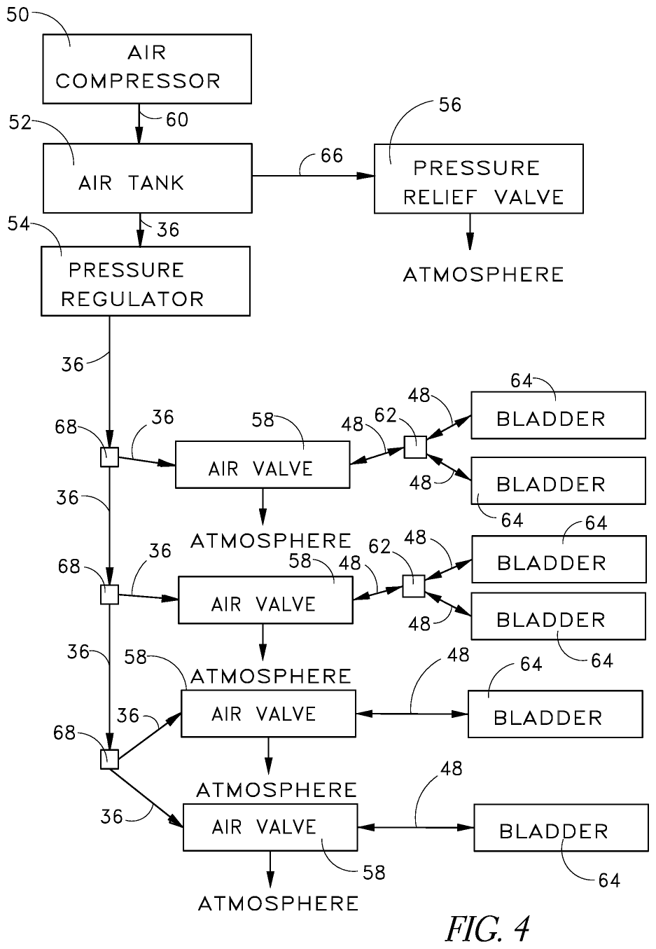

FIG. 4 illustrates a schematic embodiment of a pressurized air subsystem. In some embodiments, pressurized air is supplied by an air compressor 50 which is capable of providing pressurized air to an air tank 52 through a compressor air line 60. In some examples, air compressor 50 is capable of a total free air output of about four to about eight cubic feet per minute (cfm) at a pressure of about four pounds per square inch (psi). The compressor air line 60 can comprise a flexible hose having an internal diameter of about ½ inch to about ¾ inch. Air tank 52 can have a capacity of about five gallons and can be capable of withstanding an operating pressure of about 100 psi. In some embodiments, output from the air tank 52 travels through air line 36 which comprises a flexible hose with an internal diameter of about one inch. In some examples, air line 36 connects to a pressure regulator 54. Air tank 52 can also connect to a pressure relief valve 56 by a pressure relief valve fitting 66. In some examples, the pressure relief valve 56 may be set to any pressure from about one psi to about five psi and vent about eight cfm or more of air. In some embodiments, the pressure regulator 54 can be set to an output pressure of about three to about five psi and feed at least one air valve 58 through air line 36. In some examples, pressure from air line 36 may be distributed to a plurality of air valves 58 by air line tees 68 or any other kind of pressure distributor having multiple openings. The air valves 58 can be connected to bladders 64 on the right leg cuffs 42, left leg cuffs 44 and buttock cuff 46 by bladder lines 48. In some examples, the bladder lines 48 comprise ½ inch internal diameter flexible hose. In some embodiments, air valves 58 are ½ inch. In some examples, the air valves 58 can be 24-volt. In some embodiments, the air valves 58 can be closed. In some examples, the air valves 58 can have two-positions. In some embodiments, the air valves 58 are three-way, air pilot assist valves having an open and a closed configuration. In some embodiments, non-pilot air valves can be used. In the closed configuration, the air valves 58 can be configured to prevent flow from air tank 52 to bladders 64. When closed, the bladders 64 can be configured to also vent to the atmosphere. In the open configuration, the air valves 58 can be configured to allow air pressure from air tank 52 to pressurize bladders 64 and prevent any venting. In some embodiments, ridged threaded barbs and hose clamps can be used to secure hoses 36, 48, 60 and 66 to the other components of the ECP system. One of skill in the art will understand that any of a variety of other mechanical fittings suitable for securing hoses may be used.

Another embodiment of an electrical power system for the ECP system is illustrated in FIG. 5. A 120-volt system is described below, but one skilled in the art will understand how to adapt the ECP system for use in a 110-volt, 220-volt, 240-volt or other system. A 120-volt power cord 72 is configured to feed power to a re-settable ground fault interrupter (GFI) 74, which in turn can connect to an on/off power switch 24. In some embodiments, the power switch 24 is a two-position double-pole lighted switch. Power switch 24 can connect, for example, to an EMI filter 76 that in turn connects to a start switch 28 and a start switch relay 78 having an engaged and disengaged position. In some embodiments, the start switch 28 is a momentary lighted single pole switch used to start ECP system 22. In some examples, the start switch relay 78 also connects to start switch 28. When start switch 28 is in the engaged position, start switch 28 is capable of sending power to timer switch 26. In some embodiments, the timer switch 26 has an active state and an inactive state. The timer switch 26 can go from the active state to the inactive state after a user-settable period. The power output from timer switch 26 can be looped back to the output of start switch 28 to keep start switch relay 78 in the engaged position so long as timer switch 26 is in the active state. In some embodiments, when the timer switch 26 is in the active state, timer switch 26 provides power to air compressor 50, a programmable logic controller (PLC) 80 and a 24-volt power supply 82. In some embodiment, timer switch 26 can be set from about zero minutes to about sixty minutes. In some examples, the timer switch 26 can be set for any period of time. In some embodiments, the timer switch 26 does not reset upon loss of power. The wire 84 can provide power to air compressor 50 from GFI or resettable breaker, or an electrical safety feature 74 through timer switch 26. In some examples, the wire 84 comprises 14-gauge wire, but one skilled in the art will understand that other wire gauges may be used. Wires 86 can provide power to start switch 28, programmable logic controller (PLC) 80 and 24-volt power supply 82. In some embodiments, the wires 86 comprise 18-gauge wires, but those skilled in the art will understand that other wire gauges may be used. In some examples, the PLC 80 is a 120-volt unit with at least one input and at least three outputs. In some embodiments, the inputs range generally from about twelve volts to about twenty-four volts. The outputs can range generally from about twelve volts to about twenty-four volts.

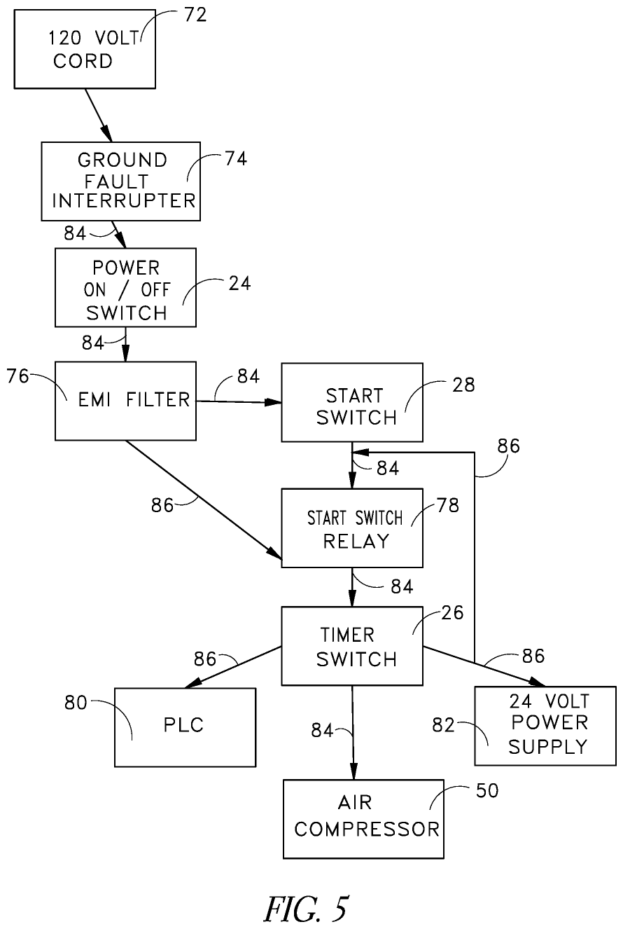

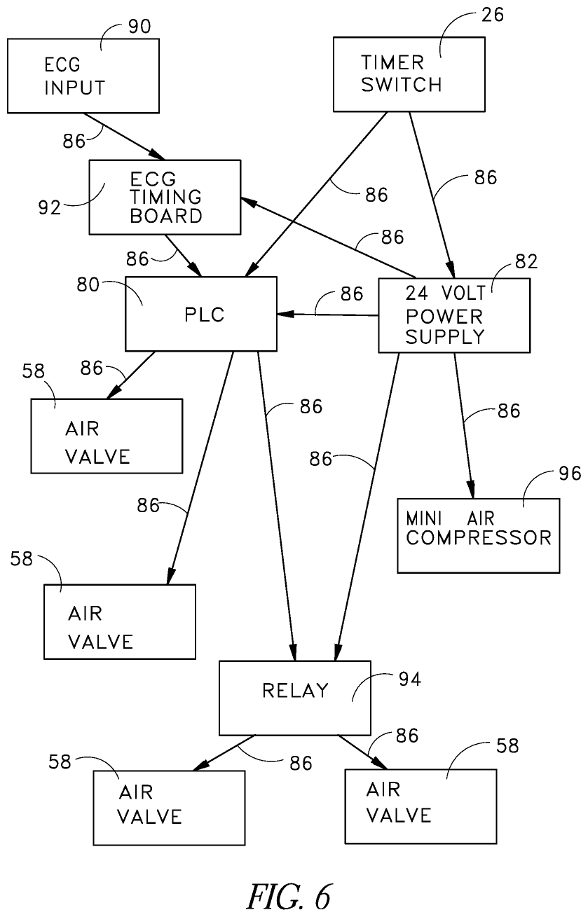

FIG. 6 illustrates an embodiment of the external ECG input 90 and a 24-volt system used to power ECG system 22. Although a 24-volt system is described herein, one skilled in the art will know that the system can be adapted to voltages from about 6-volts to about 30-volts. In some examples, a 24-volt power supply 82 supplies power to PLC 80, an ECG timing board 92, a PLC-to-air valve relay 94 and a mini-air compressor 96. In some embodiments, the ECG timing board 92 can be a relay board that amplifies and relays the signal from external ECG input 90 to PLC 80. In some examples, the PLC 80 uses the amplified ECG signal from timing board 92 to output control signals to air valves 58 and PLC-to-air valve relay 94. In some embodiments, the outputs are generally spaced about forty milliseconds apart after the first output. In some examples, the outputs are generally spaced about 10 milliseconds to about 100 milliseconds apart. A first output or control signal can regulate the air valve 58 connected to bladders contacting the upper posterior knee or lower thigh. In some embodiments, a second output regulates air valve 58 connected to bladders contacting the upper thigh or inguinal areas. In some examples, a third output goes to PLC-to-air valve relay 94, which passes the third output to air valves 58 controlling compression of the buttocks. In some embodiments, the wires 86 used for the 24-volt system can be 18-gauge wires.

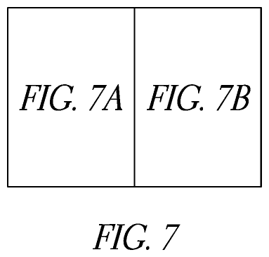

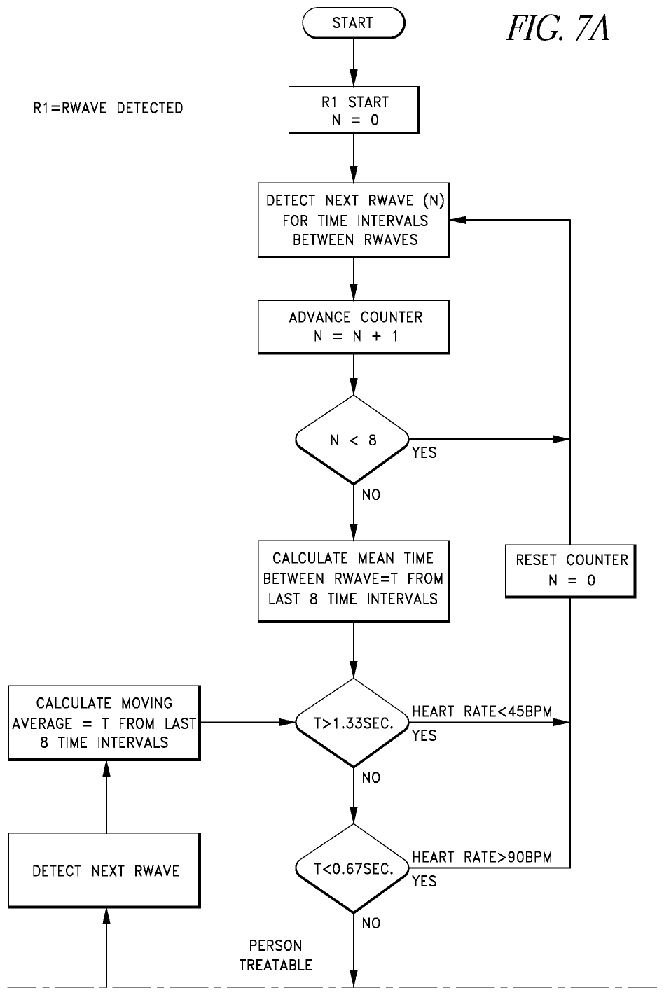

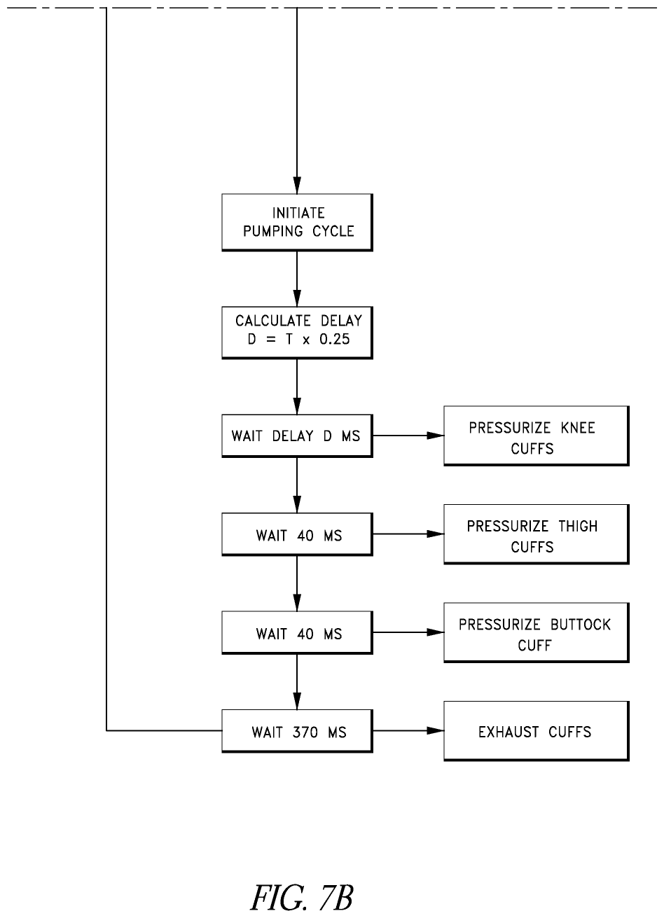

FIGS. 7A and 7B illustrate schematic representations of an embodiment of the programming of the PLC 80. In some embodiments the PLC 80 receives a squared ECG signal from ECG timing board 92. The PLC 80 can be configured to detect eight squared R wave signals and calculate the total time interval between the eight squared R wave signals. In some examples, if the total time interval is greater than about 10.7 seconds or less than about 5.3 seconds, the R wave counter is reset and the total time interval is recollected. In some examples, if the total time interval is between 5.3 and 10.7 seconds, the PLC 80 can initiate a pump cycle. In some embodiments, following a delay after the last detected peak in the squared ECG signal, the PLC 80 can initiate a first control signal that is transmitted to air valve 58 controlling bladders 64 at the lower thigh. In some examples, the delay can be pre-set at about 280 milliseconds. Alternatively, the delay can be calculated based upon the patient's heart rate or peak-to-peak time interval based upon the EC signal. In some embodiments, the delay is about 25% of the average peak-to-peak interval of the last eight trailing QRS complexes. In some examples, the delay is about 25% of the longest of the trailing eight peak-to-peak intervals of the ECG signal. In some embodiments, after a fixed interval set at about forty milliseconds, a second control signal to air valve 58 controlling bladders in the upper thigh/inguinal regions can be initiated. In some examples, the first control signal to the air valve 58 controlling the bladders 64 of the lower thighs may be terminated after the second control signal is initiated. In some embodiments, the early termination of the first control signal can advantageously allow earlier filling of the thighs for the next pump cycle. In some examples, there may be a slight delay between the initiation of the second control signal and the termination of the first control signal to allow bladders 64 of the upper thigh to fully inflate before deflating bladder 64 at the lower thigh. In some embodiments, after another fixed interval of about 40 milliseconds, a third control signal to air valve 58 controlling the buttock bladders is initiated. In some examples, after a fixed interval set at about 370 milliseconds after the start of the third control signal, the three control signals can be terminated and the cycle is repeated. In some embodiments, the control signals continue for the pre-set interval irrespective of whether another ECG signal or PVC is detected during the transmission of the control signals. In some examples, the PLC 80 can terminate the signal cycle if another signal peak is detected and initiate the next cycle, but does not distinguish between squared sinus QRS complexes and squared PVC's. Although the embodiments herein have described the use of the ECG timing board 92 and the PLC 80 to process ECG signals and provide control signals to the valves, one skilled in the art will understand that computers, microprocessors and other electronic controllers can also be used to process ECG signals and provide control signals. One skilled in the art will understand that variations of the above control systems, or other known ECP control algorithms, may be used.

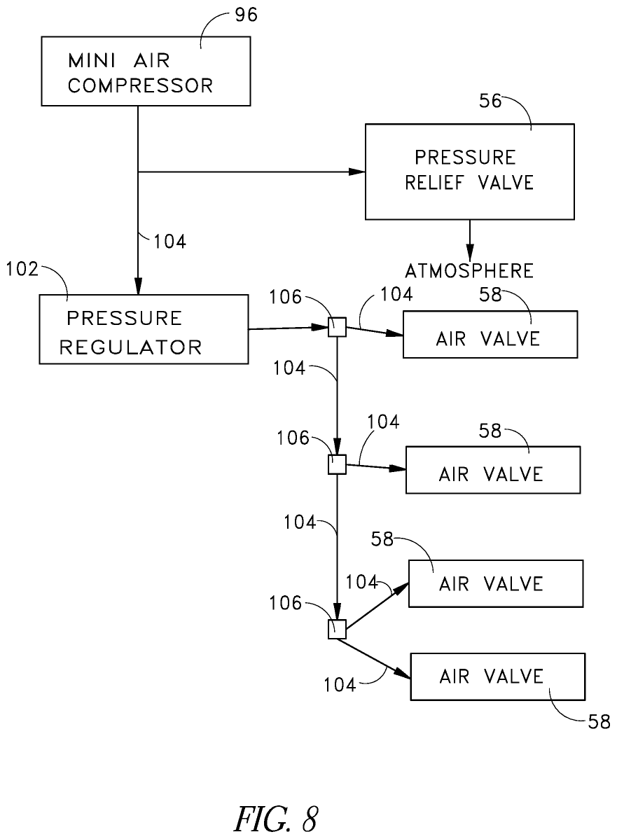

FIG. 8 represents an embodiment of a mini air system used for providing pilot assist air to the air valves 58. In some embodiments, the mini air compressor 96 is a 24-volt mini compressor with an output of about ½ cfm at a pressure of about twelve psi. The mini air compressor 96 can connect to a mini air compressor pressure relief valve 56 which is set to vent air at about twelve psi. In some examples, the mini air compressor pressure relief valve 56 connects to the mini air compressor pressure regulator 102. The air pressure regulator 102 can be a ¼ inch pipe fitting set at about ten psi. The output from mini air compressor pressure regulator 102 can be configured to feed the actuators of at least one air valve 58 using at least one ¼ inch air line tee 106 and ¼ inch air line 104. In some examples, by providing a separate and smaller compressor to produce the higher-pressure smaller-volume pilot assist air for driving the pilot assist air valves, the air compressor 50 is not unnecessarily producing higher pressure for bladders 64. Thus, air compressor 50 thus can operate efficiently at lower pressures independent of the higher pressure used for the pilot assist air needed by valves 58. By having two different compressors for serving two different functions, the total amount of noise, heat and patient discomfort created by the ECP system can be reduced. In some examples, in embodiments that do not use pilot air assist valves, a system other than the mini air system may be used.

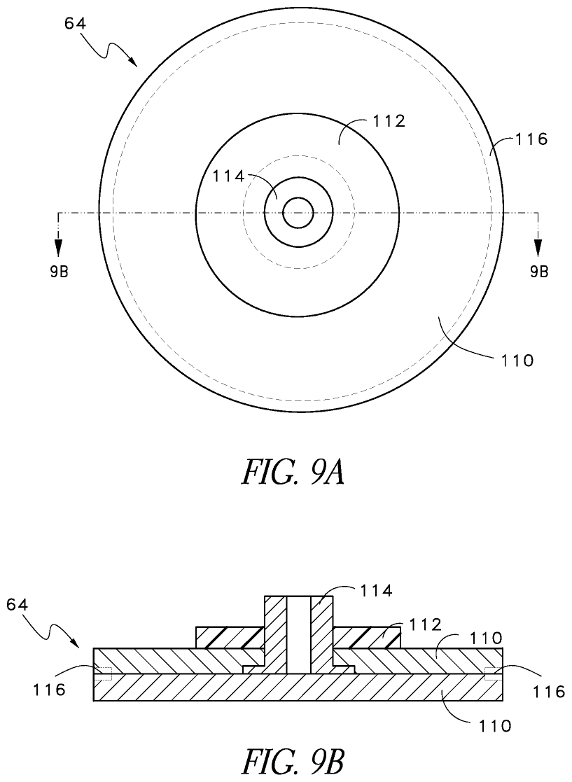

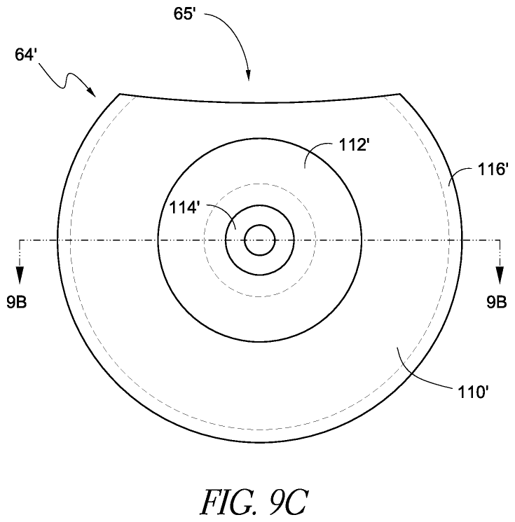

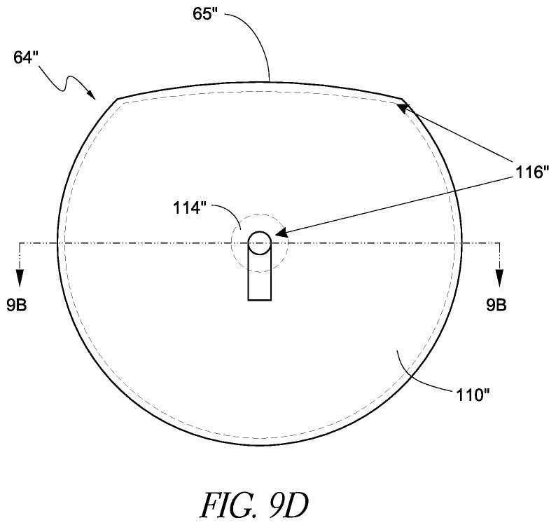

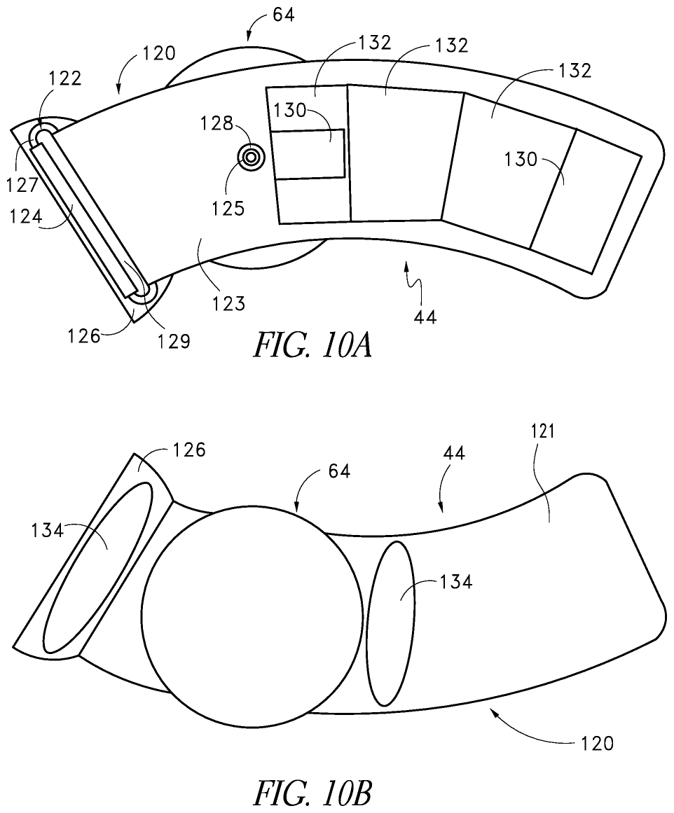

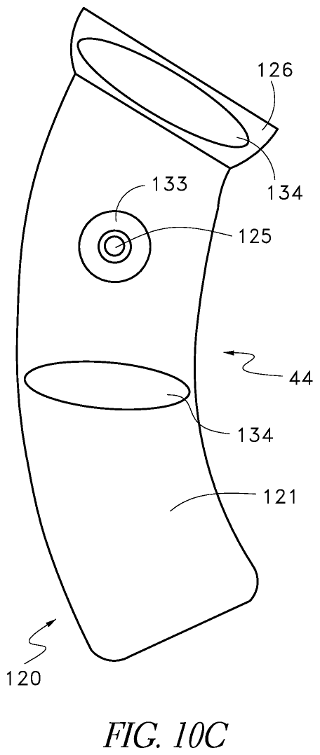

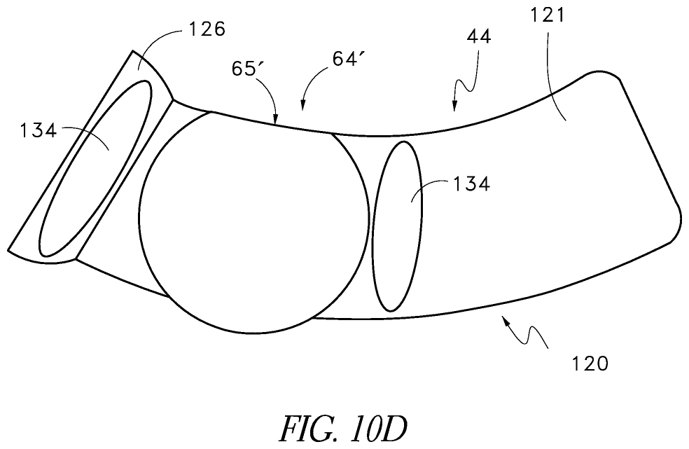

FIGS. 9A-9C and 10A-10D illustrate an embodiment of a cuff and bladder design. This configuration may increase user comfort and improve ease of set up and placement of the cuffs. In some embodiments, the bladders can be disposable. In some examples, the bladders can be easily removed from the cuff, such that the operator of the ECP system can efficiently place the cuffs and properly position each of the bladders. In some embodiments, as discussed below, the bladders can come in a variety of configurations such that the operator can adapt the ECP procedure to the needs of the patient. In some examples, the disclosed ECP system can include a cuff that uses a split buckle that reduces set-up time and aids in placement.

FIGS. 9A and 9B illustrate an embodiment of a bladder 64 that can be used in ECP system 22. In some embodiments, the bladder 64 comprises a bladder connector 114 attached to a first bladder wall 110. The bladder connector 114 can have an internal diameter of about ¼ inch to about ¾ inch. In some examples, the first bladder wall 110 is sealed to a second bladder wall 110 along a bladder sealing area 116 along the edges of bladder walls 110. In some embodiments, the bladder sealing area 116 is approximately about ⅛ to about ⅜ inch wide. Attaching can be done in a manner to provide a hermetic seal and to withstand about a ten psi or more inflation pressure. Hermetic sealing may be performed by heat sealing, solvent sealing, adhesives, or any of a variety of hermetic sealing methods known in the art and incorporated by reference herein. In some embodiments, a single continuous bladder wall forms bladder 64. A hook fastener ring 112 can attaches to the area surrounding bladder connector 114. Hook fastener ring 112, can include but not be limited to those made by Velcro USA (Manchester, N.H.), facilitates affixation of bladder 64 to cuffs described below. FIG. 9A depicts balloon 64 with a circular shape, but other possible balloon shapes include square, rectangular, triangular or any other closed loop shape. In some embodiments, a triangular balloon shape may be suitable for compressing the body in areas with creasing. The surface area of bladder 64 when flat is about forty square inches on one side. In another embodiment, the surface area can be from about twenty square inches to about sixty square inches. Bladders 64 may be made from polyester, polyurethane, polyvinylchloride, polyethylene or any of a variety of airtight materials known in the art and herein incorporated by reference.

FIG. 9C illustrates an embodiment of a bladder 64′ that can be used in the ECP system 22. Similar to the bladder 64, the bladder 64′ can include a bladder connector 114′ attached to a first bladder wall 110′. The bladder connector 114′ can have an internal diameter of about ¼ inch to about ¾ inch. In some examples, the first bladder wall 110′ is sealed to a second bladder wall 110′ along a bladder sealing area 116′ along the edges of bladder walls 110′. In some embodiments, the bladder sealing area 116′ is approximately about ⅛ to about ⅜ inch wide. Attaching can be done in a manner to provide a hermetic seal and to withstand about a ten psi or more inflation pressure. Hermetic sealing may be performed by heat sealing, solvent sealing, adhesives, or any of a variety of hermetic sealing methods known in the art and incorporated by reference herein. In some embodiments, a single continuous bladder wall forms bladder 64′. A hook fastener ring 112′ can attach to the area surrounding bladder connector 114′. Hook fastener ring 112′, can include but not be limited to those made by Velcro USA (Manchester, N.H.), facilitates affixation of bladder 64′ to cuffs described below. The bladder 64′ can be very similar to the bladder 64 but further includes a notch 65′. In some examples, the notch 65′ can be semicircular and is configured to allow the bladder 64′ to be placed higher in to the groin area. In some embodiments, the notch 65′ permits placing the balloon further into the inguinal area, getting the bladder pressure into the vasculature and closer to the surface in the inguinal area. As illustrated in FIG. 10D, the notch 65′ of the bladder 64′ can help to properly orient the bladder 64′ on the cuff 44. In some embodiments, the bladder 64′ can be engaged to the cuff 44 with a connector (e.g., an elbow) that is configured to point away from the notch 65′. The configuration of the connector can therefore ensure proper orientation of the bladder 64′ on the cuff 44.

Although FIG. 9C depicts the balloon 64′ with a generally circular shape, but other possible balloon shapes include oval, ellipse, rounded, square, rectangular, triangular or any other closed loop shape that can be modified to also include a notch 65′ that conforms with a side of the cuff 44. Bladders 64′ may be made from polyester, polyurethane, polyvinylchloride, polyethylene or any of a variety of airtight materials known in the art and herein incorporated by reference.

FIG. 9D illustrates an embodiment of a bladder 64″ that can be used in the ECP system 22. Similar to the bladder 64, the bladder 64′, and the bladder 64″ can include a bladder connector 114″ attached to a first bladder wall 110″. The bladder connector 114″ can have an internal diameter of about ¼ inch to about ¾ inch. In some examples, the first bladder wall 110″ is sealed to a second bladder wall 110″ along a bladder sealing area 116″ along the edges of bladder walls 110′. The bladder sealing area 116″ indicates where the first bladder wall 110″ is welded to the second bladder wall 110″. In some embodiments, the bladder sealing area 116″ is approximately about ⅛ to about ⅜ inch wide. Attaching can be done in a manner to provide a hermetic seal and to withstand about a ten psi or more inflation pressure. Hermetic sealing may be performed by heat sealing, solvent sealing, adhesives, or any of a variety of hermetic sealing methods known in the art and incorporated by reference herein. In some embodiments, a single continuous bladder wall forms bladder 64″. The bladder 64″ can be very similar to the bladder 64 but further includes a notch 65″. In some examples, the notch 65″ can be semicircular and is configured to allow the bladder 64″ to be placed higher in to the groin area. In some embodiments, the notch 65″ permits placing the balloon further into the inguinal area, getting the bladder pressure into the vasculature and closer to the surface in the inguinal area. As illustrated in FIG. 10D, the notch 65″ of the bladder 64″ can help to properly orient the bladder 64″ on the cuff 44. In some embodiments, the bladder 64″ can be engaged to the cuff 44 with a connector (e.g., an elbow) that is configured to point away from the notch 65″. The configuration of the connector can therefore ensure proper orientation of the bladder 64′ on the cuff 44.

Although FIG. 9D depicts the balloon 64″ with a generally circular shape, but other possible balloon shapes include oval, ellipse, rounded, square, rectangular, triangular or any other closed loop shape that can be modified to also include a notch 65″ that conforms to a side of the cuff 44. Bladders 64″ may be made from polyester, polyurethane, polyvinylchloride, polyethylene or any of a variety of airtight materials known in the art and herein incorporated by reference.

FIGS. 10A and 10B depict embodiments of a left leg cuff 44 with bladder 64 in place. In the embodiments illustrated in FIGS. 10A and 10B and other embodiments described below, a right leg cuff 42 may be a mirror image of left leg cuff 44 for use on the right lower extremity. Alternatively, right leg cuff 42 and left leg cuff 44 may be identical or similar in configuration. In some examples, cuff material 120 has an inner surface 121, an outer surface 123 and a hole 125 for insertion of bladder connector 114 of bladder 64. In some embodiments, the cuff 44 has an arcuate configuration that is particularly suited to compress anatomical structures that are located in areas of narrowing or creasing, but is not limited to this particular purpose. In some examples, cuff material 120 can be made of a flexible non-stretch material that is able to withstand repeated inflations of bladder 64. In some embodiments, the non-stretch material comprises a 600 denier polyester cloth as used in backpacks. A ring 128 around hole 125 can optionally be color-coded to indicate which complementary color-coded bladder air line 48 connects to which bladder 64. A portion of bladder 64 may be visible when viewing outer surface 123 of leg cuff 44, which may facilitate accurate placement of bladder 64 when securing cuff 44 to the patient. Outer surface 123 may also have identifying marks to show the position of underlying bladder 64 if obscured by cuff 44. Identifying marks can be configured to allow accurate positioning of bladder 64 on the patient's body.

A buckle 122 with a buckle roller 124 can attach to one end of cuff 44. In some embodiments, the buckle 122 comprises a frame 127 with a slot opening 129 for insertion of a cuff end, the slot opening 129 having dimensions of about ¼ inch to about ¾ inch in one direction and about six inches in second direction. In some examples, the buckle roller 124 can a tube with an internal diameter larger than the diameter of buckle frame 127, permitting buckle roller 124 to turn freely. In some examples, buckle roller 124 can reduce the effort needed to tighten cuff 44 on the patient by allowing cuff 44 to slide through the slot opening of buckle 122 with reduced friction against buckle frame 127. In some embodiments, buckle 122 and buckle roller 124 are made from any of a variety of rigid materials well known in the art, including but not limited to a metal or a plastic. Buckle shield 126 may be made of the same type of material as cuff material 120. Optionally, buckle shield 126 may be made stiffer with any of a variety of materials attached or adhered to buckle shield 126, including but not limited to a thin polycarbonate. In some embodiments, buckle shield 126 attaches to the inner surface 121 of cuff material 120 to provide protection from buckle 122. In some examples, buckle shield 126 may reduce the pinching of the skin on the patient when left leg cuff 44 is tightened. Hook fastener 130 and loop fastener 132 can be attached to the other end of cuff material 120 by stitching, gluing, or any of a variety of methods well known in the art and incorporated by reference herein. Hook fastener 130 and loop fastener 132 can be used to fasten right leg cuff 42 or left leg cuff 44 when the cuff is tightened on the patient. In some embodiments, the width of right leg cuff 42 or left leg cuff 44 is approximately six inches with a circumferential length of approximately 30 to 45 inches. In another embodiment, cuffs 42, 44 have a width of about three inches to about eight inches and a circumferential length of about twenty to about sixty inches. Cutouts are optionally provided in cuff material 120 for vascular access or any other procedure requiring access to body areas covered by cuff material 120.

FIG. 10B illustrates another embodiment of the invention comprising a friction or non-slip material 134 on inner surface 121 of right leg cuff 42 or left leg cuff 44. Non-slip material 134 may be joined to cuff material 120 by stitching, gluing, coating or any other method of attachment as is known in the art. In some examples, the non-slip material 134 may also be an inherent characteristic of cuff material 120. In some embodiments, non-slip material 134 may comprise any of a variety of flexible materials with a coefficient of friction sufficient to resist slippage of the cuff, including but not limited to neoprene, rubber or texturized versions of cuff material 120. Those skilled in the art will be familiar with other known non-slip materials that may be used.

FIG. 10C illustrates an example of the inner surface 121 of cuff 44 without bladder 64. In some embodiments, to attach bladder 64 to cuff 44, bladder connector 112 of bladder 64 inserts through hole 125 such that hook fastener ring 112 of bladder 64 engages loop fastener ring 133 on cuff 44.

FIG. 10D illustrates an embodiment of a left leg cuff 44 with bladder 64′ in place. In the embodiment illustrated in FIG. 10D, a right leg cuff 42 may be a mirror image of left leg cuff 44 for use on the right lower extremity. As shown in FIG. 10D, the bladder 64′ is positioned such that the notch 65′ is positioned adjacent to the side of the cuff 44 to allow the bladder 64′ to be positioned more snuggly adjacent the groin. Similarly, the bladder 64″ of FIG. 9D can be similarly positioned on the cuff 44 to allow the notch 65″ to be positioned more snuggly adjacent the groin.

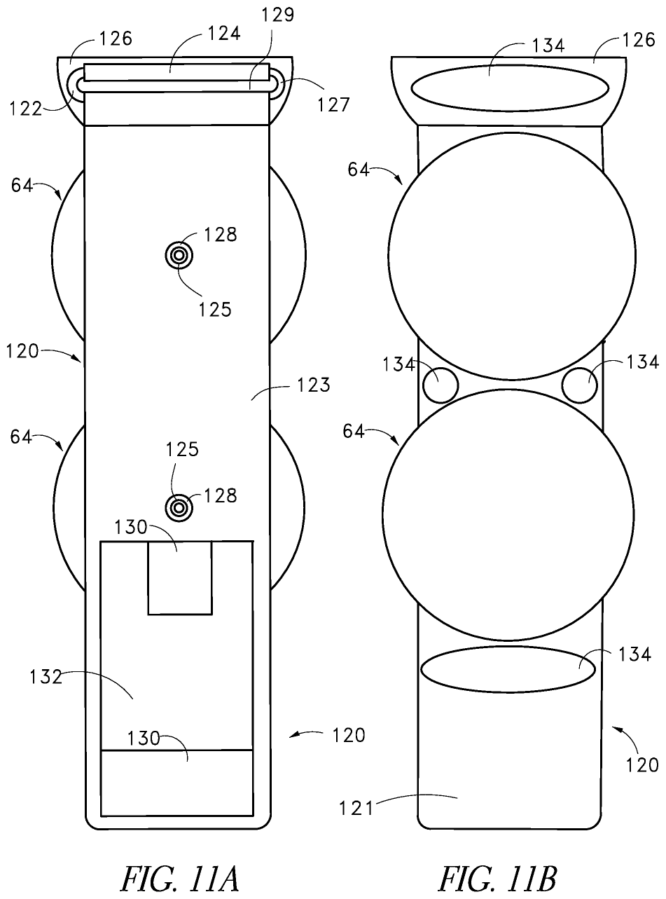

FIGS. 11A and 11B illustrate another embodiment comprising a buttock cuff 46 with two bladders 64 attached to cuff 46. In some examples, the cuff material 120 has an inner surface 121, an outer surface 123 and a hole 125 for insertion of bladder connector 114 of bladder 64. In some examples, the buttock cuff 46 can have a straight configuration, but may also be arcuate or any other configuration that is able to encompass a circumference of the body that includes the buttocks. The cuff material 120 can be made of any flexible non-stretch material able to withstand repeated inflations of bladder 64. In some embodiments, the non-stretch material comprises a 600 denier polyester cloth as used in backpacks. The rings 128 around holes 125 are optionally color-coded to indicate which complementary color-coded bladder air lines 48 are to be connected to the bladders 64. A portion of bladders 64 may be visible when viewing outer surface 123 of buttock cuff 46, which may facilitate accurate placement of the bladders 64 when securing cuff 46 to the patient. Outer surface 123 may also have identifying marks to show the position of underlying bladder 64 obscured by cuff 46.

In some embodiments, buttock cuff 46 comprises buckle 122 and optionally the buckle roller 124 and buckle shield 126 as previously described. Cuff material 120 can be made of any flexible non-stretch material able to withstand repeated inflations of bladders 64. In some embodiments, the non-stretch material comprises a 600 denier polyester cloth as used in backpacks. The hook fasteners 130 and loop fasteners 132 can be attached to the other end of cuff material 120 by stitching, gluing, or any of number of methods well known in the art. In some embodiments, the hook fasteners 130 and loop fasteners 132 are used to secure buttock cuff 46 when cuff 46 is tightened on the patient. In some examples, the width of buttock cuff 46 is approximately 6 inches with a circumferential length of about 60 inches. In some embodiments, cuff 46 has a width of about four inches to about ten inches and a circumferential length of about fifty to about ninety inches. In some embodiments, buttock cuff 46 comprises a plurality of bladders 64 from about one bladder 64 to about four bladders 64. Cutouts are optionally provided in cuff material 120 for vascular access or any other procedure requiring access to body areas covered by cuff material 120. FIG. 11B depicts an example of the invention comprising a non-slip material 134 on inner surface 121 of buttock cuff 46, as described in the previous leg cuff embodiment.

FIG. 11C illustrates the inner surface of cuff 42 without bladders 64. Bladder connectors 112 of bladders 64 can be inserted through holes 125 and rings 128 of cuff material 120 to attach to bladder air lines 48.

In some embodiments, hook fastener 130 is attached to cuff material 120 at one end and one surface of cuffs 42, 44 and 46 and loop fastener 132 is joined to cuff material 120 at the opposite end and opposite surface, allowing the cuffs 42, 44, 46 to be secured to the patient by wrapping one end of a cuff over the other end of the same cuff by coupling hook fastener 130 to loop fastener 132. In some embodiments, the buckle 122, buckle roller 124, and buckle shield are not included.

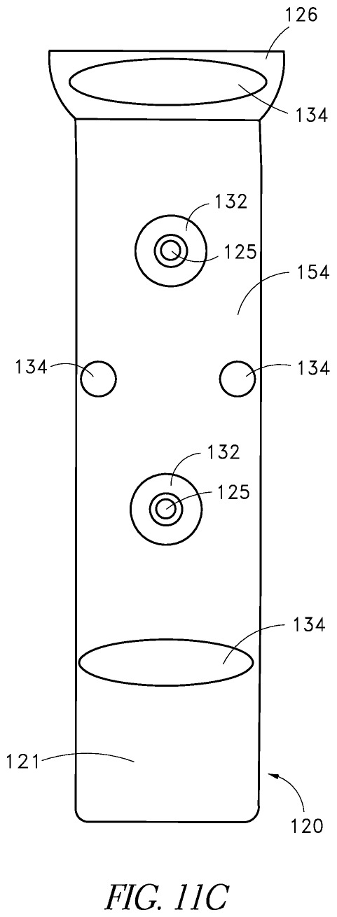

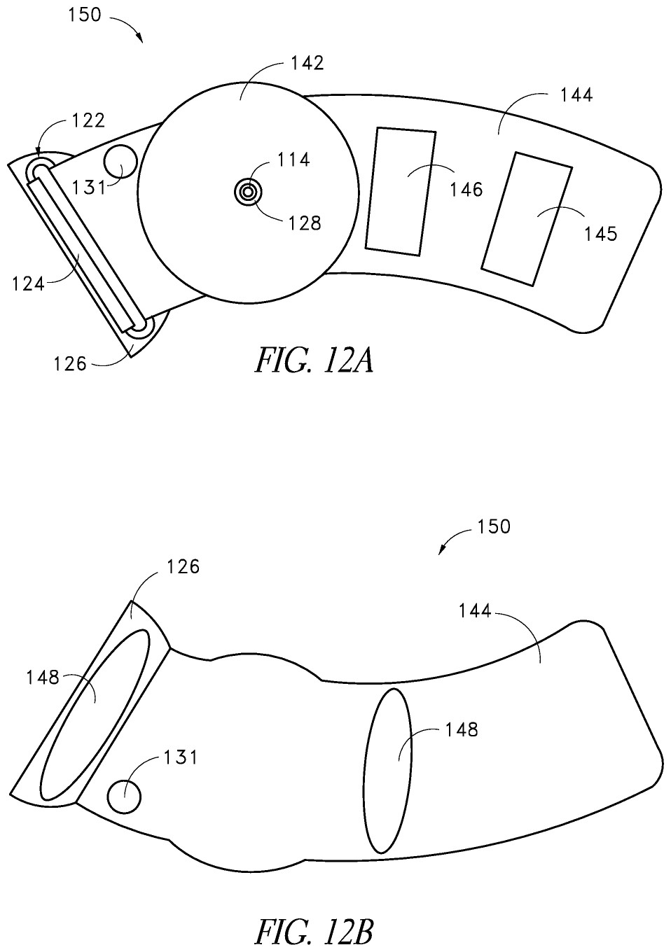

FIGS. 12A and 12B illustrate another embodiment of a left leg cuff 150. Right leg cuff 156 may have a similar configuration or a mirror image configuration of left leg cuff 150 and can have similar construction and materials. Optional color-coded ring 128 around bladder connector 114 indicates which color-coded bladder air line 48 is to be connected to which bladder connector 114. In some examples, bladder connector 114 is attached to bladder wall 142 by any of a variety of attachment methods including heat sealing, solvent sealing, gluing or any other hermetic sealing as known in the art. In some embodiments, the bladder wall 142 can be hermetically sealed to cuff material 144 using a sealing area of about ¼ inch on the outer edge of bladder wall 142, forming a bladder. In some embodiments, cuff material 144 is enlarged in width where bladder walls 142 are sealed to cuff material 144. Cuff material 144 may also have identifying marks to show the position of underlying bladder wall 142 obscured by cuff material 144. In some embodiments, the sealing area is about ⅛ to about ½ inch on the outer edge of bladder wall 142. Hermetic sealing may be performed by methods previously described. In some examples, the bladder wall 142 and cuff material 144 can include any of a variety of flexible non-stretch airtight materials, as previously described. Bladder wall 142 and cuff 144 may comprise different materials that are hermetically sealable together. For example, the bladder wall 142 may comprise any of a variety of non-stretch or semi-stretchable airtight materials, including but not limited to polyurethane materials made by Magister Corporation (Chattanooga, Tenn.), herein incorporated by reference. Use of semi-stretchable airtight materials for bladder wall 142 may facilitate inward volume expansion and pressure transmission to the patient.

In some embodiments, the leg cuff 150 comprises buckle 122 and optionally buckle roller 124 and buckle shield 126 as previously described. A self-adhesive hook 145 and loop fastener 146 can be attached to cuff material 144 near bladder wall 142. In some embodiments, the self-adhesive hook 145 can be a distance of between 0.5 inches-2.0 inches, between 0.5 inches-1.0 inches, between 1.0 inches-1.5 inches, and between 1.5 inches-2.0 inches from the edge of the bladder wall. In some embodiments, the self-adhesive hook 145 is 0.5 inches, 0.6 inches, 0.7 inches, 0.8 inches, 0.9 inches, 1.0 inch, 1.1 inches, 1.2 inches, 1.3 inches, 1.4 inches, 1.5 inches, 1.6 inches, 1.7 inches, 1.8 inches, 1.9 inches, 2.0 inches from the edge of the bladder wall. In some embodiments, only one side of self-adhesive hook and loop fastener 146 is attached to bladder wall 142. The topside of self-adhesive hook and loop fastener 146 is self-adhesive and covered with a wax paper-type protector. This can allow the operator to remove the protector and adhere the end of left leg cuff 150 to the self-adhesive when securing the cuff to the patient. This configuration can permit leg cuff 150 to be fitted to the patient and allow the removal of leg cuff 150 as medical needs dictate by separating the hook fastener from the loop fastener. In some embodiments, both hook fastener 130 and loop fastener 132 are pre-attached to leg cuff 150. In some examples, the width of leg cuff 150 can be approximately six inches with a length of approximately thirty to forty-five inches. In some embodiments, leg cuff 150 includes a self-adhesive non-slip material 148 on the inner surface of left leg cuff 150, of material and attached as previously described. Cutouts 131 can be optionally provided in cuff material 144 for vascular access or any other procedure requiring access to body areas covered by cuff material 144. This embodiment may also be particularly suited for use as a disposable cuff because of the simplified design and lower cost of manufacturing, but the embodiment is not limited to this particular use.

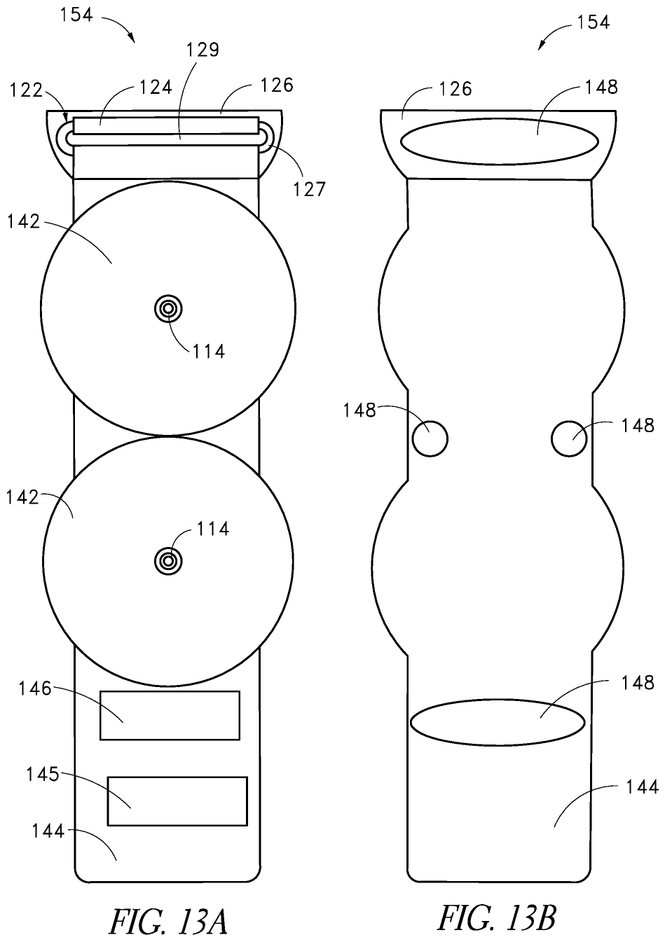

FIGS. 13A and 13B illustrate another embodiment of the buttock cuff 154. As shown, two bladder connectors 114 can be provided in bladder walls 142. In some examples, color-coded rings 128 can be included around bladder connectors 114 to indicate which color-coded bladder air lines 48 are to be connected to which bladder connectors 114. Bladder connectors 114 can be attached to bladder walls 142 by any of a variety of attachment methods including heat sealing, solvent sealing, gluing or any other hermetic sealing method as known in the art. In some embodiments, the bladder walls 142 are hermetically sealed to cuff material 144 using a sealing area of about ¼ inch on the outer edge of bladder wall 142, forming a bladder. In another embodiment, the sealing area is about ⅛ to about ½ inch on the outer edge of bladder walls 142. In some examples, cuff material 144 is enlarged in width where bladder walls 142 are sealed to cuff material 144. The cuff material 144 may also have identifying marks to show the position of the underlying bladder wall 142 that is otherwise obscured by cuff material 144. In some examples, hermetic sealing may be performed by heat sealing, solvent sealing, adhesives or any of a variety of hermetic sealing methods known in the art. In some embodiments, bladder walls 142 may comprise any of a variety of non-stretchable or semi-stretchable airtight materials known in the art. Use of semi-stretchable airtight materials for bladder wall 142 may facilitate inward volume expansion and pressure transmission to the patient.

In some examples, buttock cuff 154 comprises buckle 122 and optionally buckle roller 124 and buckle shield 126 as previously described. A self-adhesive hook 145 and loop fastener 146 can be attached to cuff material 144. In some examples, the outer surface of self-adhesive hook and loop fastener 146 is self-adhesive and covered with a wax paper-type protector. This can allow the operator to remove the protector and adhere the end of buttock cuff 154 to the self-adhesive after tightening on the patient. This configuration permits buttock cuff 154 to be fitted to the patient while also allowing the buttock cuff 154 to be removed as desired. In some examples, the buttock cuff 154 can be removed by separating the hook fastener from the loop fastener. In another embodiment, both hook fastener 145 and loop fastener 146 are pre-attached to the buttock cuff 154. In some examples, the width of buttock cuff 154 can be about six inches with a length of about sixty inches. In some embodiments, buttock cuff 154 comprises self-adhesive non-slip material 148 on the inner surface of buttock cuff 154, of material and attached as previously described. Cutouts are optionally provided in cuff material 144 for vascular access or any other procedure requiring access to body areas covered by the cuff material 144. This embodiment may also be particularly suited for use as a disposable cuff due to the simplified design and lower cost of manufacturing, but the embodiment is not limited to this particular use.

In some embodiments, the hook fastener is joined to the cuff material 144 at one end and one surface of the cuffs 150, 154, 156 while a loop fastener is joined to the cuff material 144 at the opposite end and the opposite surface. This configuration can allow the securing of cuffs 150, 154, 156 to the patient by wrapping one end of a cuff over the other end of the same cuff. In some examples, this embodiment does not require buckle 120 and may further simplify the cuff design and lower the cost of manufacturing.

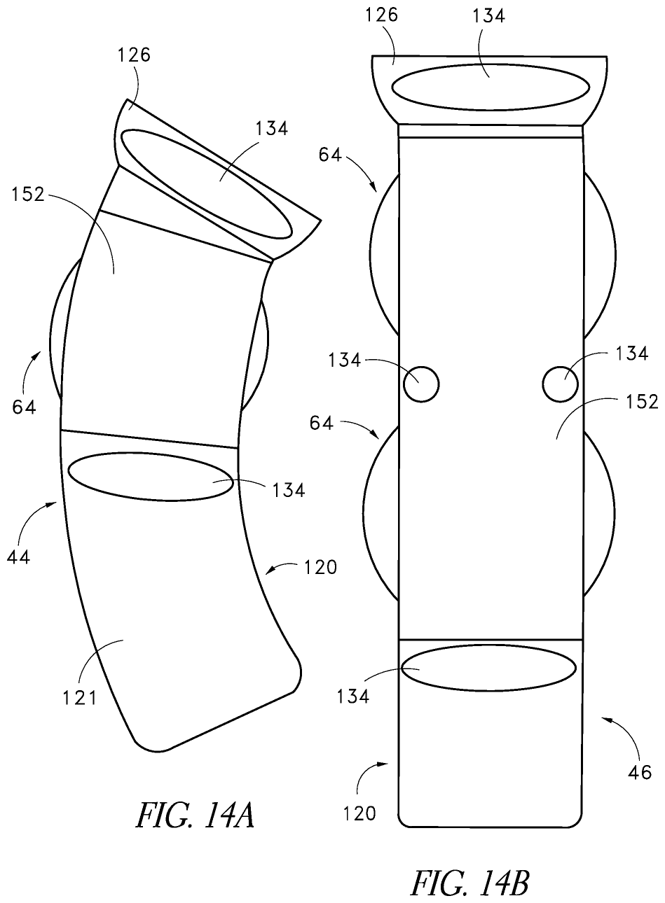

FIG. 14A illustrates another embodiment of the leg cuff 44 wherein a padding 152 is placed on inner surface 121 of leg cuff 44. In some examples, the padding 152 is a cloth, foam or encapsulated gel material used to reduce skin irritation resulting from multiple hours of treatment or in patients with sensitive skin. One skilled in the art will understand that any type of skin-protective covering or padding may be used. FIG. 14B illustrates an embodiment of the buttock cuff 46 comprising padding 152.

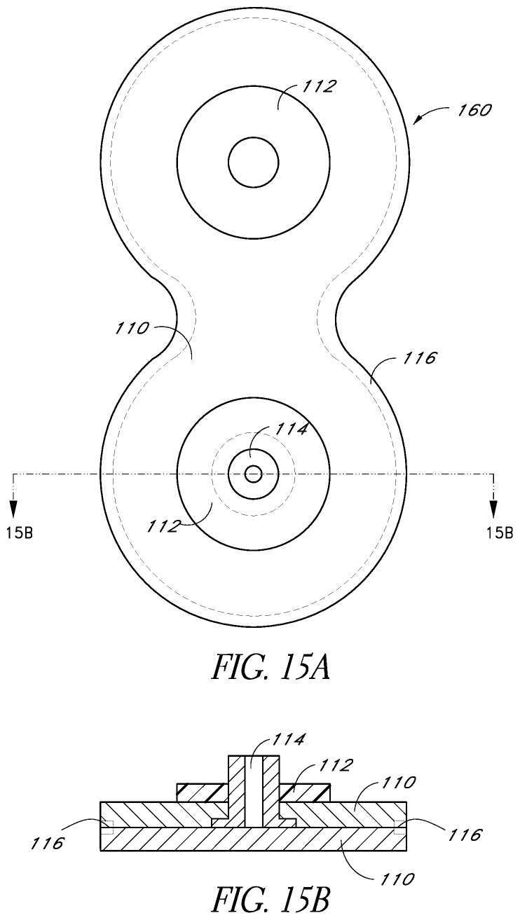

FIGS. 15A and 15B illustrate another embodiment of a bladder comprising a single buttock bladder 158. In some examples, one bladder connector 114 is attached to bladder wall 110 having an hourglass shape and a surface area of about seventy-two square inches. Although FIG. 15A depicts buttock bladder 158 with an hourglass shape, any closed loop shape may be used, including squares, rectangles, triangles or a combination thereof. A second bladder connector 114 may be optionally attached to the other portion of buttock bladder 158. In some examples, bladder connector 114 can have an internal diameter of about ¼ inch to about ¾ inch. In some embodiments, bladder wall 110 can be hermetically attached to a second bladder wall 110 having an hourglass shape and a surface area of about seventy-two square inches. In some examples, bladder wall 110 can be attached to the second bladder wall 110 by providing an air tight seal that is configured to withstand about ten psi inflation pressure. In some embodiments, the bladder sealing area 116 is approximately about ⅛ inch to about ⅜ inch wide. In some examples, the hook fastener ring 112 can be adhered to the area surrounding bladder connectors 114. In some embodiments, the surface area of single buttock bladder 158 when flat is about seventy-two square inches.

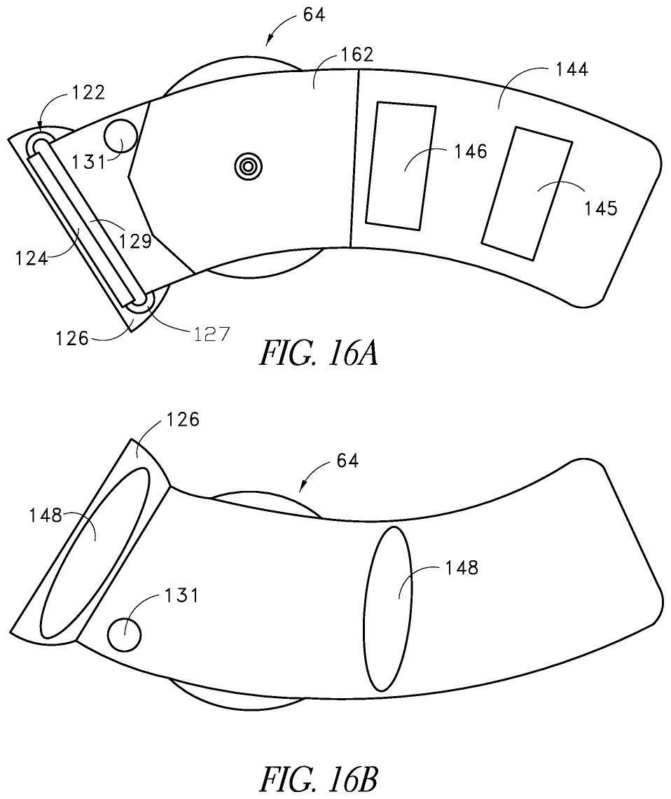

FIGS. 16A and 16B illustrate another embodiment of the left leg cuff 150 with a leg bladder pocket 162 for holding and reversibly attaching bladder 64. As discussed above, the right leg cuff 156 can be identical or similar to the left leg cuff 150. Leg bladder pocket 164 can include a flexible material attached to cuff material 144. In some embodiments, pocket 164 comprises the same material as cuff material 144. In some examples, cutouts 131 are optionally provided in cuff material 144 for vascular access or any other procedure requiring access to body areas covered by cuff material 144.

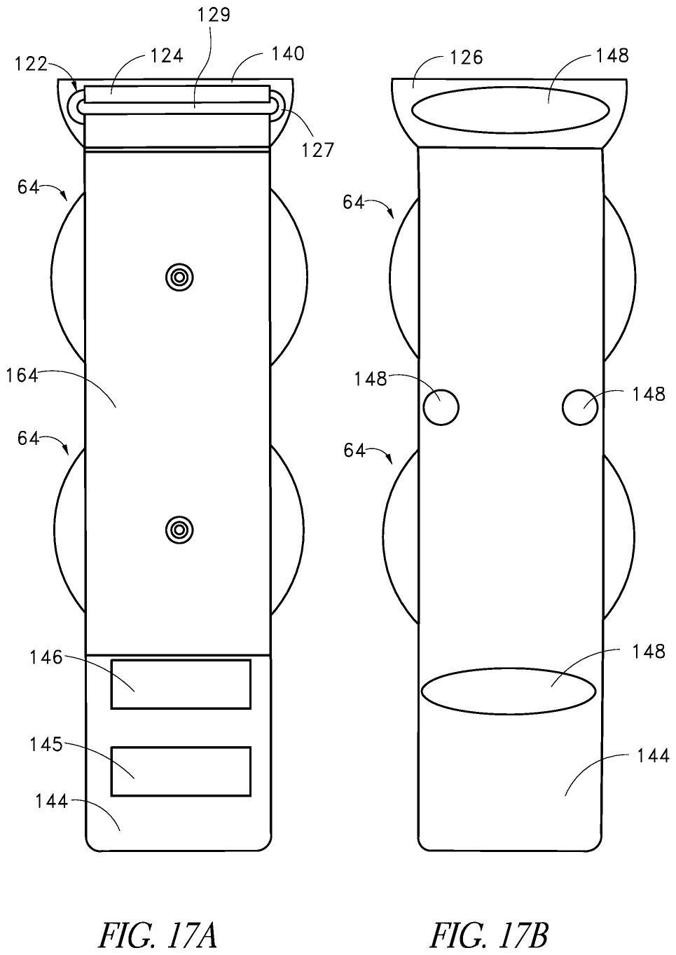

FIGS. 17A and 17B illustrate another embodiment of buttock cuff 154 with an optional buttock bladder pocket 164 to allow the use of two bladders 64 or single buttock bladder 158. Buttock bladder pocket 164 can be made of a flexible material able to be attached to cuff material 144. In some embodiments, pocket 164 comprises the same material as cuff material 144.

Although the embodiments described above describe inflatable bladders and cuffs to provide the compression for ECP, one skilled in the art can adapt other compression mechanisms to provide ECP treatment using limited compression to the upper-posterior knees, inguinal regions and buttocks of a patient. For example, U.S. Pat. No. 6,620,116 to Lewis, herein incorporated by reference, discloses the use of electromechanical actuators in cuffs for compression. These electromechanical actuators can be adapted as ECP compression members to supply a total compression surface area of about 240 square inches or less to the upper-posterior knees, inguinal regions and buttocks.

Other embodiments of the ECP device can include but are not limited to the use of other gases or liquids as an inflation fluid, including but not limited to water, nitrogen or helium. Helium has a lower fluid density and viscosity compared to atmospheric air and can advantageously provide higher fluid flow rates at the same pressures. Other gases or combination of gases may also be used. Because of the cost of helium, an embodiment of the device using helium may further comprise a closed fluid system whereby deflation of the bladders occurs by venting the valves into a reservoir rather than to the atmosphere. One such closed system for ECP is disclosed in U.S. Pat. No. 6,572,621 to Zheng et al., herein incorporated by reference. The fluid vented to the reservoir is then recompressed and stored in air tank 52 for reuse in inflating bladders 64. Other alternative embodiments of the ECP system are described below.

In some embodiments, a temperature-controlled ECP system is provided. A temperature-controlled system may be desirable for some patients with skin conditions or for use in critical care or surgical environments, including but not limited to stroke treatment, hypothermia, cardiovascular surgery and neurosurgery. In one embodiment, heating and/or cooling coils may be embedded or applied to the cuffs or bladders. In a further embodiment of the invention, a reversible heat pump is attached to a set of temperature coils in the cuffs so that cooling or heating may be performed with the same set of coils. In another embodiment, the gas or liquid inflating the bladders may be cooled or heated to provide temperature control. Any of a variety of temperature control systems, as is known in the art, may be used to provide a temperature-controlled ECP system.

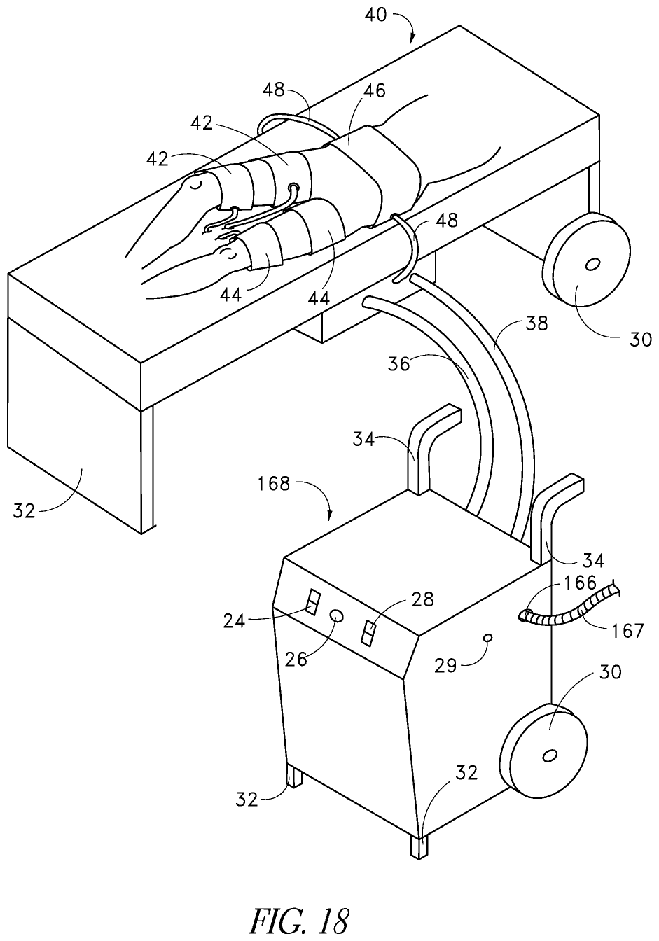

FIG. 18A illustrates an embodiment of the ECP system 22 that is capable of using an external supply of compressed air. The external air supply tubing 167 can be connected to external compressed air supply inlet 166 that is attached to pressure regulator 54. In some embodiment, ECP system 22 comprises air supply inlet 166 without air compressor 50. In some embodiments, ECP system 22 comprises both air supply inlet 166 and air compressor 50 and either source may be used to supply compressed air to bladders 64.

In some embodiments, the ECP system 22 can include an O₂ (or air or CO₂, or other compressed gas) tank or source, a pneumatic counsel, a breathing console, a mask configured to be positioned on the patient's face, and the ECP system comprising a plurality of bladders and cuffs on the upper and lower extremities on the patient. In particular, the disclosed ECP system can be configured to maintain blood circulation and enhance oxygen circulation. Because of the relative portability of the above-described system, the disclosed ECP system 22 can be easily used in an emergency vehicle (i.e., an ambulance) or even on a plane or a boat.

In some embodiments, the ECP system can include a pneumatic console. The pneumatic console can be configured to power the O₂ tank and the breathing console. In some examples, the pneumatic console is configured to regulate the timing of the cuff and the pressure within the O₂ tank is configured to inflate each of the plurality of bladders on the patient. In some embodiments, the pressure provided into each of the plurality of bladders is relative to atmospheric pressure. In some embodiments, the pneumatic console is configured to include a timer that cycles. In some examples, the pneumatic console can be electrically powered.

In some examples, the ECP system 22 can include an O₂ tank. In some embodiments, the O₂ tank can include at least one pony bottle that can provide an additional 15-20 minutes of oxygen. As well, the coupling of the pony bottle(s) can allow the ECP system to have multiple sources of O₂ and/or to switch sources of O₂ with minimal disruption. In some embodiments, the O₂ tank is fluidly connected to the breathing console. In some examples, the breathing console is configured to provide constant positive pressure to the diaphragm through the face mask. In some embodiments, the face mask is configured to keep a slight flow of air into and out of the lungs. In some embodiments, the breathing console is configured to force oxygen into the lungs. Thereafter the diaphragm naturally collapses to push the air out.

In some embodiments, the O₂ tank of the ECP system is configured to inflate the plurality of cuffs with attached bladders on the patient. In some embodiments, the plurality of cuffs with attached bladders can be placed on the upper and/or lower extremities of the patient. In some embodiments, the cuffs can be included on the buttock. In some examples, the plurality of cuffs with attached bladders can be configured to provide blood flow between approximately 40 to 60 cycles per minute. In some embodiments, the plurality of cuffs with attached bladders on the upper extremities of the patient (e.g., the arms) can be configured to provide blood flow and oxygen to the brain and to the heart. In some examples, the plurality of cuffs with attached bladders on the lower extremities of the patient (e.g., the leg) can be configured to provide blood flow and oxygen to the heart and major organs.

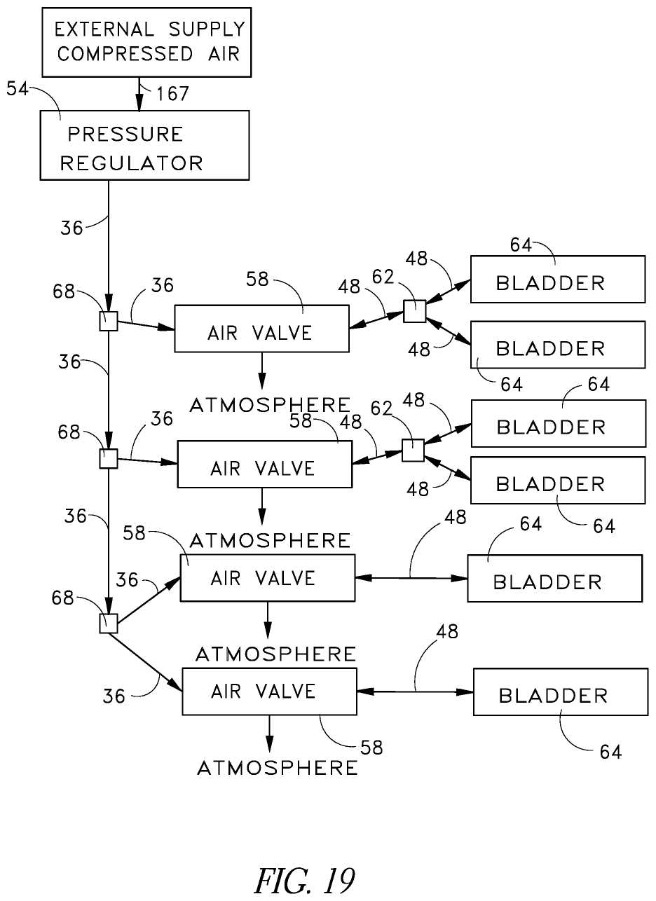

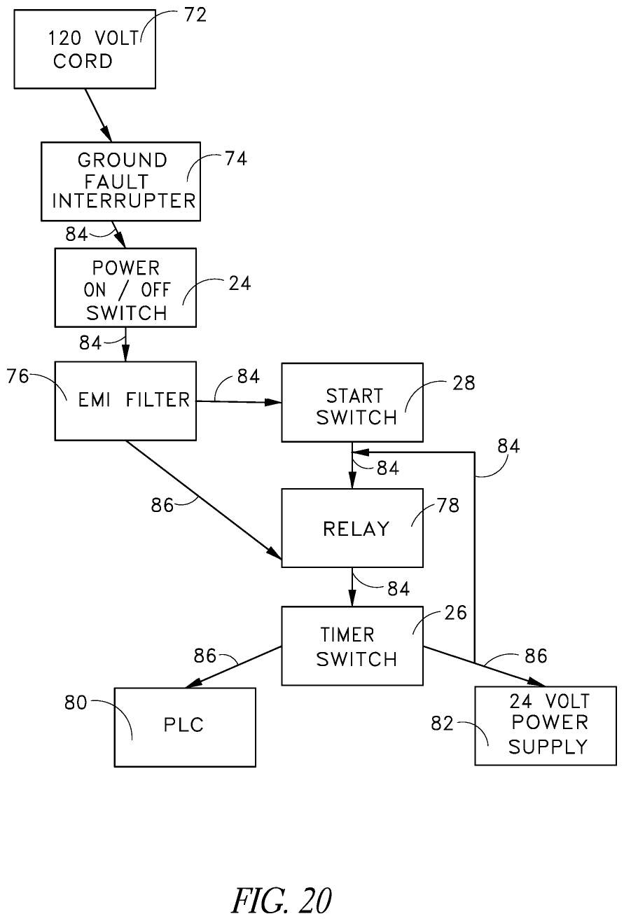

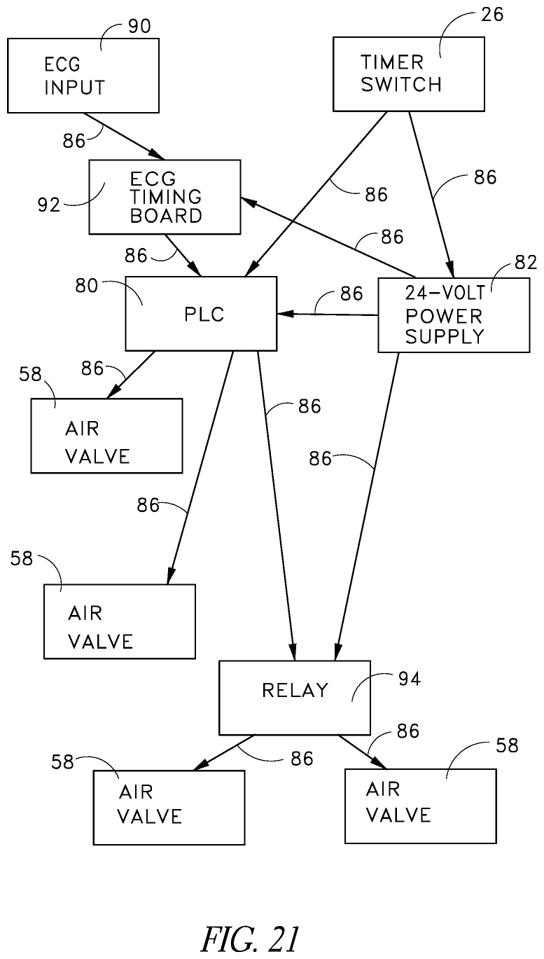

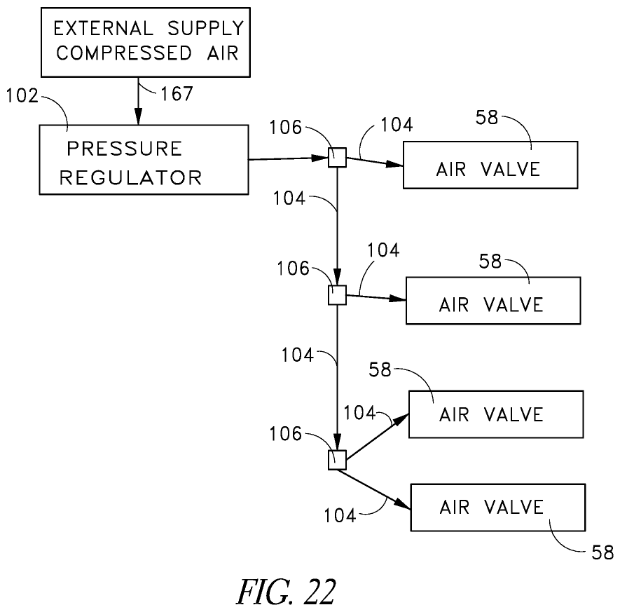

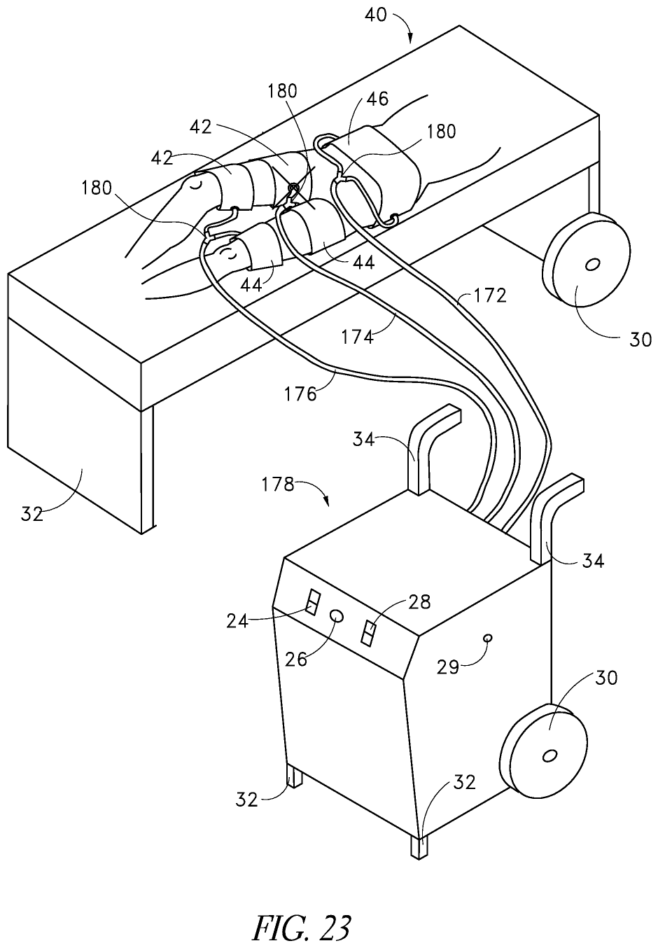

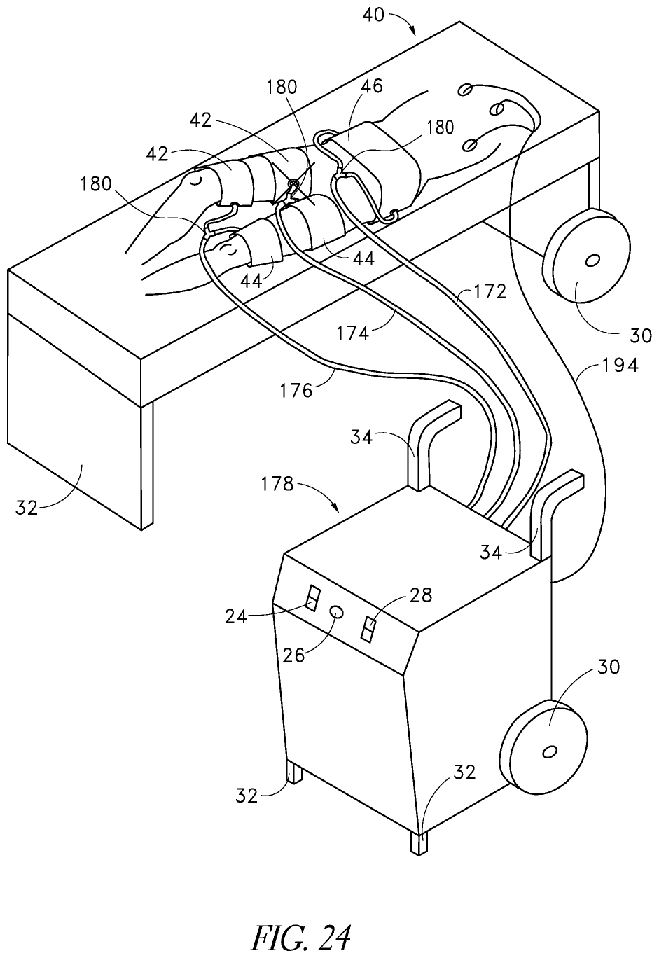

FIG. 19 illustrates a schematic of an embodiment of the ECP system including an external supply of compressed air. The air supply can connect to air supply tubing 167 that attaches to pressure regulator 54. The remaining connections of this embodiment are otherwise similar to that shown in FIG. 3 above. FIG. 20 illustrates a schematic of the 120-volt electrical power system for this embodiment where an external source of compressed air is utilized. Similarly, FIG. 21 illustrates a schematic of the 24-volt electrical system, without the mini air compressor. FIG. 22 illustrates a schematic depicting the use of externally supplied compressed air for providing pilot assist air for air valves 58. 1091411 FIG. 23 illustrates another embodiment of an ECP system 178 and a table 40 where the air line, the control line and the valves are integrated into the housing of the ECP system 178. In some examples, the air hoses 172, 174 and 176 directly connect the ECP system 178 to cuffs 42, 44 and 46, so that any surface, such as a hospital bed, may be used for patient treatment instead of table 40. Thus, patients do not have to be moved to any particular table to undergo treatment. In some examples, the hose comprises flexible plastic tubing of about ⅜ inch to about ⅝ inch internal diameter. Mechanical disconnects are optionally provided for partially disassembling system 178. In some examples, “Y” fittings 180 on each hose permit one hose to connect each pair of balloons. Each hose may be color-coded to aid the operator in properly connecting each hose to the correct balloon pair.

In some embodiments, as illustrated in FIG. 2, the ECP system 22 and table 40 are configured to facilitate transport of the system. ECP system 22 and table 40 may each have at least one wheel 30 to permit rolling of each component when the component is tilted onto wheels 30. Handles 34 may be provided for gripping and leverage when tilting. ECP system 22 and table 40 can also have at least one leg 32 to prevent movement of the components without the use of a brake.

To utilize the ECP system previously described, a patient is laid on table 40 and two right leg cuffs 42, two left leg cuffs 44, and buttock cuff 46 are placed on the patient. An off-the-shelf ECG monitor can be attached to the patient to provide an ECG signal. In some embodiments, an ECG/QRS detector can be incorporated into the ECP system 22. The ECP system 22 can then be powered up using on/off power switch 24. The treatment duration for the patient can then be set on timer switch 26. In some examples, the start switch 28 is pressed to start the treatment. The intervals between the detection of a QRS complex and the initialization of the first output or control signal from PLC 80 can be determined by taking the average heart rate over the previous series of QRS complexes or over a previous set period of time. By basing the delay interval of the first control signal on the R-to-R interval or peaks between sequential QRS events or any consistent detected region of the electrocardiogram wave form or vascular pressure wave form, a patient population with a greater range of resting heart rates may be treated. For example, patients with resting heart rates from about 30 beats per minute (bpm) can undergo treatment up to patients with resting hearts rates of about 110 bpm can safely be treated, though physical embodiment may truncate this range to further increase patient safety and reduce system size by requiring reduced air capacity. The duration of the first output, the duration and intervals of the subsequent outputs originating from the detected QRS complexes can be preset or calculated by the system. In one embodiment, the delay interval is 25% of the average of the last eight peak-to-peak intervals of squared ECG signal. The inflation pressures of bladders 64 can also be preset by the system to a maximum of about 200 mmHg. In the event of a power failure, the ECP system 22 can stop operating and not restart unless start switch 28 is pressed. Air valves 58 can also revert to normally closed positions and vent bladders 64 during a power outage when no control signals are provided by PLC 80. To stop the treatment before the time ends, an on/off power switch 24 can be pressed. In some examples, the time remaining for treatment on timer switch 26 does not change due to stops or power failures.

A signal from the ECG monitor is sent to ECP system 22 through ECG input connector 29. The signal goes to ECG timing board 92 where it is amplified and relayed to programmable logic controller 80. Programmable logic controller 80 sends a signal to air valves 58 controlling right leg cuff 42 and left leg cuff 44 placed on the lower thighs or upper posterior knees. Approximately forty milliseconds later, programmable logic controller 80 sends another signal to air valve 58 controlling right leg cuff 42 and left leg cuff 44 placed on the upper thighs or inguinal regions. After another approximately forty milliseconds delay, the programmable logic controller 80 sends a signal to two air valves 58 controlling buttock cuff 46 placed on the buttocks. The signals terminate generally at the same time after a fixed interval following the detection of the QRS complex in that cycle.

With the air assist provided from mini air compressor 96, the signals from the PLC 80 can open the air valves 58. The pressurized fluid from air compressor 50 can pass through air tank 52. In some examples, the fluid can pass through pressure regulator 54. The pressure can be set at a limit of about 155 to about 240 mm Hg by pressure regulator 54. In some embodiments, the pressure is preset to 200 mm Hg. In some examples, Pressure buildup over about 700 mm Hg can be vented by pressure relief valve 56. In some embodiments, when air valve 58 opens, it closes the exhaust port and allows pressurized fluid to inflate balloon 64. After a preset time of about 450 milliseconds from the start of lower thigh inflation, the signals from programmable logic controller 80 can be stopped. When the signals stop, air valves 58 close at about the same time and can vent the pressures in balloons 64. In some embodiments, valves 58 allow balloons 64 to inflate if there is power and signal from programmable logic controller 80. In some examples, any interruption of power can cause air valve 58 to close and exhaust balloons 64. The venting of balloons 64 can be a fail-safe in case of power loss. This cycle can be repeated until the treatment period finishes.

In some embodiments, right leg cuffs 42, left leg cuffs 44, and buttock cuff 46 are placed on the patient. Right leg cuffs 42, left leg cuffs 44 and buttock cuff 46 are tightened by inserting the cuff end into buckle 122 and pulling the cuff end tight. Once tight, the cuff ends can be pressed to fasten hook fastener 130 to loop fastener 132. In some embodiments, right leg cuffs 42, left leg cuffs 44, and buttock cuff 46 are tightened to give effective treatment. Use of buckle 122 and buckle roller 124 can facilitates tightening of the cuffs by the operator. The buckle shield 126 can reduce pinching of the patient's skin by buckle 122. Balloons 64 of right leg cuffs 42, left leg cuffs 44 and buttock cuff 46 can be connected to balloon air lines 48. In some examples, balloon air lines 48 are configured to both inflate and deflate balloons 64. Balloon 64 can be held in place on right leg cuff 42, left leg cuff 44 or buttock cuff 46 with hook fastener ring 112 and loop fastener 132. This can allow balloon 64 to be independently replaced without having to replace right leg cuff 42, left leg cuff 44 or buttock cuff 46. In some examples, the hook fastener ring 112 and loop fastener 132 can allow attachment of balloon 64 to the cuff without the use of cuff pockets. In some embodiments, balloon wall 110 can transfer the pressure to the patient without any reduced effect from added layers of material and result in more efficient treatment while using less pressure.

In some examples, the cuffs described above (e.g., left leg cuff 150, right leg cuff 156 and buttock cuff 154) can be disposable. The disposable cuffs 150, 154 and 156 can be tightened in the same manner as previously described. The operator can remove the adhesive protector from self-adhesive hook and loop fastener 146 and press the portions of cuffs 150, 154 and 156 overlying self-adhesive hook and loop fastener 146 to adhere fastener 146 to another portion of the cuff. In some examples, cuffs 150, 154 and 156 may be unfastened and refastened using the hook and loop fastening of self-adhesive hook and loop fastener 146. In some embodiments, vascular access to the femoral arteries and veins, or a vascular catheter already placed therein, are accessible through access openings in cuff material 144.

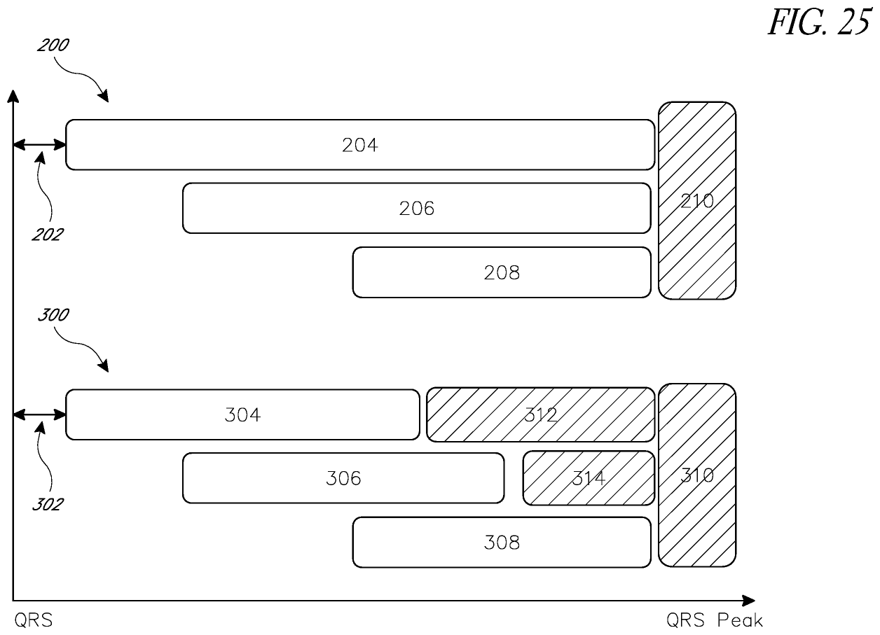

FIG. 25 illustrates a schematic representation of alternative embodiments of an ECP system. FIG. 25 depicts a comparison of the pressurization and refill time of a first, second, and third compression member (e.g., cuff set) in a first, concurrent depressurization embodiment of an external counterpulsation system 200 and a second, staggered depressurization embodiment of an external counterpulsation system 300. FIG. 25 comprises an axis showing time beginning after a QRS complex and ending at a QRS peak. As shown in FIG. 25, in the concurrent depressurization embodiment of external counterpulsation systems 200, the first cuff set (e.g., the knee or lower thigh cuffs) may first be pressurized following a delay 202 after a QRS complex. Determination of the delay time can be performed as described herein. The pressurization time of the first cuff set is represented by bar 204. After a certain time, the second cuff set (e.g., the thigh cuffs) may be pressurized. The pressurization of the second cuff set is represented by bar 206. After another period of time, the third cuff set (e.g., the buttocks cuffs) may be pressurized. The pressurization of the third cuff set is represented by bar 208. The three sets of cuffs may then be simultaneously or nearly simultaneously depressurized. Following depressurization, there may be an interval period 210, during which time the venous blood vessels in the vicinities of the cuff sets may recover and refill. While the concurrent depressurization embodiment 200 has been shown using three compression members or cuff sets, it will be appreciated that other numbers of compression members (e.g., 1, 2, 4, 5, greater than 5, etc.) are also possible.

In the second, staggered depressurization embodiment 300, the first cuff set (e.g., the knee or lower thigh cuffs) may first be pressurized following a delay 302 after a QRS complex, like in the concurrent pressurization embodiment 200. The pressurization time of the first cuff set is represented by the bar 304. After a period of time, the second cuff set (e.g., the thigh cuffs) may be pressurized. The pressurization time of the second cuff set is represented by the bar 306. After a period of time, the third cuff set (e.g., the buttocks cuffs) may be pressurized. The pressurization time of the third cuff set is represented by the bar 308. While the second cuff set is pressurized, the first cuff set may be depressurized, beginning the recovery or refilling period. The recovery period of the first cuff set is represented by bar 312. The recovery period of the first cuff set 312 is shown as beginning subsequent to the pressurization period 308 of the third cuff set. However, in some embodiments, the recovery period 312 of the first cuff set may begin prior to the pressurization period 308 of the third cuff set. While the third cuff set is pressurized, the second cuff set may be depressurized, beginning the recovery or refilling period. The recovery period of the second cuff set is represented by bar 314. After the third cuff set has been pressurized for a period of time, the third cuff set is depressurized. At that point, all three cuff sets may be in a recovery period, represented by bar 310. As shown in the staggered depressurization embodiment 300, the first cuff set recovery period 312 and the second cuff set recovery period 314 provide a greater amount of recovery time than in the concurrent depressurization embodiment. While the staggered depressurization embodiment 300 has been shown using three compression members or cuff sets, it will be appreciated that other numbers of compression members (e.g., 1, 2, 4, 5, greater than 5, etc.) are also possible.

In some embodiments, each cuff may be pressurized for a period of about 350-400 ms. In some embodiment, each cuff is pressurized for a period of about 370 ms. In some embodiments, each cuff is pressurized for a same amount of time. In some embodiments, the cuffs are pressurized for different amounts of time. The delay between pressurization of the first and second cuff members and the delay between pressurization of the second and third cuff members may be about 10-70 ms. In some embodiments, the delay between pressurization of the first and second cuff members and the delay between pressurization of the second and third cuff members is about 30-50 ms. In some embodiments, the delay between pressurization of the first and second cuff members and the delay between pressurization of the second and third cuff members is about 40 ms. The delay between pressurization of the cuff members may be the same or different. In some embodiments, the extra recovery period 312 that occurs in the staggered depressurization embodiment 300 for the first set of cuffs may be about 20 ms to about 140 ms. In some embodiments, the extra recovery period 312 is about 80 ms. In some embodiments, the extra recovery period 314 that occurs in the staggered depressurization embodiment 300 for the second set of cuffs may be about 10 ms to about 70 ms. In some embodiments, the extra recovery period 314 may be about 40 ms.

As illustrated by FIG. 25, staggering the depressurization of the cuff sets so that they are depressurized midcycle relative to other cuff sets, as in the second embodiment 300 may give the venous system in a vicinity around the first and second cuff sets greater recovery time than in a concurrent depressurization embodiment 200. Greater recovery time may allow the venous vasculature more time to refill, which may allow for increased refilling of the venous vasculature. Increasing the volume of blood in the venous system prior to inflating the cuffs during diastole can increase the venous pressure, which can further enhance cardiac output. The depressurization during pressurization may give the patient the feeling that the treatment is smoother (e.g., less abrupt). The increased blood available for each subsequent compression cycle is expected to increase the treatment efficacy and possibly reduce the total treatment time needed to achieve clinically relevant results.

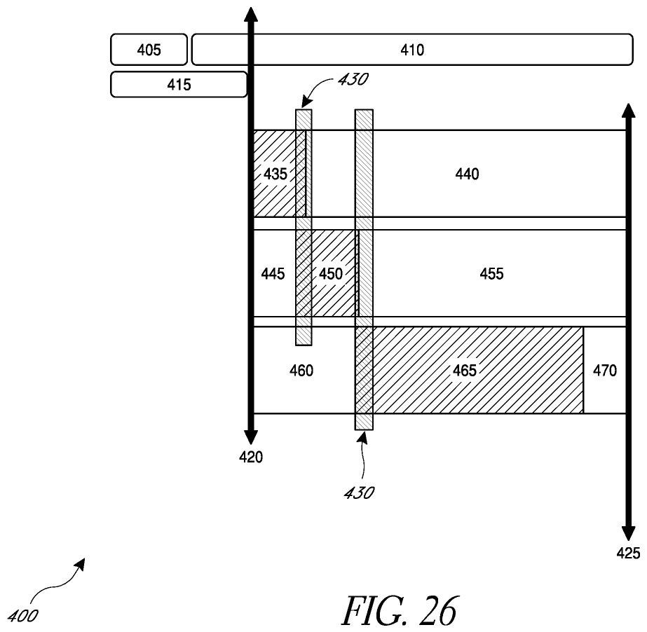

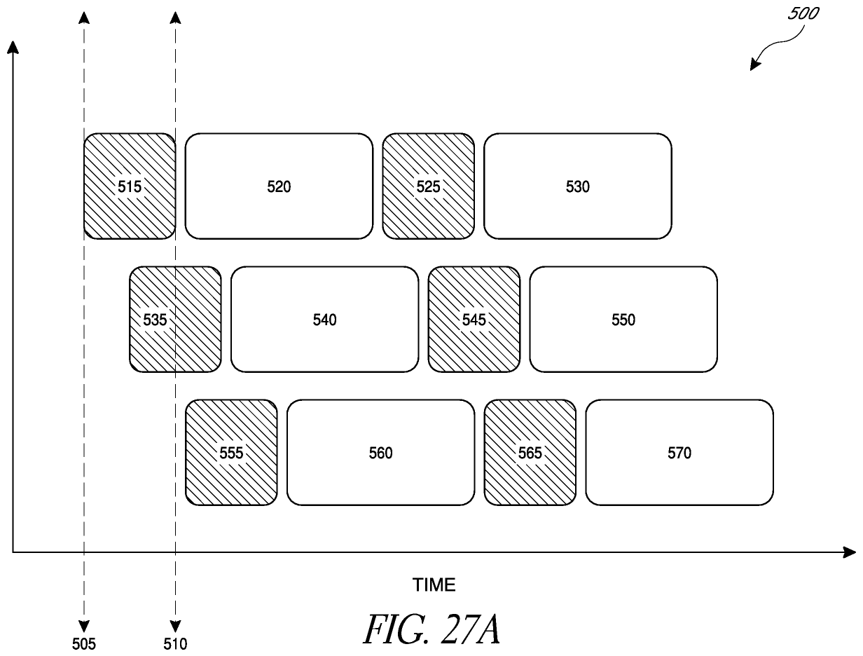

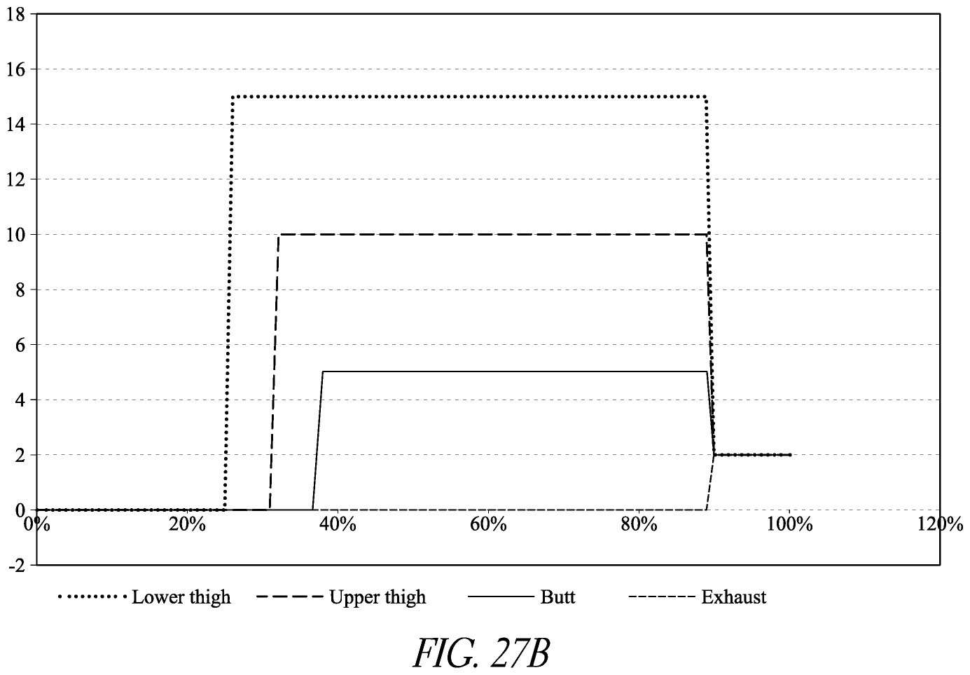

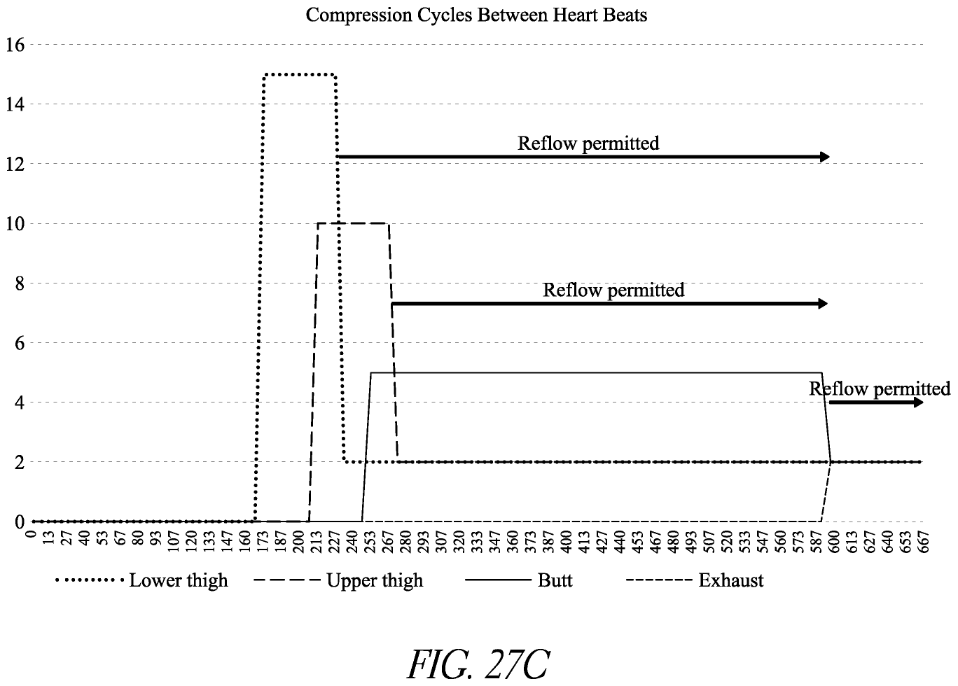

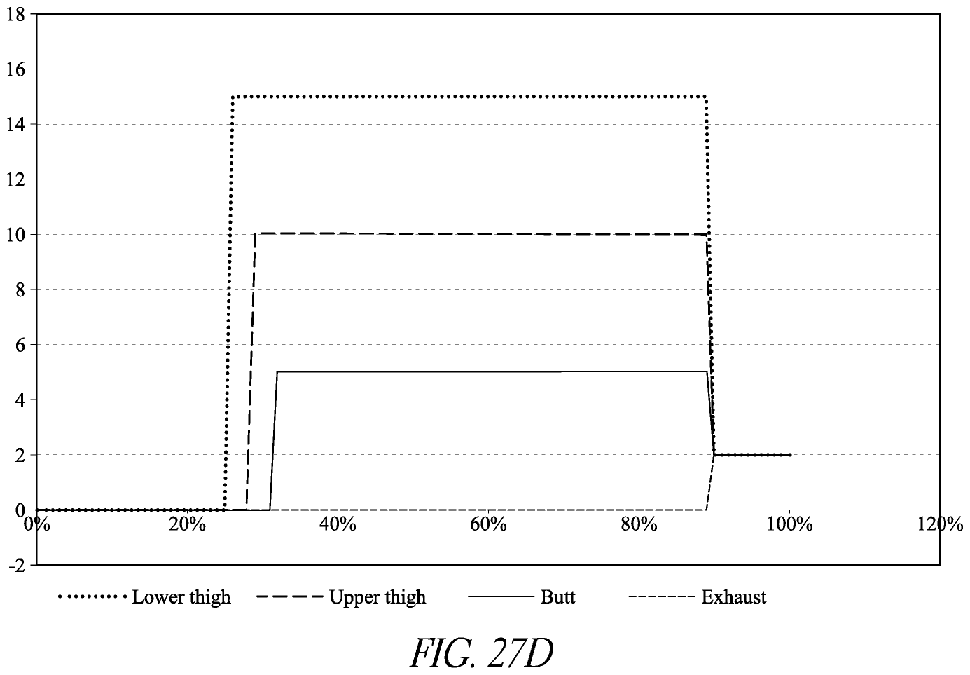

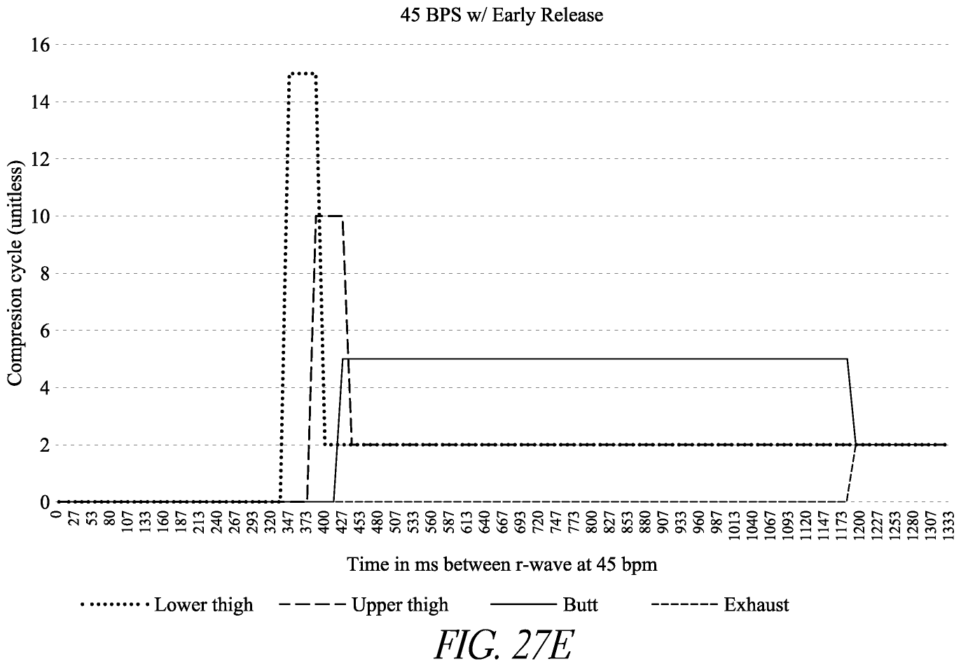

FIGS. 26 and 27A-27E illustrate additional schematic representations of alternative embodiments of an ECP system. FIG. 26 illustrates a staggered pressurization and depressurization embodiment of an external counterpulsation system 400. FIG. 27A illustrates another embodiment of a staggered pressurization and depressurization embodiment of an external counterpulsation system 500. FIGS. 27B-27E illustrates various examples of the cycling of the external counterpulsation system 500 in patients having a target heart rate of 90 bpm and patients having a target heart rate of 45 bpm.

In some embodiments, FIG. 26 depicts the pressurization and refill of a plurality of compression members (e.g., a cuff set comprising a first, second, and third compression member) wherein the external counterpulsation system 400 is staggered. FIG. 26 illustrates an axis showing the cycle start 420 after systole 405 and shortly after the start of diastole 410. In some examples, the cycle start 420 occurs after a delay 415 of approximately 25% of the heart rate of the patient. In some examples, the cycle start 420 occurs after a delay 415 occurring approximately after a QRS complex (i.e., after a r-wave peak). As shown in FIG. 26, the external counterpulsation system 400 includes a staggered pressurization and depressurization of a plurality of compression members. In some examples, the first cuff set can be the most distal from the heart. In some embodiments, the first cuff set is positioned behind the knee or the lower thigh. In some examples, the first may be positioned relative to the target organ. For example, in order to perfuse the brain, a system including only arm cuffs at lower pressure may be sufficiently effective. In some examples, leg cuffs may be used as a supplement the previously-described system. By providing for brain perfusion with only arm cuffs, such a system can be small and portable, thereby making it easy to treat disorders effecting the brain (such as Alzheimer's, dementia, depression, etc.) and potentially in a home environment reducing the cost of healthcare.

In some examples, the first cuff set may first be pressurized after a delay 415 of approximately 25% of the heart rate of the patient. In some examples, the delay 415 is approximately 40 ms after the r-wave peak. In some embodiments, the determination of the delay time 415 can be performed as described herein. The pressurization time of the first cuff set is represented by the bar 435. In some examples, the pressurization time of the first cuff set is approximately 40 ms. In some embodiments, the pressurization of the first cuff set is long enough to prevent back flow and before any reflow is allowed into previously constricted regions. In some examples, after a period of time, the second cuff set (e.g., located in the upper inguinal/groin, upper interior thigh region) may be pressurized. The delay time before the pressurization of the second cuff set is represented by bar 445 and the pressurization time of the second cuff set is represented by bar 445. In some examples, the pressurization time of the second cuff set is approximately 40 ms. In some embodiments, the pressurization of the second cuff set is long enough to prevent back flow and before any reflow is allowed into previously constricted regions. In some examples, after a period of time, the third cuff set (e.g., located in the buttock, arms, etc.) may be pressurized. The delay time before the pressurization of the third cuff set is represented by bar 460 and the pressurization time of the third cuff set is represented by bar 465.

In some examples, while the second cuff set is pressurized at bar 435, the first cuff set may be depressurized, beginning the recovery or refilling period. The recovery period of the first cuff set is represented by bar 440. In some examples, the recovery period illustrated by bar 440 provides sufficient reflow to allow oxygenated blood into previously constricted areas. This can help to improve or restore tissue oxygenation to the region previously constricted and prepare the region for the next compression cycle. As shown in FIG. 26, in some examples, the recovery period of the first cuff set at bar 440 can occur during the pressurization period of the second cuff set at bar 450. However, the depressurization of the first cuff set at bar 440 can occur before or after the pressurization period of the second cuff set at bar 450. While the third cuff set is pressurized at bar 465, the second cuff set may be depressurized, beginning the recovery or refilling period. The recovery period of the second cuff set is represented by bar 445. In some examples, the recovery period illustrated by bar 455 provides sufficient reflow to allow oxygenated blood into previously constricted areas. This can help to improve tissue oxygenation. As shown in FIG. 26, in some examples, the recovery period of the second cuff set at bar 455 can occur during the pressurization period of the third cuff set at bar 465. However, the depressurization of the second cuff set at bar 455 can occur before or after the pressurization period of the third cuff set at bar 465. After the third cuff set has been pressurized for a period of time at bar 465, the third cuff bar can be depressurized. The recovery period of the third cuff set is represented by bar 470. In some examples, the recovery period illustrated by bar 470 provides sufficient reflow to allow oxygenated blood into previously constricted areas. This can help to improve tissue oxygenation. At that point, all three cuff sets may be in a recovery period and the system reaches the cycle end 425. As described above, each of the three described compression members or cuff sets illustrated in FIG. 26 can be pressurized and depressurized in a staggered configuration. In some embodiments, there can be an overlap in the pressurization of the compression members or cuff sets as illustrated in bars 430. While the staggered depressurization embodiment 400 has been shown using three compression members or cuff sets, it will be appreciated that other numbers of compression members (e.g., 1, 2, 4, 5, greater than 5, etc.) are also possible.

In some embodiments, each cuff may be pressurized for a period of about 350-400 ms. In some embodiment, each cuff is pressurized for a period of about 370 ms. In some embodiments, each cuff is pressurized for the same amount of time. In some embodiments, the cuffs are pressurized for different amounts of time. The delay between pressurization of the first and second cuff members and the delay between pressurization of the second and third cuff members may be about 10-70 ms. In some embodiments, the delay between pressurization of the first and second cuff members and the delay between pressurization of the second and third cuff members is about 30-50 ms. In some embodiments, the delay between pressurization of the first and second cuff members and the delay between pressurization of the second and third cuff members is about 40 ms. The delay between pressurization of the cuff members may be the same or different. In some embodiments, the recovery period 440 that occurs in the staggered depressurization embodiment 400 for the first set of cuffs may be about 20 ms to about 140 ms. In some embodiments, the recovery period 440 is about 80 ms. In some embodiments, the recovery period 455 that occurs in the staggered depressurization embodiment 400 for the second set of cuffs may be about 10 ms to about 70 ms. In some embodiments, the recovery period 455 may be about 40 ms. In some examples, the recovery period 470 that occurs in the staggered depressurization embodiment 400 for the third set of cuffs can be variable—depending on the length of the cycle. In some embodiments, the duration of the recovery period 470 is all of the remaining time available before the cycle end 425. In some examples, the duration of the recovery period 470 can be dependent on the heart rate. For example, in higher heart rates, there is less time available for a patient's vessels to refill. This is another reason for allowing the prior bladders (e.g., the first and second cuff sets) to recover prior to the next compression cycle.

As shown in the external counterpulsation system 400, the staggered pressurization and depressurization of the three compression members or cuff sets can provide a greater amount of recovery time than in concurrent depressurization embodiments. Furthermore, by allowing the reflow of blood to occur more frequently, this can allow more blood to circulate in the next cycle. By staggering the number of pressurization and depressurization of the plurality of compressions members or cuff sets, it provides for the creation of negative pressure that increases the reflow of blood and amount of blood pulled along the circulatory system, reducing the load on the heart to refill the vessels.

In some examples, FIG. 27A depicts another embodiment of the pressurization and refill of a plurality of compression members (e.g., a cuff set comprising a first, second, and third compression member). FIG. 27A illustrates an axis showing the plurality of compression members pressurizing and depressurizing over time. As shown in FIG. 27A, the external counterpulsation system 500 includes a staggered pressurization and depressurization of a plurality of compression members. In some examples, the first cuff set is located distal to the target organ (e.g., behind and above the knee) may first be pressurized. The pressurization time of the first cuff set is represented by bar 515. As shown in FIG. 27A, the pressurization of the first cuff set begins at compression start 505 and ends at compression end 510. In some examples, at the end of the pressurization of the first cuff set at bar 515, the first cuff set is depressurized for a set amount of time. For example, the first cuff set can be depressurized about 50 ms after the second cuff set is inflated. The depressurization of the first cuff set is represented by bar 520. In some examples, the first cuff set is depressurized long enough such that blood is allowed to reflow into previously constricted areas. In some examples, the pressurization and depressurization of the first cuff set cycles as illustrated in bar 525 and bar 530 respectively. In some embodiments, the pressurization time represented by bar 515 and bar 525 and the depressurization time represented by bar 520 and bar 530 can be any of 0 ms, 5 ms, 10 ms, 15 ms, 20 ms, 25 ms, 30 ms, 35 ms, 40 ms, 45 ms, 50 ms, 55 ms, 60 ms, 65 ms, 70 ms, 75 ms, 80 ms, 85 ms, 90 ms, 95 ms, 100 ms, 105 ms, 110 ms, 115 ms, 120 ms, 125 ms, 130 ms, 135 ms, 140 ms, 145 ms, and 150 ms.

In some examples, the second cuff set (e.g., upper thigh groin area) may be pressurized after the first cuff set has been pressurized. As shown in FIG. 27A, in some examples, the pressurization of the second cuff set (e.g., bar 535) can overlap with the pressurization of the first cuff set (e.g., bar 515). In other embodiments, the pressurization of the second cuff set at bar 535 can occur after the end of the pressurization of the first cuff set at bar 515 such that there is no overlap between the pressurization of the first cuff set (e.g., bar 515) and the pressurization of the second cuff set (e.g., bar 535). In some examples, at the end of the pressurization of the second cuff set at bar 535, the second cuff set can be depressurized for a set amount of time. For example, the second cuff set can be depressurized about 50 ms after the third cuff set is inflated. The depressurization of the second cuff set is represented by bar 540. In some examples, the second cuff set is depressurized long enough such that blood is allowed to reflow into previously constricted areas. In some examples, the pressurization and depressurization of the second cuff set cycles, as illustrated in bar 545 and bar 550 respectively. In some embodiments, the pressurization time represented by bar 535 and bar 545 and the depressurization time represented by bar 520 and bar 550 can be any of 0 ms, 5 ms, 10 ms, 15 ms, 20 ms, 25 ms, 30 ms, 35 ms, 40 ms, 45 ms, 50 ms, 55 ms, 60 ms, 65 ms, 70 ms, 75 ms, 80 ms, 85 ms, 90 ms, 95 ms, 100 ms, 105 ms, 110 ms, 115 ms, 120 ms, 125 ms, 130 ms, 135 ms, 140 ms, 145 ms, and 150 ms.

In some examples, the third cuff set (e.g., buttocks) can be pressurized after the first and second cuff set have been pressurized. As shown in FIG. 27A, in some examples, the pressurization of the third cuff set (e.g., bar 555) can overlap with the pressurization of the first cuff set (e.g., bar 515), the second cuff set (e.g., bar 535), or both. In other embodiments, the pressurization of the third cuff set at bar 555 can occur after the end of the pressurization of the second cuff set at bar 535 such that there is no overlap between the pressurization of the second cuff set (e.g., bar 535) and the pressurization of the third cuff set (e.g., bar 555). In other embodiments, the pressurization of the third cuff set at bar 555 can occur after the end of the pressurization of the first cuff set at bar 515 such that there is no overlap between the pressurization of the first cuff set (e.g., bar 515) and the pressurization of the third cuff set (e.g., bar 555). In some examples, at the end of the pressurization of the third cuff set at bar 555, the third cuff set can be depressurized for a set amount of time. For example, the third cuff set can be depressurized about 50 ms before the next r-wave. In some embodiments, the timing of the depressurization of the third cuff set is configured such that the vessels are ready for the blood flow to refill. The depressurization of the third cuff set is represented by bar 560. In some examples, the third cuff set is depressurized long enough such that blood is allowed to reflow into previously constricted areas. In some examples, the pressurization and depressurization of the third cuff set cycles, as illustrated in bar 565 and bar 570 respectively. In some embodiments, the pressurization time represented by bar 555 and bar 565 and the depressurization time represented by bar 560 and bar 570 can be any of 0 ms, 5 ms, 10 ms, 15 ms, 20 ms, 25 ms, 30 ms, 35 ms, 40 ms, 45 ms, 50 ms, 55 ms, 60 ms, 65 ms, 70 ms, 75 ms, 80 ms, 85 ms, 90 ms, 95 ms, 100 ms, 105 ms, 110 ms, 115 ms, 120 ms, 125 ms, 130 ms, 135 ms, 140 ms, 145 ms, and 150 ms.

As discussed above, the external counterpulsation system 500 is configured to provide the staggered cycling of the pressurization and depressurization of a plurality of compression members. As illustrated in FIG. 27A, more than one of the plurality of compression members can be depressurized at the same time. This therefore allows for the reflow of blood in multiple target locations at the same time. As discussed with the other counterpulsation systems above, the staggered pressurization and depressurization of the compression members can provide for the creation of negative pressure that increases the reflow of blood and amount of blood pulled along the circulatory system. In some examples, the recovery period illustrated by bar 520 and bar 530 for the first cuff set can be configured to provide sufficient reflow to allow oxygenated blood into previously constricted areas. This can help to improve tissue oxygenation. As shown in FIG. 27A, in some examples, the recovery period of the first cuff set at bar 520 and bar 530 can overlap with the pressurization or depressurization of the second and third cuff sets. In some examples, the recovery period illustrated by bar 540 and bar 550 for the second cuff set can be configured to provide sufficient reflow to allow oxygenated blood into previously constricted areas. This can help to improve tissue oxygenation. As shown in FIG. 27A, in some examples, the recovery period of the second cuff set at bar 540 and bar 550 can overlap with the pressurization or depressurization of the first and third cuff sets. In some examples, the recovery period illustrated by bar 560 and bar 570 can be configured to provide sufficient reflow to allow oxygenated blood into previously constricted areas. This can help to improve tissue oxygenation. As shown in FIG. 27A, in some examples, the recovery period of the third cuff set at bar 560 and 570 can overlap with the pressurization or depressurization of the first and second cuff sets. In some embodiments, the plurality of compression members (e.g., the first, second, and third cuff sets) can overlap in cycle such that all of the plurality of compression members are pressurized at the same time. In some embodiments, the plurality of compression members (e.g., the first, second, and third cuff sets) can overlap in cycle such that all of the plurality of compression members are depressurized at the same time. While the staggered depressurization embodiment 500 has been shown using three compression members or cuff sets, it will be appreciated that other numbers of compression members (e.g., 1, 2, 4, 5, greater than 5, etc.) are also possible.

In some embodiments, each cuff may be pressurized for a period of about 350-400 ms. In some embodiment, each cuff is pressurized for a period of about 370 ms. In some embodiments, each cuff is pressurized for a same amount of time. In some embodiments, the cuffs are pressurized for different amounts of time. The delay between pressurization of the first and second cuff members and the delay between pressurization of the second and third cuff members may be about 10-70 ms. In some embodiments, the delay between pressurization of the first and second cuff members and the delay between pressurization of the second and third cuff members is about 30-50 ms. In some embodiments, the delay between pressurization of the first and second cuff members and the delay between pressurization of the second and third cuff members is about 40 ms. The delay between pressurization of the cuff members may be the same or different. In some embodiments, the recovery periods 520, 530 that occur in the staggered depressurization embodiment 500 for the first set of cuffs may be about 20 ms to about 140 ms. In some embodiments, the recovery periods 520, 530 is about 80 ms. In some embodiments, the recovery periods 540, 550 that occur in the staggered depressurization embodiment 500 for the second set of cuffs may be about 10 ms to about 70 ms. In some embodiments, the recovery periods 540, 550 may be about 40 ms.

As shown in the external counterpulsation system 500, the staggered pressurization and depressurization of the three compression members or cuff sets can provide a greater amount of recovery time than in concurrent depressurization embodiments. Furthermore, by allowing the reflow of blood occur more frequently, this can allow more blood to circulate in the next cycle. By staggering the number of pressurization and depressurization of the plurality of compressions members or cuff sets, it provides for the creation of negative pressure that increases the reflow of blood and amount of blood pulled along the circulatory system.

In some embodiments, in any of the counterpulsation systems described above, the compression members or cuff sets can be pressurized at approximately 40 ms after the r-wave peak. In some embodiments, the cuffs can be the same size as the calf cuffs. In some examples, the compression members or cuff sets can be pressurized with a value at or below diastolic pressure. The use of below diastolic pressure can enhance the flow and reflow of blood. In some embodiments, any of the above-described counterpulsation systems can be applied to bladder systems include those located in the upper extremities.

FIGS. 27B-27E illustrates example graphs of the compression cycle between heartbeats of ECP systems in patients with target heart rates of 90 bpm and 45 bpm. As an illustration of the benefit of a system with staggered pressurization and depressurization of the plurality of compression members, FIG. 27B illustrates a compression cycle with a target heart rate of 90 bpm without staggering the pressurization and depressurization of the plurality of compression members while FIG. 27C illustrates a compression cycle with a target heart rate of 90 bpm that staggers the pressurization and depressurization of the plurality of compression members. Similarly, FIG. 27D illustrates a compression cycle with a target heart rate of 45 bpm without staggering the pressurization and depressurization of the plurality of compression members while FIG. 27E illustrates a compression cycle with a target heart rate of 45 bpm that staggers the pressurization and depressurization of the plurality of compression members.

Turning first to FIGS. 27B and 27D, the compression member on the lower thigh, upper thigh, and butt are each progressively pressurized until the plurality of compression members at all three locations are pressurized at the same time. FIG. 27B illustrates the compression cycle for a patient with a target heartrate of 90 bpm while FIG. 27D illustrates the compression cycle for a patient with a target heartrate of 45 bpm. As illustrated, the plurality of compression members are thereafter depressurized at the same time. As discussed above, the increased pressurization time of each of the plurality of compression members during each cycle reduces the amount of time for the reflow of blood into previously constricted regions.

In contrast, FIGS. 27C and 27E illustrates the staggered pressurization and depressurization of the plurality of compression members on the lower thigh, upper thigh, and butt. FIG. 27C illustrates the staggered compression cycle for a patient with a target heart rate of 90 bpm and FIG. 27E illustrates the staggered compression cycle for a patient with a target heart rate of 45 bpm. As discussed above, the compression members at each location is pressurized and depressurized after a next set of compression members is pressurized. For example, as illustrated in both FIGS. 27C and 27E, the compression members located on the lower thigh can be pressurized and thereafter depressurized any of 0 ms, 5 ms, 10 ms, 15 ms, 20 ms, 25 ms, 30 ms, 35 ms, 40 ms, 45 ms, 50 ms, 55 ms, 60 ms, 65 ms, 70 ms, 75 ms, 80 ms, 85 ms, 90 ms, 95 ms, 100 ms, 105 ms, 110 ms, 115 ms, 120 ms, 125 ms, 130 ms, 135 ms, 140 ms, 145 ms, and 150 ms after the compression members on the upper thigh are pressurized. In some embodiments, the compression members located on the lower thigh can be depressurized any of between about 0 ms to 50 ms, between about 50 ms to 100 ms, between about 100 ms to 150 ms, between about 0 ms to 5 ms, between about 5 ms to 10 ms, between about 10 ms to 15 ms, between about 15 ms to 20 ms, between about 20 ms to 25 ms, between about 25 ms to 30 ms, between about 30 ms to 35 ms, between about 35 ms to 40 ms, between about 40 ms to 45 ms, between about 45 to 50 ms, between about 50 ms to 55 ms, between about 55 ms to 60 ms, between about 60 ms to 65 ms, between about 65 ms to 70 ms, between about 70 ms to 75 ms, between about 75 ms to 80 ms, between about 80 ms to 85, between about 85 ms to 90 ms, between about 90 ms to 95 ms, between about 95 ms to 100 ms, between about 100 ms to 110 ms, between about 110 ms to 120 ms, between about 120 ms to 130 ms, between about 130 ms to 140 ms, and between about 140 ms to 150 ms after the compression members located on the upper thigh are pressurized.

Similarly, the compression members located on the upper thigh can be pressurized and thereafter depressurized any of 0 ms, 5 ms, 10 ms, 15 ms, 20 ms, 25 ms, 30 ms, 35 ms, 40 ms, 45 ms, 50 ms, 55 ms, 60 ms, 65 ms, 70 ms, 75 ms, 80 ms, 85 ms, 90 ms, 95 ms, 100 ms, 105 ms, 110 ms, 115 ms, 120 ms, 125 ms, 130 ms, 135 ms, 140 ms, 145 ms, and 150 ms after the compression members on the butt is pressurized. In some embodiments, the compression members located on the upper thigh can be depressurized any of between about 0 ms to 50 ms, between about 50 ms to 100 ms, between about 100 ms to 150 ms, between about 0 ms to 5 ms, between about 5 ms to 10 ms, between about 10 ms to 15 ms, between about 15 ms to 20 ms, between about 20 ms to 25 ms, between about 25 ms to 30 ms, between about 30 ms to 35 ms, between about 35 ms to 40 ms, between about 40 ms to 45 ms, between about 45 to 50 ms, between about 50 ms to 55 ms, between about 55 ms to 60 ms, between about 60 ms to 65 ms, between about 65 ms to 70 ms, between about 70 ms to 75 ms, between about 75 ms to 80 ms, between about 80 ms to 85, between about 85 ms to 90 ms, between about 90 ms to 95 ms, between about 95 ms to 100 ms, between about 100 ms to 110 ms, between about 110 ms to 120 ms, between about 120 ms to 130 ms, between about 130 ms to 140 ms, and between about 140 ms to 150 ms after the compression members located on the butt are pressurized.

Lastly, the compression members located on the butt can be pressurized and thereafter depressurized any of 0 ms, 5 ms, 10 ms, 15 ms, 20 ms, 25 ms, 30 ms, 35 ms, 40 ms, 45 ms, 50 ms, 55 ms, 60 ms, 65 ms, 70 ms, 75 ms, 80 ms, 85 ms, 90 ms, 95 ms, 100 ms, 105 ms, 110 ms, 115 ms, 120 ms, 125 ms, 130 ms, 135 ms, 140 ms, 145 ms, and 150 ms before the next r-wave. In some embodiments, the compression members located on the butt can be depressurized any of between about 0 ms to 50 ms, between about 50 ms to 100 ms, between about 100 ms to 150 ms, between about 0 ms to 5 ms, between about 5 ms to 10 ms, between about 10 ms to 15 ms, between about 15 ms to 20 ms, between about 20 ms to 25 ms, between about 25 ms to 30 ms, between about 30 ms to 35 ms, between about 35 ms to 40 ms, between about 40 ms to 45 ms, between about 45 to 50 ms, between about 50 ms to 55 ms, between about 55 ms to 60 ms, between about 60 ms to 65 ms, between about 65 ms to 70 ms, between about 70 ms to 75 ms, between about 75 ms to 80 ms, between about 80 ms to 85, between about 85 ms to 90 ms, between about 90 ms to 95 ms, between about 95 ms to 100 ms, between about 100 ms to 110 ms, between about 110 ms to 120 ms, between about 120 ms to 130 ms, between about 130 ms to 140 ms, and between about 140 ms to 150 ms before the next r-wave.

### Example of an ECP System and Method of Use

In both FIGS. 27C and 27E, reflow occurs upon depressurization of the compression members. As such, reflow is allowed to occur in staggered configuration. In comparing FIGS. 27C and 27E with FIGS. 27B and 27D, significantly more reflow is allowed to occur at each of the target locations that the compression members are located. As discussed previously, by staggering the number of pressurization and depressurizations of the plurality of compression members or cuff sets, it provides for the creation of negative pressure that increases not only the reflow of blood and amount of blood pulled along the circulatory system, but also reduces the load on the heart to refill the vessels. The reduced load also increases patient comfort and can therefore enable the ECP system to be use for a great period of time.

The staggered pressurization and depressurization of the above-described ECP system can be analogized to the milking of a dairy animal by hand. To efficiently milk an animal, a person starts by gently squeezing the teat at a top end with the thumb and index finger. Individual fingers are then added one finger at a time in a downward direction until all fingers are on the teat. This effectively forces milk into the pail. As pressure on the teat is done in a staggered configuration, negative pressure is created which allows milk to reflow into the teat. In contrast to simply pulling on the teat with the entire hand, the staggered pressure provides for the increased flow of milk into the teat such that the maximum amount of milk can be expelled with each squeeze of the hand.

As discussed previously, ECP therapy is a non-invasive, non-surgical method to increase coronary blood flow. The ECP device comprises three basic components: a set of cuffs, an air compressor/pump, and a computer system. Three set of cuffs are wrapped around the buttocks, lower thighs, upper thighs, and are then attached to the air compressor by hoses, which allows the cuffs to be cyclically inflated and deflated in synchrony with the patient's cardiac cycle. In early diastole, pressure (i.e., 100-300 mmHg) is sequentially applied in a distal to caudal fashion, which produces retrograde aortic flow that increases coronary artery peak diastolic pressure by >90%. The cuffs are subsequently deflated just before systole with an electrocardiogram (ECG) guide. A typical course of ECP includes 35 one-two hour sessions over 7 weeks.

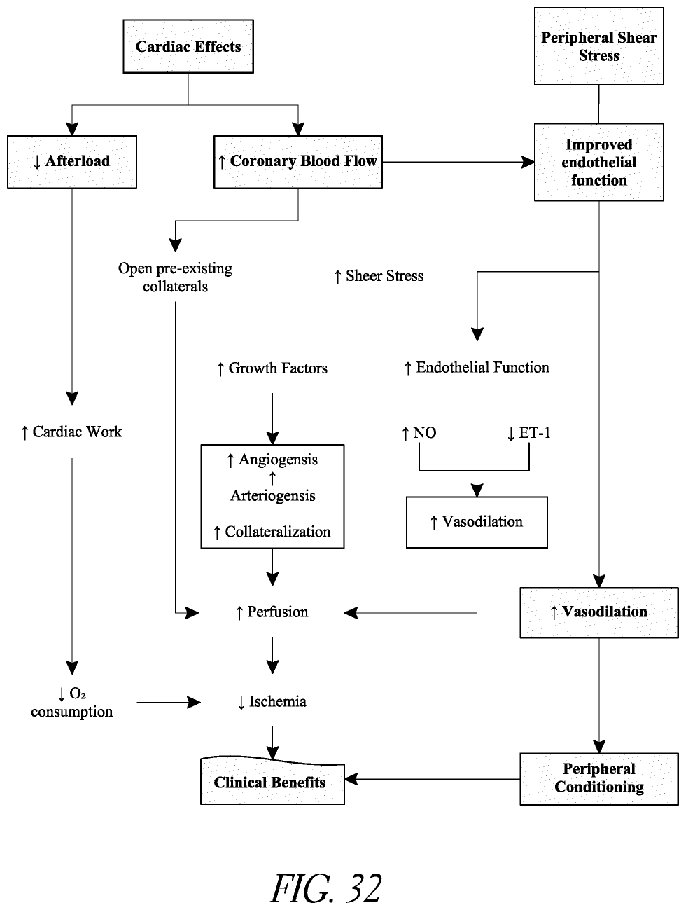

As illustrated in FIG. 32, ECP has multiple hemodynamic and peripheral effects. As confirmed by angiography, intracoronary Doppler and echocardiography, ECP can lead to increased coronary blood flow velocity and pressure, improved diastolic filling, decreased left ventricular (LV) end-diastolic pressure, improved LV time to peak filling rate, and increased LV end-diastolic volume. ECP can also improve peripheral endothelial function, likely through shear-stress induced increases in nitric oxide and decreased bradykinin levels.

### Overview

The disclosed ECP system is designed to solve the barriers in treatment from both the clinical perspective (e.g., size, operational complexity, and cost) and patient (e.g., accessibility, pain, and discomfort) perspectives.

To accomplish the aforementioned goals, in some embodiments, the disclosed ECP system can include design characteristics that provide for a substantially smaller and portable technology. The below discussed changes can substantially reduce electrical energy requirements and noise and heat generation. This can permit the design of a smaller, portable device without compromising performance. In some embodiments, the reduction in size without a reduction of performance can allow the creation of a unit that is small and portable enough to treat in a home environment. This can reduce the cost of care to treat a patient with, for example, angina.

Lower Heart Rate—In some embodiments, the ECP system is designed for use on patients with a heart rate less than 90 bpm. This can help to eliminate the use of pharmaceutical and their inherent risk. Alternatively, in some embodiments, the ECP system can be designed to modify treatment in patient with a heart rate over 90 bpm. For example, the ECP can reduce the frequency of pressurization to once every other heartbeat in patients with heart rates over 90 bpm. This keeps the system requirements low while also minimizing risk on higher risk patients.

Targeted Placement of Bladders—In some examples, the placement of the cuffs (and attached bladders) are optimized. For example, the bladders are placed at blood pressure pulse points where blood is closer to the body surface. This can include, for example, the groin area, and behind and just above the knee joint. These targeted areas are regions where the blood vessels are closest to the body surface. Less pressure is therefore necessary to generate retrograde flow. This therefore reduces patient discomfort as “brute force” of retrograde flow is no longer necessary.

Reduced Pressure—The disclosed ECP system is further able to deliver the same standard of care at significantly lower diastolic pressure (i.e. <240 mmHg) compared to current ECP technologies. The resulting device can therefore be smaller, more portable, and more gentle on the patient than existing ECP technologies while still providing the same standard of care. In some embodiments, treatment pressure is reduced, thereby allowing the ECP system to downsize to a single pump. In some examples, the reservoir can be smaller and used as an accumulator for maintaining both pressure and an adequate air reserve to smooth the inflation pressure pulse. In some embodiments, the treatment pressure is less than 240 mmHg, less than 230 mmHg, less than 220 mmHg, less than 210 mmHg, less than 200 mmHg, between 0 mmHg-240 mmHg, between 0 mm Hg-220 mmHg, between 0 mmHg-200 mmHg, between 200 mmHg-240 mmHg, and between 100 mmHg-200 mmHg.

The disclosed system can be smaller and more portable than existing ECP systems currently on the market. Existing ECP systems frequently weigh more than 200-250 lbs. In some embodiments, the ECP system can be less than 100 lbs., less than 95 lbs., less than 90 lbs., less than 85 lbs., less than 80 lbs., less than 75 lbs., less than 70 lbs., less than 65 lbs., less than 60 lbs., less than 55 lbs., less than 50 lbs., between 50 and 100 lbs., between 50 and 60 lbs., between 60 and 70 lbs., between 70 and 80 lbs., between 80 and 90 lbs., and between 90 and 100 lbs. As a result of the smaller size and reduced weight, the ECP system can be easily portable and therefore used in a variety of settings. The ECP system is also designed for easy set-up that ensures that portability of the system. In some embodiments, the bladders, cuffs and hoses used with the ECP systems are smaller and easier to connect. In some examples, the cuffs and bladders can be disposable. Furthermore, the ECP system can be configured to use less electricity as a by-product of the size of the ECP system. For example, the ECP system can be configured to be used with the 10 Amp outlets common to residential homes. This can allow the disclosed ECP system to provide home-care treatment.

General User Comfort—A goal of the disclosed ECP system is to improve user comfort so as to increase the likelihood of patient compliance for the entirety of the duration of treatment. This is particularly important as patients who undergo ECP treatment tend to be generally fragile, frail, and somewhat ambulatory. As a result, an ECP system that causes pain or discomfort decreases the likelihood of the patient completing the full course of treatments. This is a reoccurring problem with existing systems on the market. Patients stop treatment mid-session as the existing products on the market cause discomfort. As discussed in detail above, the disclosed ECP system uses preloaded bladders and staggered pressurization to provide gradual pressurization that is less jarring and painful to the patient.

For example, in using the ECP system, the patient relaxes on a comfortable padded surface while the operator wraps the muscular areas of the patient's thighs and buttocks with the cuffs and bladders. Each of the cuffs and bladders can be similar to blood pressure cuffs which are familiar to the patient. In some examples, hoses are used to connect each of the cuffs and bladders to an air pressure source. In some embodiments, a plurality of ECG electrodes are placed on the patient's chest so the computer can monitor heart rate. In some examples, three ECG electrodes are used. An additional sensor can be placed on the patient's finger or ear to detect each pulse wave. The patient should be comfortable and not experience pain during the aforementioned procedure. Should the patient experience pain, such as pinching, the patient can ask the operator to adjust the cuffs. During the procedure, the patient should experience the sensation of a “hug” moving from the lower extremities to the buttocks. The procedure can be relaxing and allow the patient to watch TV, a video, listen to music, or to even take a nap. The system can be automated such that the operator can start the procedure and the system is configured to automatically stop when the treatment timer stops. In some examples, the ECP procedure does not produce any adverse effects that are associated with invasive procedures.

Patient Customization—In some embodiments, the ECP system can adjust the treatment protocol by automatically detecting delays. In some embodiments, the settings of the ECP system are established by calculations based on the patient's heart rate and QRS peak. However, as the heart rate slows during treatment, the amount of delay can change. For example, the amount of delay can be adjusted to permit a longer refill time for blood to refill the previously compressed area. As discussed above, the delay is based on a percentage of time between two QRS peaks (e.g., heart beats). However, as a patient's heart rate decreases, the amount delay will decrease. The decrease in a patient's heart rate—and accordingly the amount of delay—can occur when a patient is more comfortable or less nervous. This can frequently occur during treatment or over subsequent treatment sessions as a patient acclimates to the ECP treatment. The increase in delay time can allow for more blood to be pushed during the next compression cycle as an increased delay time allows more refill time and more blood to be pushed through the system. This can thereby improve treatment and augmentation.

### System Overview

The ECP system can include a console, at least one ECG lead and/or patch, a pod, and a cuff set. In some examples, the ECP system can include a console. The console can be configured to provide air to each of the at least one bladder on each of the cuffs on the cuff set. In some examples, the console of the ECP system is configured to control the treatment provided by the ECP system. The ECP system can include at least one lead and patch. In some embodiments, each of the at least one lead and patch can be used to connect the patient to the system. In some examples, the ECP system can include a pod. The pod can contain a plurality of valves and hose connections to inflate each of the at least one bladders on the cuffs of the cuff set. The ECP system can include a cuff set including a plurality of cuffs. In some embodiments, the cuff set can include two lower thigh cuffs, two upper thigh cuffs, and one buttock cuff. In some examples, each of the cuffs of the cuff set is used for locating and attaching bladders.

The ECP system can include a front panel that allows a user to engage with the ECP system and receive information regarding the operation of the ECP system. In some embodiments, the front panel of the ECP system can include a power switch, a timer, a button to start/stop treatment, and a display. In some examples, the power switch of the ECP system can be used by the operator to turn the system on or off. In some embodiments, the power switch can be used to stop the ECP system in an emergency. In some embodiments, the ECP system can include a timer. In some examples, the timer can be used to set treatment duration up to 2 hours. The ECP system can also include a button to start and/or stop treatment. In some embodiments, the button to start and/or stop treatment can be used to start, pause, and/or stop treatment. In some examples, stopping or pausing treatment does not affect and/or reset the timer of the ECP system. In some embodiments, the ECP system includes a display. The display can be configured to show an ECG wave form. In some embodiments, the display can illustrate the heart rate in beats per minute.

The ECP system can include a rear panel that is configured to engage with a plurality of externalities. In some embodiments, the rear panel of the ECP system can include a rear circuit breaker, a plurality of ECG leads, a power cord, a cable connection to valves, a handle, an air hose connection, and a plurality of hoses. In some examples, the rear circuit breaker of the ECP system is configured to serve as a safety feature. For example, the rear circuit breaker is configured to turn off the ECP system when the ECP system receives excessive power. In some embodiments, the ECG leads of the ECP system is configured to conduct ECG from the patient to the device of the ECP system. In some examples, the power cord of the ECP system is a hospital-grade power cord that can be used to connect the ECP system to an electrical power outlet. In some embodiments, the ECP system can include at least one cable connection to a plurality of valves. The cable connection can be used to connect the cables from the Pod to the ECP system. In some embodiments, the cable connection can serve as a conduit for activation signals to the valves which provide air to each of the bladders of the cuffs of the cuff set. In some examples, the cable connection is configured to provide low voltage power to each of the plurality of valves. The ECP system can include a handle. The handle may be configured to aid in moving the ECP system. In some embodiments, the handle can be retractable and/or pivotable to allow for easy storage. In some examples, the air hose connection of the ECP system is used to connect an air source to each of the plurality of valves. The hoses of the ECP system can be used to carry air from the console to each of the bladders on the cuff.

The ECP system can engage with a number of accessories. In some embodiments, at least one ECG electrode(s) and/or patch(es) can be configured to be used with the ECP system. In some examples, the ECP system can engage with an ECG cable. The ECG cable can be used to connect the ECG electrode wires from the patient to the R-wave detector. In some embodiments, the ECP system can be configured to receive ECG information from an external device. For example, the ECP system can receive ECG data via Bluetooth, wifi, or other remote communication technologies.

As mentioned above, in some embodiments, the ECP system can be used with a plurality of cuffs. The cuffs can receive at least one bladder. In some examples, a plurality of tights can be used with the ECP system. The tights can be configured to help keep the bladders from scraping or pinching the skin of the patient. In some embodiments, the ECP system can be used with a pulse oximeter and/or a plethysmograph. In some examples, the pulse oximeter and/or the plethysmograph can be used to determine diastolic and systolic pressure waveforms.

### Technical Specifications

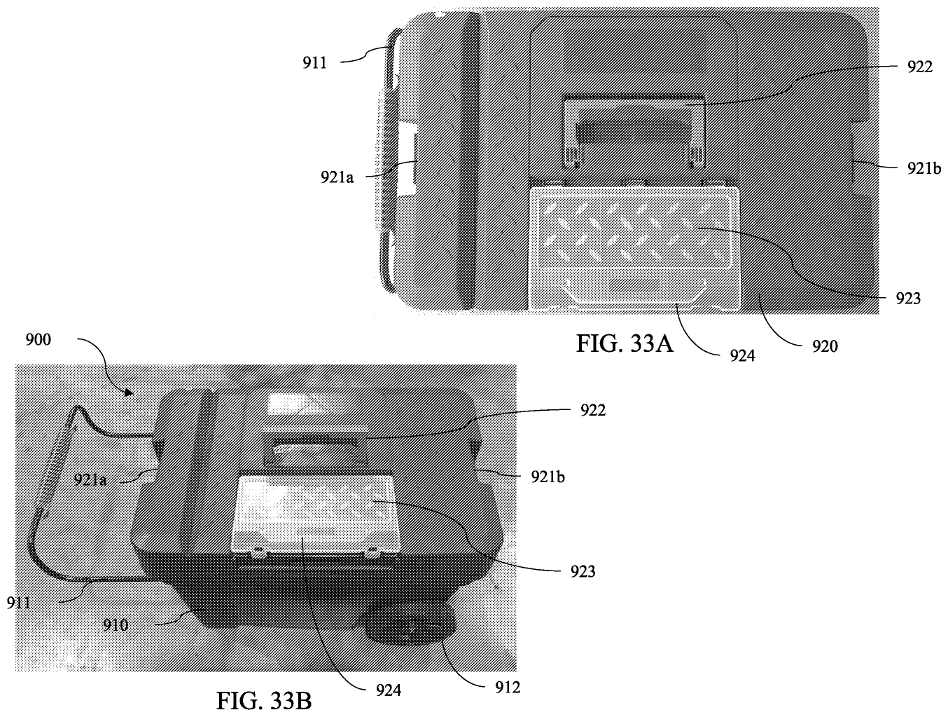

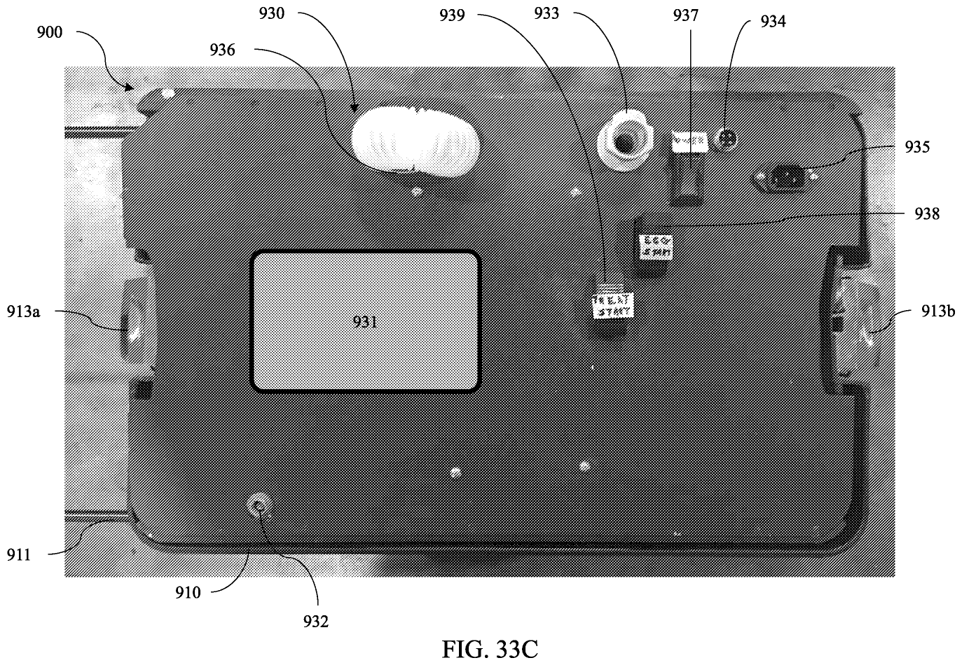

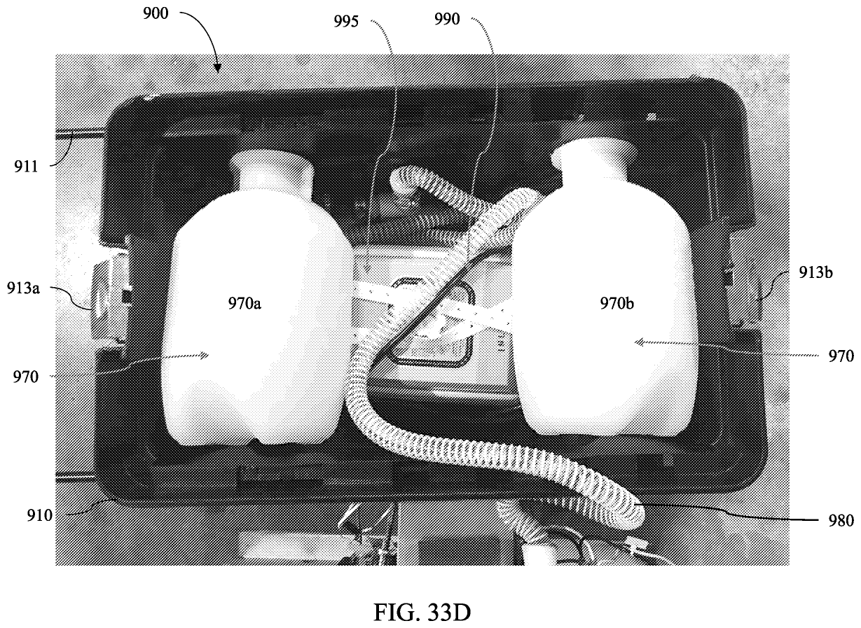

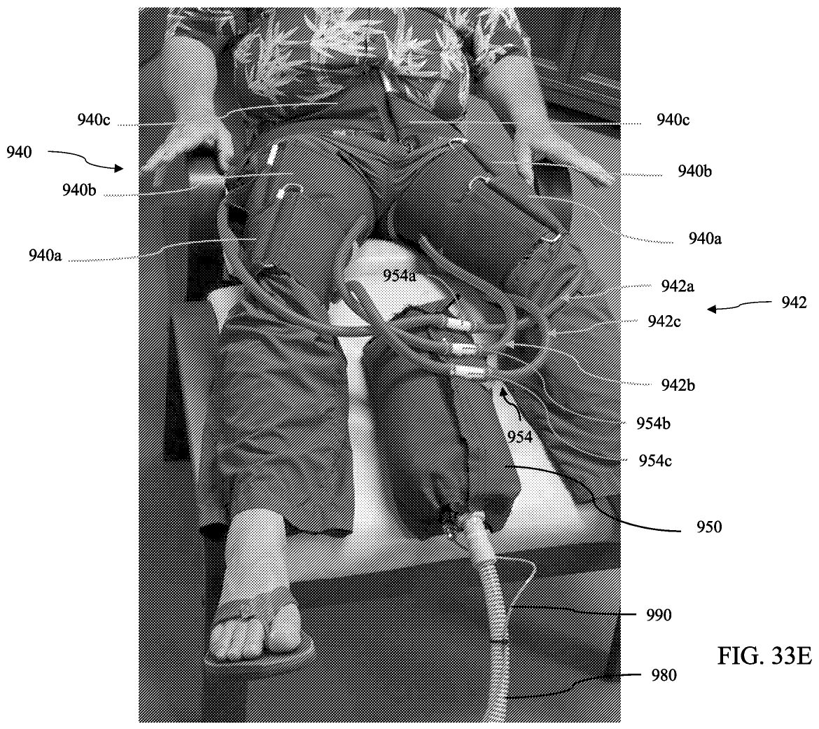

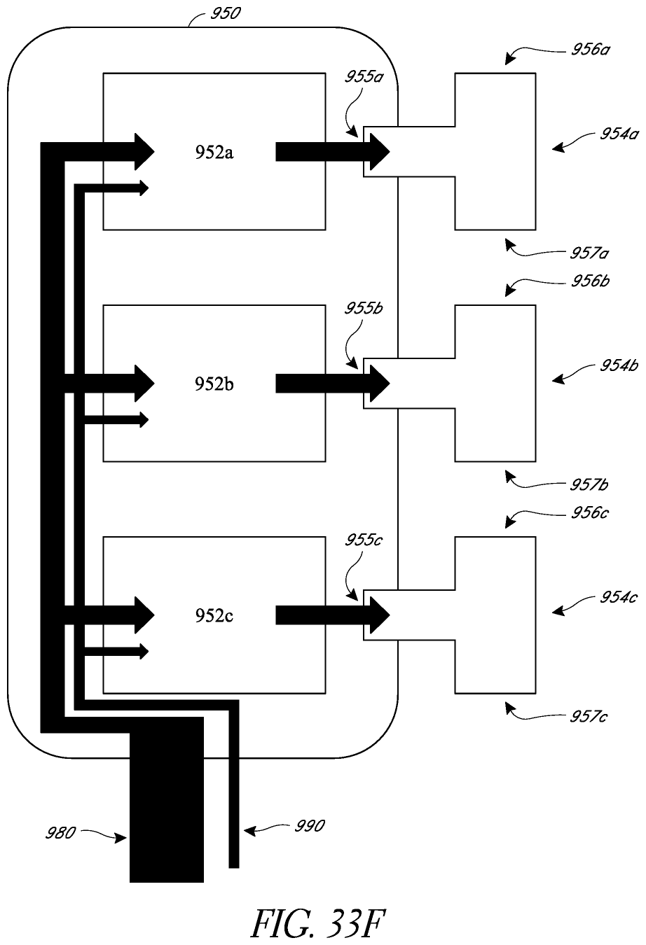

FIGS. 33A-33E illustrate an embodiment of the portable ECP system. FIGS. 33A-33B illustrate the ECP system with a lid and the lid removed respectively. FIG. 33C illustrates the control panel of the ECP system. FIG. 33D illustrates the ECP system with the control panel removed. FIG. 33E illustrate an embodiment of the cuffs of the portable ECP system attached to a patient. FIG. 33F illustrates a schematic of an embodiment of the pod of the ECP system.

FIGS. 33A-33B illustrates an embodiment of the ECP system 900. The ECP system 900 can include a body 910 and a lid 920. In some embodiments, the body 910 is configured to house the components of the ECP system 900. As the ECP system 900 is configured to be portable, the ECP system 900 can weigh less than 100 lbs., less than 90 lbs., less than 80 lbs., less than 70 lbs., between 90 lbs.-100 lbs., between 80 lbs.-90 lbs., between 70 lbs.-80 lbs., between 60-70 lbs. In some examples, to allow the ECP system 900 to be easily transported, the ECP system 900 can include a handle 911 and at least one wheel 912 to allow a user to easily move the ECP system 900 from one location to another. In some embodiments, the handle 911 is retractable to allow the handle 911 to be stored within the body 910 to reduce the profile of the ECP system 900.

FIG. 33C illustrates the body 910 of the ECP system 900 with the lid 920 removed. To allow a user to easily remove and secure the lid 920 to the body 910, in some embodiments, the body 910 can include a latch 913a and a latch 913b. In some embodiments, the latch 913a and the latch 913b are configured to engage with a shelf 921a and a shelf 921b located on either side of the lid 920. The lid 920 can include a carrying handle 922 to allow the lid 920 to be easily removed from the ECP system 900. In some embodiments, the lid 920 can include a compartment 923 to stores components of the system. As illustrated in FIG. 33B, the compartment 923 can include a compartment lid 924 to protect the contents of the compartment 923. In some examples, the compartment 923 can be sized to secure and hold the electrodes and/or patches of the ECP system 900.

In some examples, the ECP system 900 can include a control panel 930. As illustrated in FIG. 33C, once the lid 920 of the ECP system 900 is removed, the user can easily access the components of the ECP system 900. In some embodiments, the control panel 930 can include a plurality of connectors. For examples, the control panel 930 can include a cable connector 932, an air hose connection 933, a valve cable connection 934, a power input 935, and an air inlet 936. In some embodiments, the cable connector 932 can receive an ECG cable (not illustrated). The ECG cable can be connected to a plurality of electrodes attached to the patient. In some embodiments, the cable connector 932 can receive ECG signals from the patient. In some examples, the air hose connection 933 receives a main airline 980 (discussed in more detail below). The air hose connection 933 can be configured to provide air to the at least one bladder of the ECP system 900. In some embodiments, the valve cable connection 934 is configured to receive the valve controller wires from the pod 950. As will be discussed in more detail below, the pod 950 can house the valves for filling and exhausting each of the plurality of bladders. In some examples, the power input 935 can receive a power cable to power the ECP system 900. As discussed above, the ECP system 900 can operate on a lower power requirement. This can allow the ECP system 900 to provide home-care treatment as the power requirements of the ECP system 900 are consistent with the 10 Amp outlets common to residential homes. In some embodiments, the air inlet 936 of the control panel 930 provides an air inlet to the lower area of the body 910 of the ECP system 900.

The control panel 930 can include a display 931. In some embodiments, the display 931 can provide user information (e.g., information from the ECG attached to the patient, patient heart rate information, etc.). In some examples, the display 931 can provide treatment information (e.g., information regarding the fill rate of the bladder, the exhaust rate of the bladder, which of the bladders is being pressurized, the pressure exerted by each of the bladders). In some embodiments, the display 931 can provide the user with the capability to control the ECP system and the treatment applied to the patient (e.g., starting the ECG, starting treatment, etc.).

In some embodiments, the control panel 930 can include a plurality of controls to allow the user to operate the ECP system 900. In some examples, the control panel 930 can include a power switch 937 that can power on and power off the ECP system 900. In some embodiments, the control panel 930 can include an ECG switch 938 that can power on and power off the ECG system attached to the patient. In some examples, the control panel 930 can include a treatment switch 939 that can power on and power off the ECP treatment once the cuffs are properly placed and secured to the patient.

FIG. 33D illustrates an embodiment of the interior of the body 910 of the ECP system 900. In some examples, the body 910 of the ECP system 900 can house at least one reservoir 970, a compressor 995, and a programmable logic controller (PLC) (not pictured). In some embodiments, depending on the size of the reservoir 970, the ECP system 900 can include a plurality of reservoirs 970. For example, as illustrated in FIG. 33D, the ECP system 900 can include a first reservoir 970a and a second reservoir 970b. As discussed in more detail below, because of the reduced power and air requirements of the ECP system 900, the at least one reservoir 970 can be smaller in size. In some embodiments, the reservoir 970 can be 2.0 gallons, 2.1 gallons, 2.2 gallons, 2.3 gallons, 2.4 gallons, 2.5 gallons, 2.6 gallons, 2.7 gallons, 2.8 gallons, 2.9 gallons, 3.0 gallons, and between 2.0 gallons-3.0 gallons.

In some embodiments, the body 910 can house the compressor 995 which is fluidly attached to the at least one reservoir 970 (e.g., the first reservoir 970a and the second reservoir 970b). The compressor 995 can be fluidly connected to the pod 950 by the airline 980 to supply air to each of the plurality of cuffs 940.

In some examples, the body 910 can house the PLC (not illustrated). As discussed above, the PLC can be configured to receive ECG information and to output control signals to a plurality of valves 952 that are located in the pod 950. In some embodiments, a valve controller wire 990 is attached to the PLC and, as will be discussed below, is connected to the pod 950. The PLC can control the opening and closing of the plurality of valves 952 through the valve controller wire 990. This can therefore control the pressurization of each of the bladders on the plurality of cuffs 940.

FIG. 33E illustrates an embodiment of the plurality of cuffs 940 of the ECP system 900 that are attached to the patient during treatment. Because of the portability of the ECP system 900, a specialized treatment table is no longer necessary for performing ECP treatment. As is shown in FIG. 33E, the patient can undergo treatment while sitting and/or reclining on any surface (e.g., a chair or a bed). In some examples, instead of a specialized treatment bed that includes built in valves, the ECP system 900 includes the pod 950 that houses the plurality of valves 952 that are configured to pressurize each of the bladders on the plurality of cuffs 940.

In some embodiments, the ECP system 900 includes a plurality of cuffs 940. In some embodiments, the plurality of cuffs 940 can include at least one cuff 940a, at least one cuff 940b, and a third cuff 940c. In some examples, the at least one cuff 940a is located on the lower thigh (i.e., just above and behind the knee). In some embodiments, the at least one cuff 940b is located on the upper thigh (i.e., adjacent to the groin area). In some examples, the cuff 940c is located on the buttocks. Each of the plurality of cuffs 940 can include at least one bladder. In some embodiments, each of the bladders on the plurality of cuffs 940 can be pressurized by receiving air through the plurality of pairs of hoses 942. As illustrated in FIG. 33E, the pair of hoses 942a are configured to inflate the bladders located on the pair of cuff 940a, wherein one cuff 940a is positioned on the left and right lower thigh of the patient. As shown, the pair of hoses 942b can be positioned to inflate the bladders located on the pair of cuff 940b, wherein one cuff 940b is positioned on the left and right upper thigh of the patient. The pair of hoses 942c can be configured to pressurize the cuff 940c positioned on the buttocks of the patients. As illustrated in FIG. 33E, one of each of the pair of hoses 942c is located on either side of the cuff 940c.

FIG. 33E illustrates an embodiment of the pod 950 that includes a plurality of connectors 954 that can provide a fluid connection to each of the plurality of pairs of hoses 942 from the compressor 995. In some examples, the pod 950 is a portable, positional holder of the plurality of valves and hose connections. In some embodiments, the portability of the pod 950 can allow the pod 950 to be positioned in various locations to increase the comfort of the patient being treated. As well, the positional flexibility of the pod 950 can also increase the treatment location flexibility of the pod 950.

FIG. 33F illustrates a schematic of the pod 950. In some embodiments, the pod 950 includes a plurality of valves 952. In some examples, the plurality of valves 952 can include a valve 952a, a valve 952b, and a valve 952c. As illustrated in FIG. 33F, each of the plurality of valves 952 can be fluidly connected to one of the plurality of connectors 954 to provide airflow to the attached bladders. In some examples, each of the plurality of valves 952 can be fluidly connected to the airline 980 to provide airflow from the compressor 995. In some embodiments, each of the plurality of valves 952 can be connected to the valve controller wire 990 to receive signals from the PLC. In some examples, the PLC can control when each of the plurality of valves 952 opens and closes to allow airflow into and out of the fluidly connected bladders. In some embodiments, when each of the plurality of valves 952 are closed, each of the plurality of valves 952 can be configured to vent to the atmosphere.

For example, the valve 952a can receive airflow from the airline 980 and a control signal from the PLC through the valve controller wire 990. The valve 952a can be fluidly connected to the connector 954a. The connector 954a can include an inlet 955a, a first outlet 956a, and a second outlet 957a. The inlet 955a of the connector 954a can be fluidly connected to the valve 952a to receive airflow. Each of the first outlet 956a and second outlet 957a can each be fluidly attached to one of the pair of hoses 942a. As illustrated in FIG. 33E, the pair of hoses 942a are configured to inflate the bladders located on the cuffs 940a positioned on the left and right lower thigh of the patient.

In some embodiments, the valve 952b can receive airflow from the airline 980 and a control signal from the PLC through the valve controller wire 990. The valve 952b can be fluidly connected to the connector 954b. The connector 954b can include an inlet 955b, a first outlet 956b, and a second outlet 957b. The inlet 955b of the connector 954b can be fluidly connected to the valve 952b to receive airflow. Each of the first outlet 956b and second outlet 957b can each be fluidly attached to one of the pair of hoses 942b. As illustrated in FIG. 33E, the pair of hoses 942b are configured to inflate the bladders located on the cuff 940b positioned on the left and right upper thigh of the patient.

In some examples, the valve 952c can receive airflow from the airline 980 and a control signal from the PLC through the valve controller wire 990. The valve 952c can be fluidly connected to the connector 954c. The connector 954c can include an inlet 955c, a first outlet 956c, and a second outlet 957c. The inlet 955c of the connector 954c can be fluidly connected to the valve 952c to receive airflow. Each of the first outlet 956c and second outlet 957c can each be fluidly attached to one of the pair of hoses 942c. As illustrated in FIG. 33E, the pair of hoses 942c are configured to inflate the bladders located on the cuff 940c positioned on the buttocks of the patient.

The disclosed ECP system can be portable such that no treatment surface is required. In some embodiments, the ECP system can be used to treat patients in an office, a clinic, a mobile clinic, at home, etc. In some examples, the ECP system can be operated for approximately 1 hour, 1.1 hours, 1.2 hours, 1.3 hours, 1.4 hours, 1.5 hours, 1.6 hours, 1.7 hours, 1.8 hours, 1.9 hours, 2 hours, or between 1-2 hours. In some embodiments, the ECP system is configured to operate on a patient with a maximum of 90 bpm.

Alternatively, in some embodiments, the ECP system can be configured to operate on a patient with a preset maximum heart rate. In some embodiments, the preset maximum heart rate can be between 85 bpm-90 bpm, 85 bpm, 86 bpm, 87 bpm, 88 bpm, 89 bpm, and 90 bpm. If the ECP system detects that the patient has a heart rate that exceeds the preset maximum heart rate, the ECP system can be programmed to cycle every other QRS complex (e.g., every other heartbeat). In some examples, this would allow the disclosed ECP system to treat patients with a heart rate as high as 160 bpm.

In some examples, the ECP system has a width of approximately 24 inches, a depth of approximately 24 inches, and a height of approximately 36 inches. In some embodiments, the ECP system can include a handle for easy transportation. In some examples, the entirety of the ECP system weighs less than 100 lbs., less than 90 lbs., less than 80 lbs., less than 70 lbs., between 90 lbs.-100 lbs., between 80 lbs.-90 lbs., between 70 lbs.-80 lbs., between 60-70 lbs. In some embodiments, the ECP system can include a reservoir (e.g., an air tank, an air storage container) of between 1-2 gallons, 2 gallons, 1.9 gallons, 1.8 gallons, 1.7 gallons, 1.6 gallons, 1.5 gallons, 1.4 gallons, 1.3 gallons, 1.2 gallons, 1.1 gallons, and 1 gallon.

In some embodiments, the operating environment of the ECP system is approximately 70° F. (22° C.). This temperature allows the patient and operator to be comfortable. In some examples, the heart rate of the patient should be approximately between 40 beats per minute and 90 beats per minute. In some embodiments, the pressure range of the ECP system during operation should be less than 240 mmHg, less than 230 mmHg, less than 220 mmHg, less than 210 mmHg, less than 200 mmHg, between 0 mmHg-240 mmHg, between 0 mm Hg-220 mmHg, between 0 mmHg-200 mmHg, between 200 mmHg-240 mmHg, and between 100 mmHg-200 mmHg.

In some embodiments, the ECP system can have a supply voltage of between 100-120 VAC at 60 Hz. In some embodiments, the supply voltage can be 120 VAC, 115 VAC, 110 VAC, 105 VAC, 100 VAC, less than 120 VAC, less than 115 VAC, less than 110 VAC, less than 105 VAC, and less than 100 VAC. In some examples, the current rating of the ECP system can have a maximum of 15 A. In some embodiments, the Fuse rating of the ECP system can be T3.0 A/250 V (100-120 VAC). In some embodiments, the ECP system can include an input option comprising a ECG 4 pin circular socket. In some embodiments, the ECP system should be placed and used in a cool dry place. In some examples, the ECP system can be stored in a temperature ranging between 20° C. to 55° C. In some embodiments, the relative humidity for operating the ECP system can be between 10% to 90% such that it is non-condensing.

### Benefits of Technical Specifications

Treatable Heart Rate (BPM)—As discussed above, in some embodiments, the ECP system can be configured to treat a patient with a maximum heart rate of 90 bpm. This is in contrast to existing ECP systems that are directed to patients with much higher heart rates such as 120 bpm. An ECP system designed to treat a patient with a heart rate of 120 bpm takes 33% more air volume than a patient with a heart rate of 90 bpm. This can eliminate the risk of patient pharmaceutical use prior to treatment. As well, by tailoring the disclosed ECP system to a lower heart rate, the size and number of pumps in the ECP system can be reduced. The reduced size and/or number of pumps also reduces the power requirements of the ECP system. As well, in some embodiments, this reduces the size of the ECP system and allows it to be portable.

Alternatively, as discussed above, in some embodiments, the ECP system can be configured to operate on a patient with a preset maximum heart rate. In some embodiments, the preset maximum heart rate can be between 85 bpm-90 bpm, 85 bpm, 86 bpm, 87 bpm, 88 bpm, 89 bpm, and 90 bpm. If the ECP system detects that the patient has a heart rate that exceeds the preset maximum heart rate, the ECP system can be programmed to cycle every other QRS complex (e.g., every other heartbeat). By cycling every other QRS complex, again, the power requirements of the ECP system is decreased.

Treatment Pressure—In some embodiments, the pumps of the disclosed ECP system operate at a lower pressure. Operating the ECP system at a higher pressures (i.e., 375 mmHg) requires pumps that are capable of creating higher pressures. Higher pressures increase the patient risk as the retrograde pressure (e.g., the pressure generated from counterpulsation and/or retrograde flow) can potentially increase diastolic pressure above systolic pressure. As well, use of higher pressures in ECP systems requires a larger storage tank to modulate the pressure such that there are no pressure surges felt by the patient during treatment.

As discussed above, the pressure provided by the pumps can be less than 240 mmHg, less than 230 mmHg, less than 220 mmHg, less than 210 mmHg, less than 200 mmHg, between 0 mmHg-240 mmHg, between 0 mm Hg-220 mmHg, between 0 mmHg-200 mmHg, between 200 mmHg-240 mmHg, and between 100 mmHg-200 mmHg By reducing the pump pressure, the pump size of the ECP system can be reduced. In some embodiments, this means that the diaphragm pump can be smaller, quieter, and lighter when compared to other pumping technologies. In some examples, the storage tank size of the ECP system can also be reduced. In some embodiments, by reducing the pressure requirement by almost 50% can reduce patient risk during compression by reducing the likelihood of causing an aneurism or vessel damage due to the high pressure.

Preloaded Bladders—In some embodiments, the bladders of the disclosed ECP system can be preloaded with a predetermined pressure. By pressurizing the bladder from a predetermined pressure and exhausting the bladder down to a predetermined pressure, the present ECP system can be configured to perform the ECP therapy at less pressure for a longer duration. Not only is this more comfortable for the patient, but can also allow for a reduced usage of air. Instead of exhausting all of the air out of the bladders during each cycle, the ECP system retains and reuses a portion of the air in the bladder. In some examples, the preloaded bladder can increase the volume of blood retained below the bladder before each cycle. This can allow a greater volume of blood to be circulated with each cycle of the ECP system, thereby allowing a reduction of pressure of the ECP methodology to have the patient receive the same benefits from treatment.

Cuff & Bladder Placement—In some examples, the ECP system comprises a plurality of cuffs that can be positioned on the upper thigh, the lower thigh, and the buttocks. This differs from existing technologies wherein the cuffs are placed on the calf, the lower thigh, and the buttocks. In some embodiments, by moving the cuffs positioned on the calf to just above the knee joint (instead of the calf muscle), the ECP system can create equivalent increased retrograde diastolic pressure by using lower system pressures within the bladders. This allows for smaller pumps, reservoirs/air tanks, and bladder sizes. In some embodiments, the changed positions of the cuffs supports the reduction to a single pump. In some examples, this reduces the patient risk to higher treatment pressures. In some embodiments, the use of smaller and fewer pumps require less power to operate. This can support a smaller portable system that increases the number of places that a patient can receive treatment.

Reduction in Pumps—In existing ECP systems, high treatment pressure in conjunction with the treatment of persons with a 130 bpm heart rate required the use of multiple pumps (or fewer, but larger pumps). In contrast, the disclosed ECP system can have a reduced number of pumps required. In some examples, the pumps in the disclosed ECP system can be smaller than existing ECP systems. As discussed above, the disclosed ECP system operates at a lower pressure and treats patients with a lower heart rate. Furthermore, the strategic placement of the bladders on the patient's body allow the disclosed ECP system to provide the required treatment using fewer and smaller pumps. For example, instead of the three of more pumps required in existing ECP systems, the disclosed ECP system can have less than three pumps, 2 pumps, or 1 pump. Furthermore, the bladders attached to the cuffs in the ECP system can be smaller. This can improve the portability of the ECP system and, as mentioned above, increase the number of places that a patient can receive treatment. In some embodiments, the pump can have a capacity of any of between 4-6 cubic feet per minute (cfm), between 4-5 cfm, between 5-6 cfm, less than 6 cfm, 4 cfm, 5 cfm, 6 cfm, 4.1 cfm, 4.2 cfm, 4.3 cfm, 4.4 cfm, 4.5 cfm, 4.6 cfm, 4.7 cfm, 4.8 cfm, 4.9 cfm, 5.0 cfm, 5.1 cfm, 5.2 cfm, 5.3 cfm, 5.4 cfm, 5.5 cfm, 5.6 cfm, 5.7 cfm, 5.8 cfm, 5.9 cfm, and 6.0 cfm.

Elimination of Treatment Surface—In existing ECP systems, the patient is provided with a treatment bed to lie on during treatment. In some embodiments, the treatment bed can include valves that provide treatment. In contrast, the disclosed ECP system does not require a specialized treatment bed as the ECP treatment can be provided anywhere. For example, the patient can receive treatment on a table or any recliner chair. As well, the valves to the ECP system are located in the ECP system (e.g., the pod of the ECP system). A treatment bed is not required in the disclosed ECP system as a result of the substantially smaller valve CV (flow coefficient). As discussed above, the disclosed ECP system has lower pressure requirements and therefore smaller bladders can be used. As a result, less air can be required to fill the smaller and fewer bladders. In some embodiments, the valves of the disclosed ECP system can be contained in a pod adjacent to or between the patient's legs. As the disclosed ECP system does not require a treatment bed, this also allows for the disclosed ECP system to be portable.

Reduced Amperage and/or Voltage Requirements—In some embodiments, the ECP system has lower voltage and amperage requirement. For example, in some embodiments, the ECP system requires AC 120V single phase and/or 10 AMP 60 Hz. The higher amperage and higher voltage circuits required in existing ECP systems restricts where the ECP system can be used. To use many of the ECP systems, an electrician may be needed to install new circuits. As a result, ECP treatment is limited to commercial and medical settings that have the power supply capable of powering the ECP system. In contrast, the reduced power requirements of the disclosed ECP system supports smaller and more portable systems. This can increase the locations where treatment is an option. Furthermore, in some embodiments, the reduced power requirements can reduce risks and costs associated with higher voltage/amperage circuits.

Miscellaneous—In some embodiments, the disclosed ECP system does not require an integrated S_{P}O₂ sensor. In existing ECP systems, the S_{P}O₂ sensor provides the operator with blood pressure wave forms. As the disclosed ECP system operates at lower pressures on patients with lower heart rates, less monitoring is necessary to ensure the safety of the patient. In some embodiments, this can significantly reduce the system cost and software validation requirements. In some embodiments, the disclosed ECP system can be configured to be used with a S_{P}O₂ sensor.

### System Setup and ECP Treatment Overview

In some embodiments, the ECP system can be set up as described below. In some examples, prior to setting up the ECP system, the patient is asked to empty his or her (urinary) bladder before treatment. This can avoid disrupting the ECP treatment as patients frequently need to urinate during treatment. In some embodiments, before the ECP system is attached to the patient, the patient is asked to put on tights. As discussed above, the tights can help to prevent the bladders on the cuffs from scraping or pinching the patient's skin. In some examples, the operator of the ECP system should ensure that the tights fit well and that there are no creases on the tights when the patient is wearing the tights as creases can be places for potential irritation and pinching.

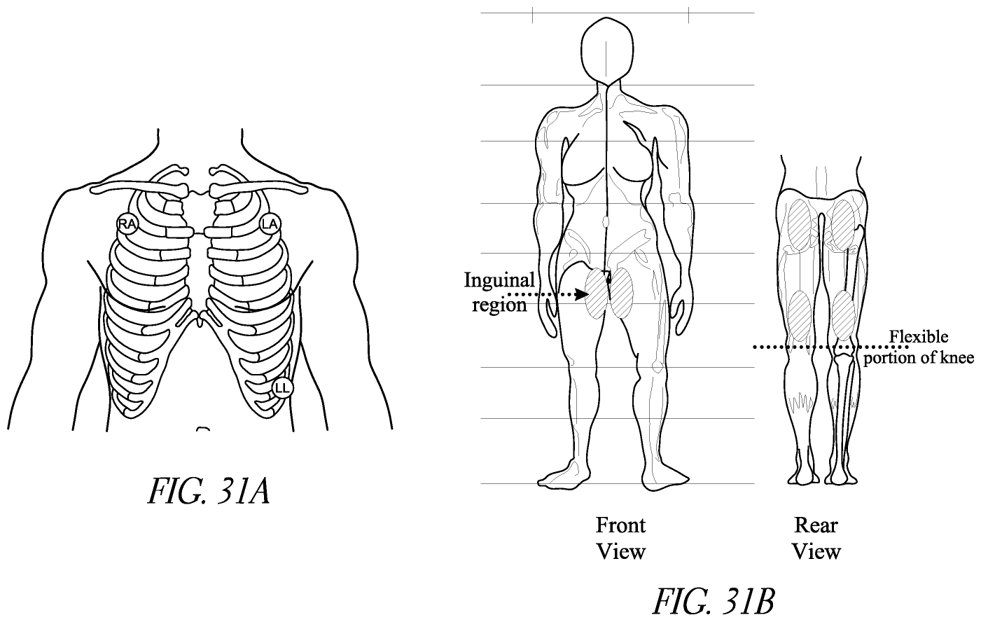

In some examples, the operator can position the ECG patches on the patient. FIG. 31A illustrates an example of the placement of the ECG patches. In some embodiments, “RA” indicates that the ECG patch can be placed on the right arm or right below the right clavicle. In some examples, “LA” indicates that the ECG patch can be placed on the left leg or upper left quadrant. In some embodiments, “LL” indicates that the ECG patch can be placed on the left leg or upper left quadrant. Once the ECG patches are positioned on the patient, ECG leads can be used to connect the electrodes on the ECG patches to the cable on the console of the ECG system. In some examples, a lead can be attached to the ECG electrode before placement on the patient. In some embodiments, the operator can ensure that there is proper electrode placement by confirming that there is an ECG signal.

In some embodiments, the operator can position a lower cuff set behind and just above the knee joint. This can be done, for example, by feeling for a pulse on the leg to ensure that the bladder is positioned above and centered on the pulse point. The cuffs of the lower cuff set can then be tightened to secure the cuff set to the leg of the patient. In some embodiments, the operator can position a cuff on the upper thigh. The upper thigh cuffs can be positioned as close and as high into the groin as possible. The cuffs of the upper thigh cuff set can then be tightened to secure the cuff set to the thigh of the patient. In some embodiments, the operator can position a cuff on the buttocks of the patient. In the buttocks cuff, the bladders are located within the buttock notch as much as possible. The cuffs on the buttocks can then be tightened to secure the cuffs.

In some examples, a pulse oximeter can be attached to the patient. In some embodiments, the operator can also attach a CPAP device to the patient. The CPAP device can ensure that a patient's oxygen levels do not decrease during treatment.

In some embodiments, the operator can position the plurality of bladders on the patient. FIG. 31B illustrates an embodiment for the placement of the cuffs. In some embodiments, the outside of the cuff includes an indicator to mark the proper bladder location and ensure proper bladder placement. In some examples, the operator places the bladders at the lower extremity first and finishes with placement of the bladders on the buttocks. As illustrated in FIG. 31B, in some embodiments, bladders can be placed in the inguinal region, above the flexible portion of the knee on the back of the thigh, and also on the buttocks. In order to secure the bladders to the patient, the operator can pull the tightening strap through the roller clamp. To confirm that the bladder is properly secured, the operator should be able to fit 1-2 fingers under the cuffs. The operator can then secure the strap with the Velcro fastener.

In some embodiments, color coded hoses can be connected to the applicable bladders. In some examples, the hoses are color coded in order to ensure that the bladders are properly attached to the ECP system. The operator can optionally connect the patient to a plethysmograph. Once attached, the operator can turn on the main power on the rear panel by pressing the power switch. The operator can then set the timer to the treatment duration. In some embodiments, the treatment duration is 60 minutes. Once the cuffs, bladders, and ECG electrodes are properly placed and the timer for treatment duration has been placed, the operator can press the start switch to begin treatment. In some embodiments, the treatment duration can be between 60 minutes and 120 minutes, 60 minutes-70 minutes, 70 minutes-80 minutes, 80 minutes-90 minutes, 90 minutes-100 minutes, 100 minutes-110 minutes, 110 minutes-120 minutes, 60 minutes, 65 minutes, 70 minutes, 75 minutes, 80 minutes, 85 minutes, 90 minutes, 95 minutes, 100 minutes, 105 minutes, 110 minutes, 115 minutes, and 120 minutes,

In some examples, to end treatment, the power switch can be turned off. The patient can then be disconnected from the equipment and the electrodes can be discarded.

### Safety Features of ECP System

In some embodiments, the disclosed ECP system include built in safety shut-offs that can be automatic, semiautomatic and/or manual. For example, in some embodiments, the ECP system can include pressure release valves that ensure that the patient will not be subjected to excessive cuff pressures over 240 mmHg. In some embodiments, the ECP system can ensure that the patient is subjected to cuff pressures that are less than or equal to 240 mm Hg.

In some embodiments, if the patient's heart rate is less than 40 or greater than 90 beats per minute (bpm), the ECP system will stop treatment. In some examples, the treatment timer does not stop during either high or low heart rate events. This can occur, for example, with isolated extra systoles or during a premature ventricular contraction (PVCs), which follow early after a normally occurring R-wave for as long as they persist.

### Alternative ECP Methods for Medical Treatments

There is evidence that blood pressure can change during ECP treatment. For example, a patient's blood pressure can drop as treatment progresses as the patient is lulled into a non-anxious state. In other examples, patients can have conditions such as CHF that require their blood pressure to be closely monitored to prevent the ECP system to cause the patient's blood pressure from going too high. To address this concern, in some embodiments, any of the above disclosed ECP system can be configured to monitor blood pressure.

As will be described in more detail below, the blood pressure monitoring can be integrated into the ECP system and can be either continuous or periodic. The purpose of the integrated continuous or periodic blood pressure monitoring can be to limit the maximum treatment pressure to some definable limit above or below systolic pressure. In some examples, the ECP system can be provided with a fixed or variable diastolic/systolic ratio to implement a treatment safety feature. In some embodiments, the ECP system is provided with a feature that permits the patient to acclimate to treatment conditions. For example, this pressure limit can be adjustable by the user or completely bypassed by the user. The user can be the healthcare provide, operator of the ECP system, or the patient himself. As will be described in more detail below, the ECP system can be hooked up to a noninvasive blood pressure monitoring system that is configured to receive information from the user. In some embodiments, the ECP system is configured to periodically monitor the blood pressure during treatment and to reintegrate this information into the treatment plan. In some examples, the described feedback loop can provide a tailored treatment plan for the patient. For example, the patient, based on his or her health condition, may require an increased or lowered pressure be used.

In some examples, the ECP system can be configured to automatically record the user's systolic and/or diastolic pressures using an integrated or external blood pressure monitor. In some embodiments, as will be discussed in more detail below, the blood pressure can be automatically measured by a blood pressure monitor incorporated into an additional bladder. In some examples, a blood pressure monitor can be incorporated into one or more of the existing bladders in the system. In some embodiments, the ECP system can allow a user to manually enter his or her systolic and/or diastolic pressures.

ECP system Comprising an Integrated Blood Pressure Monitor

In some embodiments, the ECP system comprises an integrated blood pressure monitor. In some examples, the ECP system includes at least one air source (e.g., one bladder) that has an integrated pressure transducer. This air source can be a bladder that is used specifically to monitor blood pressure, or it can be one of the bladders that is being used for treatment. In some embodiments, prior to treatment, the bladder for monitoring blood pressure can be inflated to occlude the target area. This is similar to what is commonly used in blood pressure measurement equipment. Once the blood pressure monitoring bladder is inflated, both systolic and diastolic pressures can be collected and stored. In some embodiments, only systolic pressure can be used. This systolic value can be used as a treatment pressure upper limitation. In some embodiments, the systolic value can be adjusted by the operator to be upward, downward, or by-passed completely. In some examples, once the blood pressure limitation is determined, treatment can begin and continues until either the treatment is complete or is interrupted. In some embodiments, if the treatment is interrupted, the user may or may not be able to reestablish the limitation. In some embodiments, if the treatment is interrupted, the ECP system, as part of resuming treatment, may acquire or require the establishment of a pressure limitation.

ECP system Comprising an External Blood Pressure Monitor

In some examples, the ECP system can include an external blood pressure monitor. The external blood pressure monitor can be, for example, located on a portion of the body of the patient that is not being treated. In some embodiments, the external blood pressure monitor can be used to measure one or both of systolic and diastolic pressure. In some examples, prior to treatment, the patient's systolic and diastolic pressures are stored. In some embodiments, the patient's systolic and diastolic pressures are entered into the ECP treatment software by the user. In some embodiments, the patient's systolic and diastolic pressures are automatically entered into the treatment software. This systolic value can be used as a treatment pressure upper limitation. In some examples, the stored systolic pressure can be adjusted either upward or downward before or during treatment. In some embodiments, the stored systolic pressure can be bypassed completely before or during treatment. In some examples, the blood pressure (e.g., systolic and/or diastolic pressure) can be periodically measured during the treatment at the untreated extremity. In some examples, the stored systolic value can be used to periodically adjust the treatment pressure upper limit. In some embodiments, if the treatment is interrupted, the treatment may be resumed. In some embodiments, the user may or may not reestablish the limitation to resume treatment. In some embodiments, the system requires the establishment of the pressure limitation in order to resume treatment.

### ECP System Configured to Cycle Arterial and Venous Blood

In some examples, the ECP system can be configured to cycle both arterial and venous blood. This can be used, for example, to augment heart function, or to reduce heart work load. During cardiopulmonary resuscitation or other conditions where blood flow from the heart is compromised, the disclosed method of the ECP system is configured to aid arterial and venous blood flow in the expected direction of blood flow.

Existing systems for ECP generally only address the venous side of the cardiovascular system in the treatment of cardiovascular disease. For example, existing ECP systems are configured to compress the lower limbs sequentially starting distally. This compression occurs for a period of time, and the compression is then released either sequentially or all at once. As noted above, this method is configured to work well for the venous side of the cardiovascular system, but is not configured to address the arterial side.

In treating conditions where the blood flow from the heart is compromised, the ECP system can be configured to connect with an ECG signal. Although not required, the ECP system can be configured such that when the ECG signal is detected, compression can be stopped and/or pressures reduced upon detection. In other embodiments, the ECP system is configured such that a user or operator can disable treatment as needed.

The arterial vascular system is generally located deep within the body. The arterial vascular system only nears the surface of the body at locations where a pulse can be felt. In order to treat the arterial side of the cardiovascular system, ECP bladders of the disclosed ECP system can be configured to be located at these “pulse points” such that the treatment using the ECP system can impact arterial flow. In some embodiments, the ECP bladders on the cuffs are initially inflated. In some examples, as the bladders on these cuffs are located at “pulse points,” the inflated bladders are configured to impact the venous flow at the pulse points. In some embodiments, in order to impact the venous flow at the pulse points, each of the bladders of the ECP system at the pulse points remain inflated for a preset amount of time. In some examples, each of the bladders are then deflated in a proximal direction. This can create a negative pressure at the pulse point so as to assist in pulling blood to the pulse point from the arterial side of the heart. In some embodiments, an inflated cuff is positioned at the pulse points in the groin and/or behind the knee. These locations can help to reduce the heart's effort to pump blood

In some examples, as will be discussed below, the method for impacting the arterial vascular system can first include strategically placing a plurality of ECP bladders. In some embodiments, each of the plurality of ECP bladders are placed at pulse points. In some examples, each of the plurality of ECP bladders are inflated in a proximal to distal direction to impact venous flow. In some embodiments, each of the plurality of ECP bladders are deflated in a distal to proximal direction. Alternatively, in some examples, each of the plurality of ECP bladders are deflated in a proximal to distal direction. In some examples the aforementioned method is configured to create negative pressure at the pulse point which assist in pulling blood to the pulse point from the arterial side of the heart.

In some embodiments, in order to aid in arterial and venous blood flow, the ECP system can apply a treatment that includes cycling pressure and/or cuff compression. In some embodiments, the ECP system can be used during the arterial flow cycle to enhance and/or mimic blood flow away from the heart and to the rest of the body. During the arterial flow cycle, the heart compression period frequently coincides with the QRS period. During the QRS period, blood flows from the heart in a proximal to distal direction; from the proximal-most portion of the body to the distal extremities. To mimic arterial blood flow, the bladders can be inflated sequentially from the proximal-most bladder to the distal-most bladder. For example, bladders can be placed on an upper thigh, lower thigh, and calf. In some examples, the bladders are initially deflated before being inflated in a proximal to distal order. In the aforementioned example, the upper thigh bladder is first inflated, followed by the lower thigh bladder, and followed finally by the calf bladder. Alternatively, in some embodiments, the calf bladder can be first inflated, followed by the lower thigh bladder, and followed by the upper thigh bladder. The aforementioned example is not intended to be limiting and additional or fewer bladders can be used in various locations where the bladders are inflated from the proximal-most bladder to the distal-most bladder.

In other examples, bladders can be placed on the buttocks, upper thigh, and lower thigh. In some examples, the bladders are initially deflated before being inflated in a proximal to distal order. In the aforementioned example, the bladder located on the buttocks is first inflated, followed by the upper thigh bladder, and followed finally by the lower thigh bladder. Alternatively, in some embodiments, the lower thigh bladder can be first inflated, followed by the upper thigh bladder, and followed finally by the bladder on the buttocks. The aforementioned example is not intended to be limiting and additional or fewer bladders can be used in various locations where the bladders are inflated from the distal-most bladder to the proximal-most bladder or from the proximal-most bladder to the distal-most bladder.

In some embodiments, the ECP system can be used during the venous flow cycle to enhance and/or mimic blood flow from the body back to the heart. During the venous flow cycle, heart relaxation or repolarization frequently occurs between the QRS periods. During the periods between the QRS periods, blood flows in a distal to proximal direction, with vessels returning blood back to the heart. To mimic venous blood flow, the bladders can be inflated sequentially from the distal-most bladder to the proximal-most bladder. For example, bladders can be placed on the calf (or calves), lower thigh(s), upper thigh(s), and buttocks. In some examples, the bladders are initially partially inflated. In some embodiments, the pressure can be just below diastolic so as to permit blood reflow back into the venous vessels. In some examples, the calf bladder(s) are first inflated, followed by the lower thigh bladder(s), followed by the upper thigh bladder(s), and followed finally by the buttock bladder(s). In some examples, the lower thigh bladder(s) are first inflated, followed by the upper thigh bladder(s), and followed finally by the buttock bladder(s). The aforementioned example is not intended to be limiting and additional or fewer bladders can be used in various locations where the bladders are inflated from the distal-most bladder to the proximal-most bladder.

In some examples, in the methods described above, the pressures used by the ECP system during the arterial cycle can be higher when compared to the pressures used by the ECP system during the venous vessels to reach the arterial vessels. In some examples, the above-described methods can be conducted, such that compression of blood in the arterial direction precedes compression of blood in the venous direction. In some embodiments, cuffs and bladders can be placed on other extremities such as the arms. In some examples, the majority of the cuffs and bladders are placed in the lower extremities. In some embodiments, any of the individual cuffs or bladders in the ECP system can be disabled as needed to optimize treatment or blood movement.

In some embodiments, the ECP system can be configured to integrate with a CPAP device or O₂ device during treatment. In some examples, by providing additional O₂ to the patient using a CPAP device, a patient's heart rate can be lowered. In some examples, a CPAP device can be used on all patients and not just on patients who are O₂ compromised. In some embodiments, the increased oxygen can help to reduce a patient's heart rate and thereby decrease the pressures used by the ECP system. By decreasing the pressures used, discomfort caused by the treatment using the ECP system can be decreased and the time a patient can be treated can be increased. In some embodiments, improved comfort can facilitate treating the patient for extended periods of time (e.g., at night). In some examples, the decreased pressure can facilitate the removal of post-op anesthesia so as to reduce recovery time.

In some examples, the ECP system can be configured to treat patients with kidney disorders. In patients with functioning kidneys, an indication of whether the ECP system is working is whether a patient needs to void their bladders after treatment. If a patient does not empty their urinary bladder (void) before treatment, it is not uncommon for the treatment to be paused to allow the person to empty their bladder, followed by completing the treatment.

### Alternative ECP Systems for Medical Use

In some embodiments, the ECP systems disclosed above can be configured to enhance the perfusion of drugs to various organs in the body. This can allow certain treatments to use lower dosages of drugs to achieve higher effectiveness.

### Alternative ECP Methods for Therapeutic Use

In some examples, the ECP system can be configured for therapeutic uses. For example, the ECP system can be used to improve well-being, provide improvement in vasodilation, increase oxygen consumption (VO₂), and increase blood flow. In some examples, the disclosed ECP system can be configured for massage and relaxation technology.

Therapeutic treatments with the ECP system can be done with or without synchronization with the heart. In some embodiments, the ECP system can synchronize with the heart such that it can adjust to the user's heart rate during treatment with the ECP system. In some embodiments, the ECP system is configured to have the capability to set heart rate limits for safety purposes. In some embodiments, the ECP system can synchronize with the heart so as to improve lulling or enhance the feeling of relaxation.

In some embodiments, the ECP system can include or be integrated with a blood pressure monitor. In some examples, the cuff pressure may be adjusted so as not to exceed a specified value. In some embodiments, the specified value is related to the user's systolic pressure before treatment.

In some examples, the ECP system can be used in healthy patients for non-medical and/or relaxation purposes. For example, in some embodiments, treatment with the ECP system can be configured to permit a user to achieve an orgasm or more erect penis by improving blood flow to penile tissues. In other examples, the cuffs can be applied to different parts of the body to provide additional wellness treatments. For example, the ECP system can be configured to provide or enhance facials, upper body massage. In some embodiments, the above-described wellness treatments (e.g., facials, massages) can be applied in conjunction with any of the above-described treatments.

In some embodiments, the therapeutic treatments described above can include using full-sized cuffs, half-sized bladders, or lower pressure in order to provide greater relaxation for the patient. In some examples, there are no restrictions on the location where the bladder can be placed. In some embodiments, the pressurization of any of the cuffs can start at the QRS peak for a duration of ±40 ms. In some embodiments, any of the therapeutic treatments added above can include arm cuffs. In some examples, any of the cuffs in the therapeutic treatments described above can include cuffs that are the same size as the arm cuffs.

### Method of Preloading Bladders or Disabling Bladders

In some examples, the bladders of any of the ECP systems described above can be preloaded. In some embodiments, by preloading the bladders, the total inflation time and bladder inflation experience to the user can be reduced. In particular, preloading the bladder can reduce the discomfort experienced by the user as the transition between “deflation” and “inflation” will be from diastolic to treatment pressure instead of from a deflated bladder (e.g., approximately 0 mmHg) to the treatment pressure. Using a preloaded bladder can give the patient the sensation of a softer start as well as less jolting during inflation. The more comfortable treatment can increase patient compliance of the prescribed treatment. In some embodiments, the treatment can be as many as 35 hours.

In some embodiments, a preloaded bladder can also result in less air consumption as part of the air requirement remains in the bladder. The reduced air consumption can allow the production of a smaller, portable, more readily available product to treat various diseases and medical conditions. The change in pressure (Δp) of the bladder (i.e., maximum pressure-preloaded pressure) can be the basis for estimating air consumption. The Δp of the bladder is expected to make treatment more comfortable as the patient will not experience the jolt common to each ECP pressure pulsation during an inflation and deflation cycle.

In some examples, the cuff and bladder design permits the placing of the bladder in a position wherein the pressure is concentrated and produces a more effective retrograde or anterograde flow using less energy.

In some embodiments, in treatments involving an ECP system having preloaded bladders, the ECP system can be configured to detect or determine the patient's diastolic pressure. In some examples, the ECP system can then set the preload bladder inflation pressure to a value about 0 mmHg and less than the patient's recorded diastolic pressure. In some examples, if the ECP system is incorporated with real-time blood pressure monitoring, the preloaded pressure could be adjusted as diastolic pressure changes. This can provide for further optimizing treatment conditions which would enhance the patient's treatment experience. In some examples, the initial bladder pressure is set below the patient's measured diastolic pressure. In some embodiments, this preloaded pressure is maintained during the entirety of the treatment session.

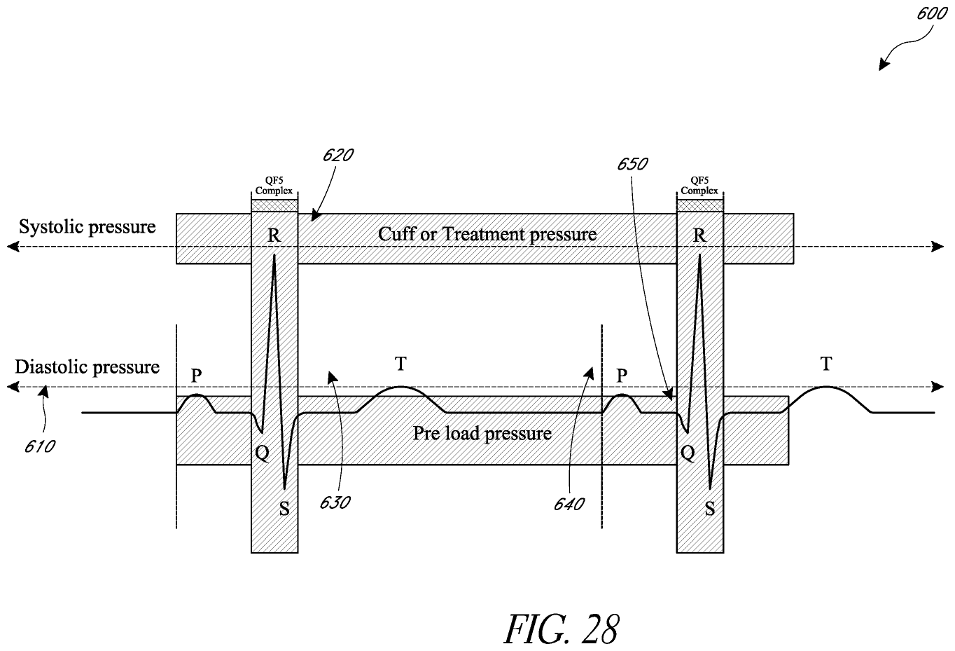

FIG. 28 illustrates a graphical illustration 600 of a comparison of the treatment pressure with the bladder preloaded pressure across the duration of a plurality of QRS waves. As shown in FIG. 28, the preloaded pressure of the bladder can be less than the cuff or treatment pressure. For example, in some embodiments, as illustrated at point 610, the bladder preload pressure can be less than or equal to the user's diastolic pressure. In some examples, the bladder preload pressure is less than the user's diastolic pressure permitting (1) less perceived bladder pushing during inflation and (2) blood flow exists into the previously compressed area even while preloaded. In some examples, as illustrated at point 610, the treatment pressure is approximately the user's systolic pressure. In some embodiments, at point 630 the preload of the bladder is maintained. In some embodiments, at point 640, the bladder can be completely exhausted. In some examples, at point 650 exhaustion of the bladders can occur.

As discussed above, in some examples, by providing a preloaded bladder, the user can experience greater comfort during treatment using the ECP system. For example, the patient can experience a gentler pulsing experience thereby providing improved comfort during treatment. In some examples, the increased comfort of treatment using the preloaded bladder can also result in increased treatment compliance as patients are more likely to complete treatment and/or return for treatment in the future. As well, the use of the preloaded bladder can also provide for less air consumption during treatment. This can provide for a lower environmental impact, less electricity usage, and reduced waste of air.

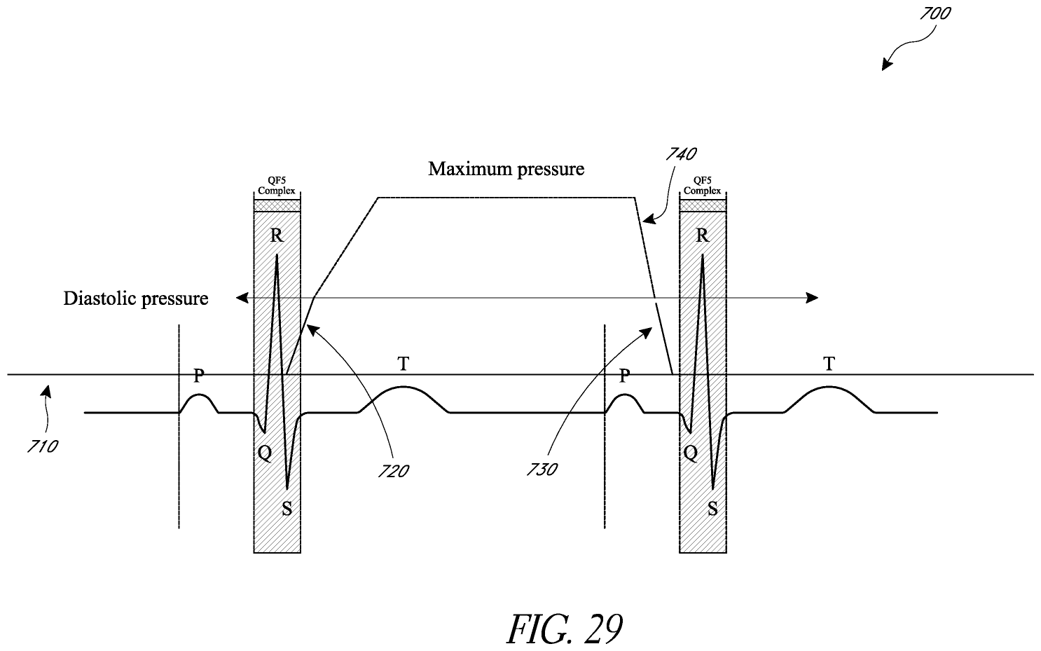

FIG. 29 illustrates a graphical illustration 700 of the bladder preload pressure across the duration of a plurality of QRS waves. As shown in FIG. 29, the preloaded pressure of the bladder can be below the diastolic pressure of the user. In some embodiments, as illustrated at point 710, the bladder pressure can start at 0 mm Hg or below diastolic pressure. In some examples, at point 720, the cuff pressure is set or pre-loaded at about diastolic pressure. In some examples, at point 730, the cuff pressure would be maintained at diastolic pressure.

In some examples, a preloaded cuff can provide a user with increased comfort during treatment using the ECP system. As with the preloaded bladder, the patient can experience a gentler pulsing experience, thereby providing improved comfort during treatment. In some examples, the increased comfort of treatment using the preloaded cuff can also result in increased treatment compliance as patients are more likely to complete treatment and/or return for treatment in the future. In some embodiments, the use of the preloaded cuff can provide for less air consumption during treatment. This can provide for a lower environmental impact, less electricity usage, and reduced waste of air.

In some embodiments, the ECP system (e.g., any of the above described counterpulsation systems) can be configured to allow individual bladders to be disabled. This can permit usage of the ECP system on patients where an extremity is missing in-whole or in-part. Patients can include, for example, veterans, diabetics, cancer patients, and others where an extremity is not present. This permits the specific tailoring of the treatment on patients where the use of certain bladders is not beneficial to the patient of his or her wellbeing.

### Method and System of Controlled Deflation of Bladders

In some embodiments, the bladders of any of the above described ECP systems can be configured such that each of the bladders can be deflated in a controlled manner. In some examples, each of the bladders is configured to include an exhaust hose with an adjustable restriction. In some embodiments, the adjustable restriction can be a valve that is configured to regulate the rate that air can flow out of the bladder. In some examples, the valve can be adjusted to increase or decrease the rate of airflow out of the bladder

In some embodiments, the valve can be configured to provide a fixed rate of air leaving the bladder. In some examples, the valve can be configured to provide a fixed rate of deflation of the bladder.

In some examples, by providing each of the plurality of bladders of the ECP system with an adjustable restriction to control the rate of deflation of the bladder, this can allow for increased patient comfort. In particular, a controlled deflation of the bladder would allow for each of the bladders to be adjusted to a customizable pressure that is comfortable for each individual patient.

Use of Plethysmograph Detection with ECP System

In some embodiments, the ECP system (e.g., any of the above described counterpulsation systems) can be configured to be used with a plethysmograph. A plethysmograph is an instrument that can be configured to measure changes in volume within an organ or within the body. This is done by measuring the fluctuations in the volume of blood or air within the body and/or organ. In some embodiments, a pulse oximeter or other device that can display or output a pulse waveform may be used in lieu of a plethysmograph. As discussed above, a pulse oximeter can be used with the ECP system (e.g., any of the above described counterpulsation systems) to noninvasively measure a patient's oxygen saturation. Any of the below described ECP systems can be used with a pulse oximeter.

Plethysmography can be used in a variety of contexts. In some embodiments, the ECP system can be configured to be used with air cuff plethysmography. Air cuff plethysmography is a technique for measuring changes in the circumference of a limb by recording the changes in pressure in an air-filled cuff surrounding the limb. In other embodiments, the ECP system can be configured to be used with infra-red plethysmograph. An infra-red plethysmograph is an infrared photoelectric sensor that can be used to record changes in pulsatile blood flow from a finger, ear, or toe. In some embodiments, the infra-red plethysmograph is attached to the temple or forehead of the patient to detect cranial flow. In other embodiments, the infra-red plethysmograph can be attached to other locations on the head/facial cranial area which can include, for example, the left side of the head, the right side of the head, both sides of the head, the center of the head, and/or the temple.

There exist many benefits for using a plethysmograph with treatment using the above-described ECP system. For example, use of the plethysmograph can, by monitoring the volume of blood or air within the patient help to increase treatment comfort and to tailor treatments to each individual patient. In some embodiments, use of the plethysmograph can help to increase patient compliance to complete the full treatment and prophylactic usage. This in turn can help to lower healthcare costs, lower equipment costs, and can be used to ensure that blood is flowing to the brain or head region.

In some embodiments, the method of performing treatment with the ECP system with the plethysmograph can include starting the cycle but not applying pressure to the bladders. In some embodiments, the patient's heart rate is initially measured and the systolic and diastolic peaks are identified with the plethysmograph. In some embodiments, a timer is set and pressure is applied to the bladders to create a pre-defined rate of pressure increase. In some embodiments, the pressure to the bladders can be increased until the diastolic peak is met by any of the following user selectable criteria: wherein a user selectable preselected percentage of the maximum diastolic peak is (1)<100% diastolic is less than systolic, (2) 100% diastolic=systolic, (3)>100% diastolic is greater than systolic. In some embodiments, the equipment is thereafter disconnected at the end of the treatment.

### Split Roller Buckle

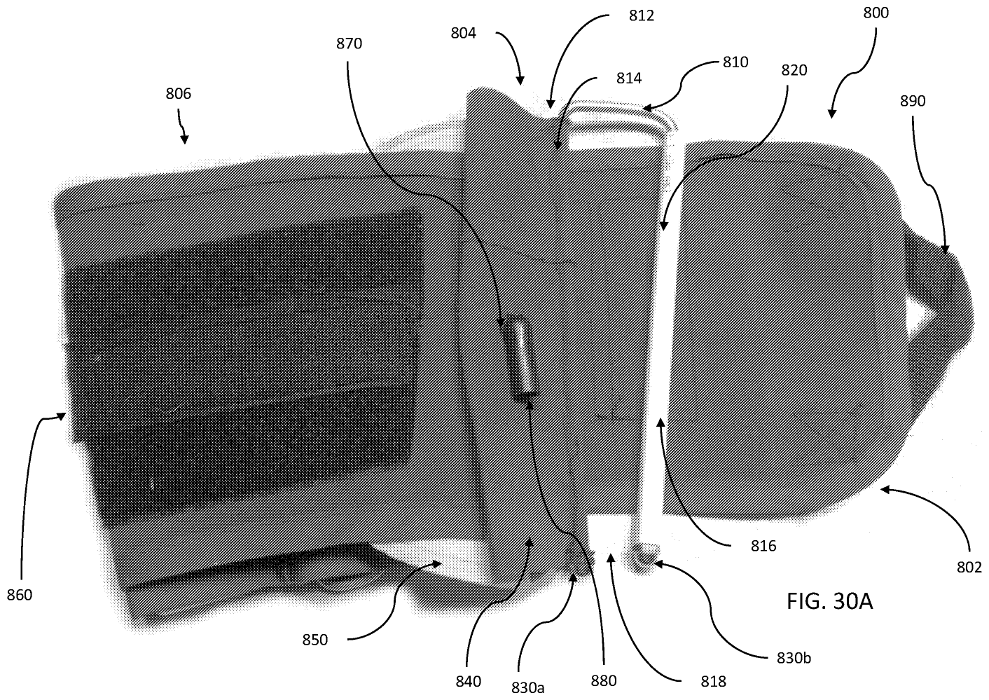

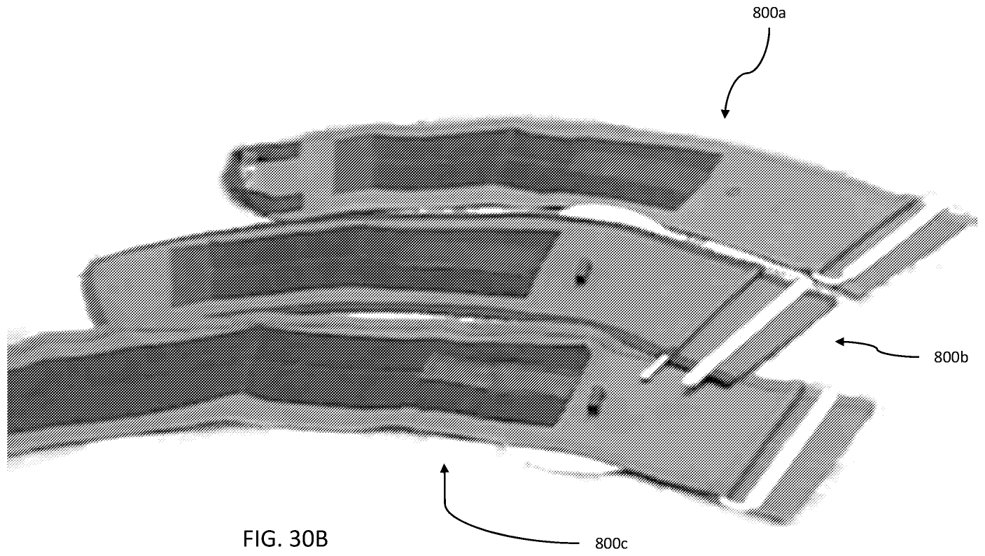

FIG. 30A illustrates an embodiment of a cuff 800 comprising a buckle 810. FIG. 30A illustrates a plurality of views of the cuff 800. As will be discussed below, in some embodiments, the buckle 810 is a split roller buckle that is configured to aid in installing and adjusting the cuff 800.

In some examples, the cuff 800 can include a body 806 having a first end 802 and a second end 804. In some examples, the cuff 800 can be made of any durable material such as nylon or bamboo. In some embodiments, the cuff 800 can be made of any flexible and non-stretch material. In some embodiments, the cuff 800 includes the buckle 810 at a first end 802 of the cuff 800. As illustrated in FIG. 30A, in some examples, the buckle 810 is a U-shape having a first arm 814 and a second arm 816. In some embodiments, the cuff 800 has an opening 812 at the first end 802 that is configured to allow the first arm 814 to extend through the first end 802 of the cuff 800. In some examples, the buckle 810 can form a roller 820 on the second arm 816. As will be discussed in more detail below, the roller 820 is configured to allow the cuff 800 to be easily and optimally secured to a target location on the patient. In some embodiments, the first arm 814 can be secured to the first end 802 of the cuff 800 and the second arm 816 can be secured to the roller 820 with securing portion 830a and securing portion 830b respectively. In some examples, the securing portion 830a and the securing portion 830b are removable. The securing portions 830a. 830b can, for example, be threaded, friction fit, snap-on, etc. such that the securing portion 830a and the securing portion 830b are easily removable. This can allow the body 806 of the cuff 800 to be washable. In some embodiments, the buckle 810 can be made of a material that does not creep under stress. This can allow the buckle 810 to withstand large amounts of force in retaining the cuff 800 against the target location on the patient at the required amount of pressure.

In some examples, the cuff 800 includes a fold 840 at the first end 802 of the cuff 800. The fold 840 can serve to protect the patient from the buckle 810 and to prevent pinching to the contact portion of the skin.

In some embodiments, the cuff 800 can include at least one opening 870 located on the body 806 of the cuff 800. In some examples, the opening 870 is configured to allow a connector 880 to extend through and provide a connection to a removable bladder 850. In some embodiments, the connector 880 is a tubular connector that provides a fluid connection to a removable air hose (not illustrated). In some embodiments, each of the bladders 850 can include a gripping material (not illustrated) on each side of the bladder 850. In some embodiments, this can help to prevent slippage of the bladder 850.

In order to help secure the cuff 800 to a target location on the body of the patient, the cuff 800 can include a securing material 860 that extends on a surface of the body 806 between the first end 802 and the second end 804. In some embodiments, the securing material 860 is located on an opposite surface of the cuff 800 as where the bladder 850 is attached. In some examples, the cuff 800 can include a handle 890 at a second end 804 of the cuff 800. As will be discussed in more detail below, the handle 890 can provide a hand-hold for the patient or user (e.g., person operating the ECP system) to wrap the cuff 800 around the target location of the patient and to tighten and/or secure the body 806 of the cuff 800 through the buckle 810.

As discussed above, the buckle 810 is configured to secure the cuff 800 to a target location on the patient's body. In some embodiments, the buckle 810 includes an 818 at one end of the buckle 810. This can enable the body 806 of the cuff 800 to slide into the opening 818 of the cuff 800. The opening 818 of the buckle 810 provides for quick adjustment of the cuff 800 and also reduces loosening of the cuff 800 during treatment. This can help to reduce set up time for patient treatment. As well, in situations where an emergency occurs (e.g., if the patient does not tolerate treatment well), each of the cuff 800 can be easily removed.

In some embodiments, the buckle 810 can be positioned over a portion of the bladder 850 (e.g. the center) as an additional aid for positioning the bladder 850 over the appropriate vasculature bed.

In some embodiments, the cuff 800 can have a variety of lengths and sizes to provide an appropriate fit for patients of different sizes. As an example, FIG. 30B illustrates a cuff 800a, cuff 800b, and cuff 800c—wherein each of the cuffs 800a, 800b, 800c has a different length. Cuff 800a illustrates a reverse side of the cuff (as compared to cuff 800b and cuff 800c) and illustrates the cuff 800 with the bladder 850 removed. As discussed above, the buckle 810 allows the cuff 800 to be easily adjustable and secured to the patient. The roller 820 on the buckle 810 allows the body 806 of the cuff 800 to be secured to the patient at any point along the length of the cuff 800. As no discrete “notches” are required to secure the cuff 800 to a patient, each version of the cuff 800 can be used on a wider range of patients. This can help to reduce the cost of treatment using the ECP system as fewer cuff sizes are needed. As well, the roller 820 on the buckle 810 allows each cuff 800 to be customized to the size of the target location of the patient as well as the type of pressure required for the specific treatment.

### Comparison of Two Example ECP Systems

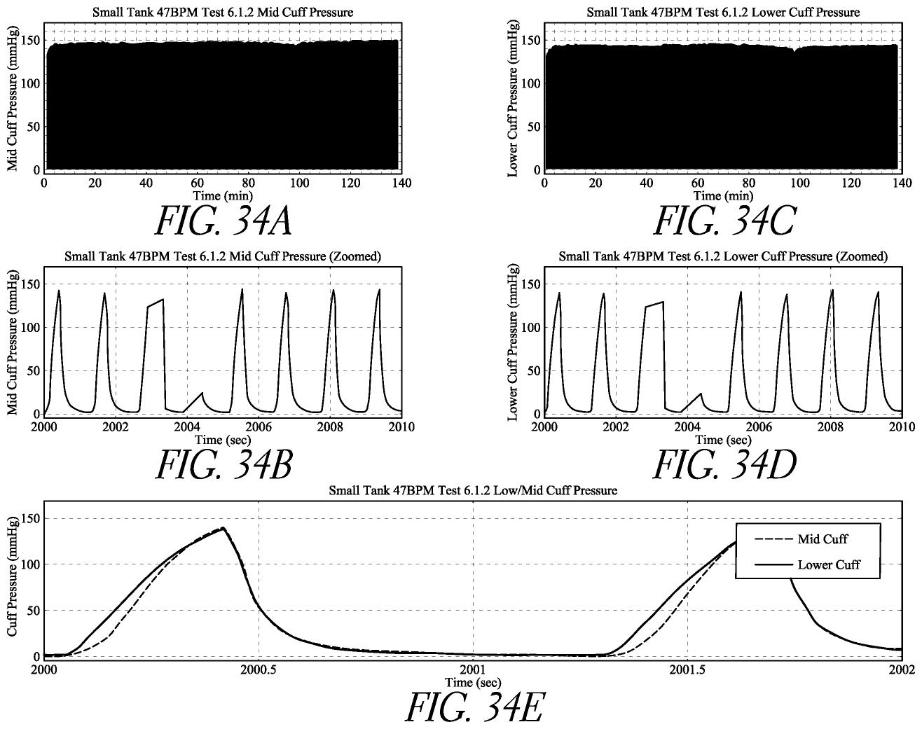

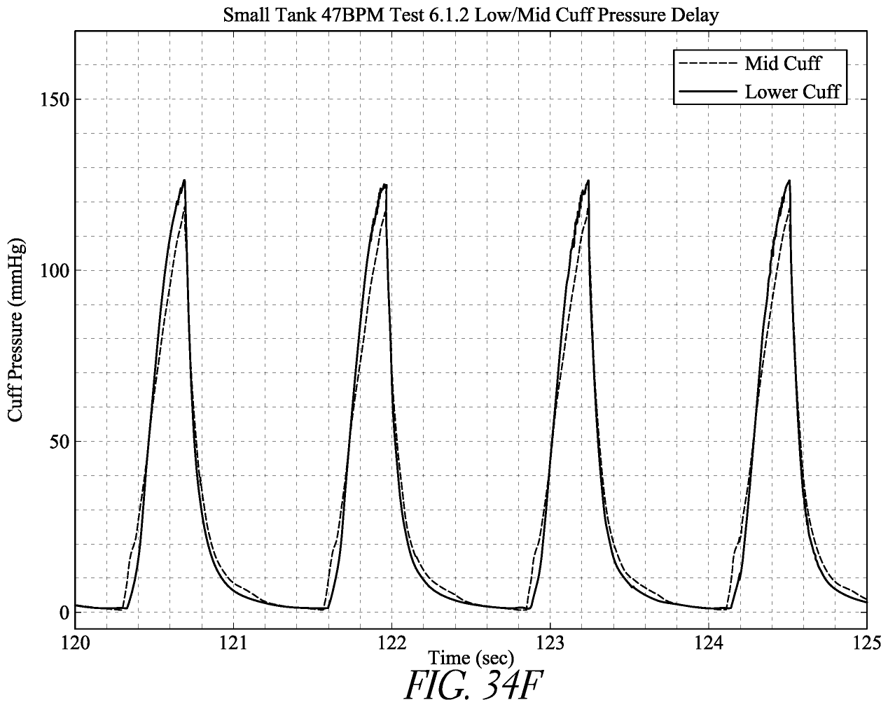

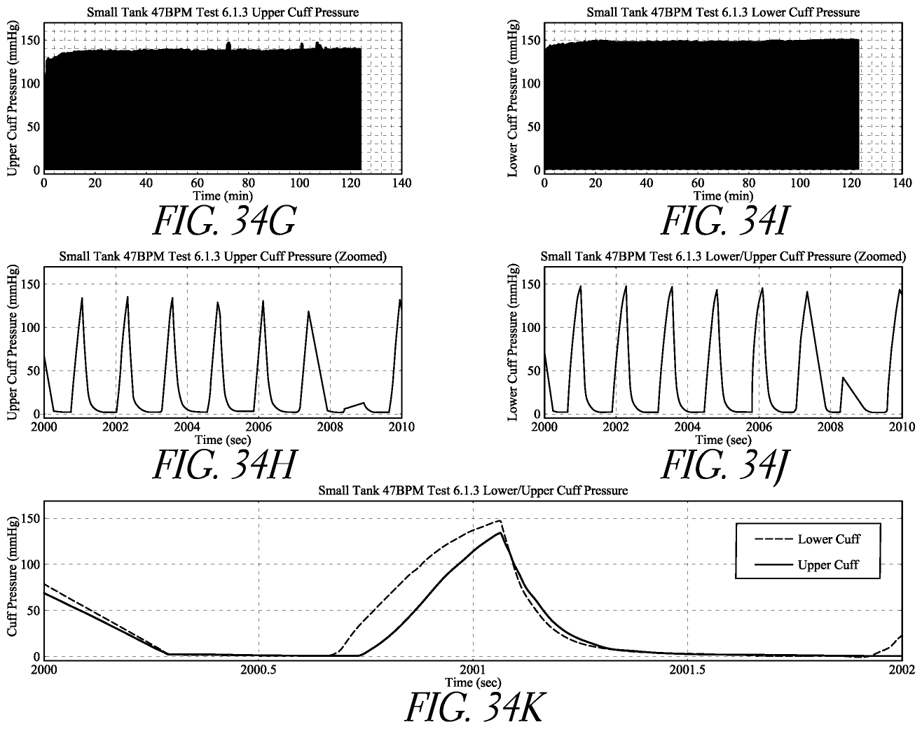

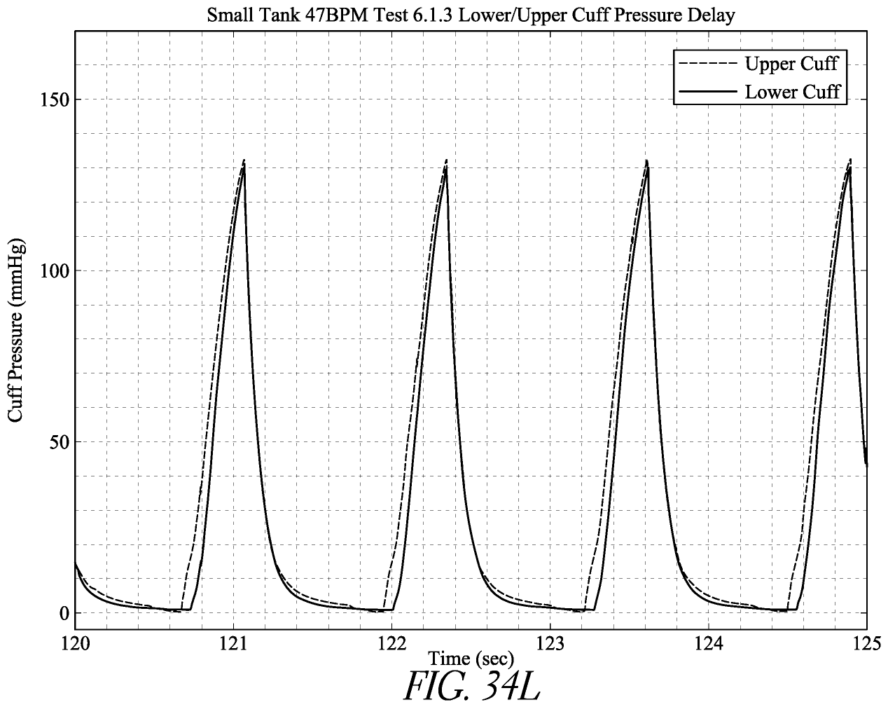

FIGS. 34A-34L, 35A-35L, 36A-36L, and 37A-37L illustrate a 2.6-gallon ECP system. The 2.6-gallon ECP system was tested at 47 cycles/min, 60 cycles/min, 75 cycles/min, and 87 cycles/min in order to mimic the performance of the two ECP systems on patients with a heart rate of 45 beats per minute (bpm), 60 bpm, 75 bpm, and 90 bpm respectively. Because of the simulation run, data could not be collected at the 45 cycles/min (45 bpm) and the 90 cycles/min (90 bpm) data points. The simulator was adjusted to move inwards from the boundary conditions to 47 cycles/min and 87 cycles/min in order to represent the data that would likely be seen at 45 cycles/min and 90 cycles/min.

Table 1 provides a summary of the tests that were conducted to represent how the 2.6-gallon ECP system is expected to perform at a patient heart rate of 45 bpm, 60 bpm, 75 bpm, and 90 bpm at various cuffs:

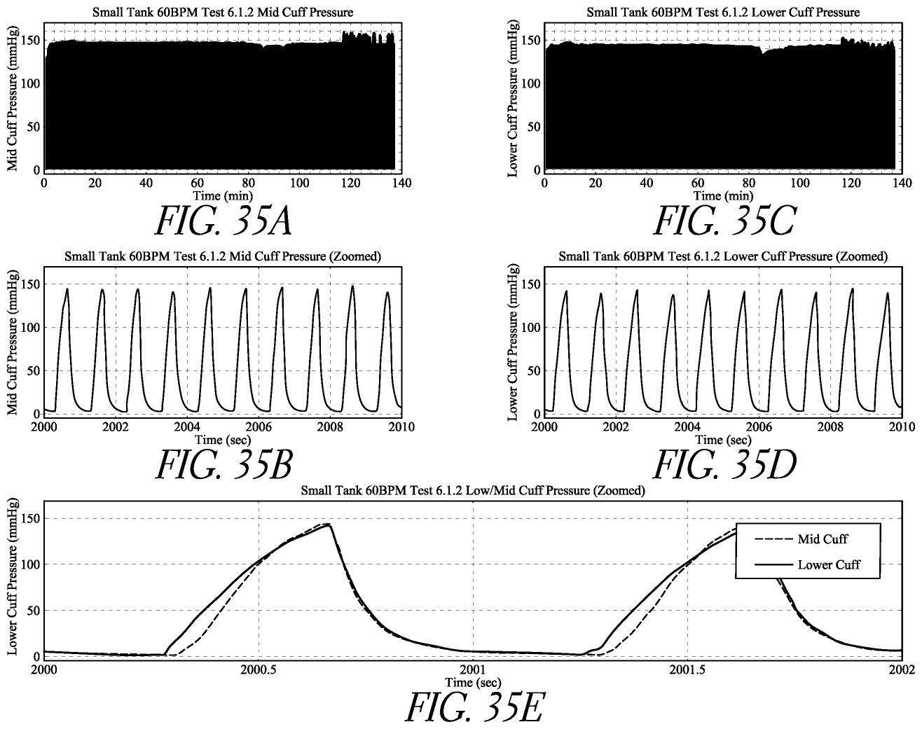

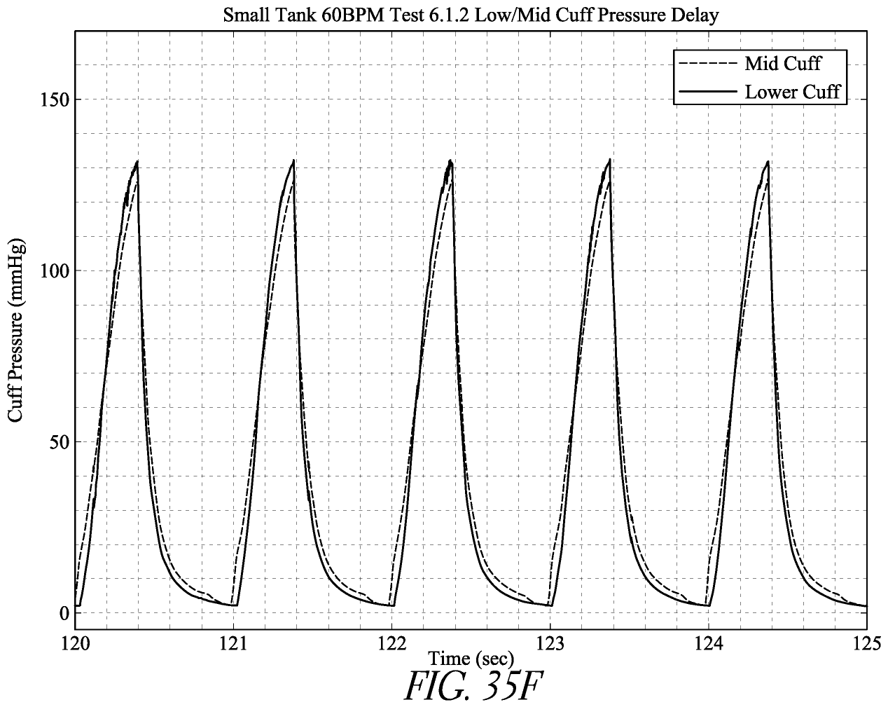

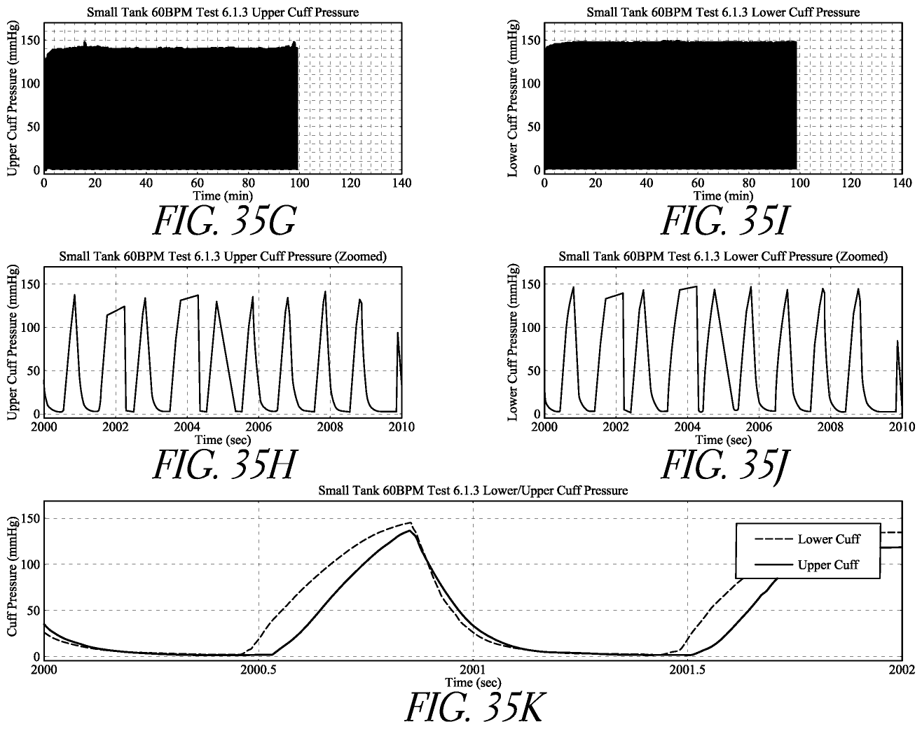

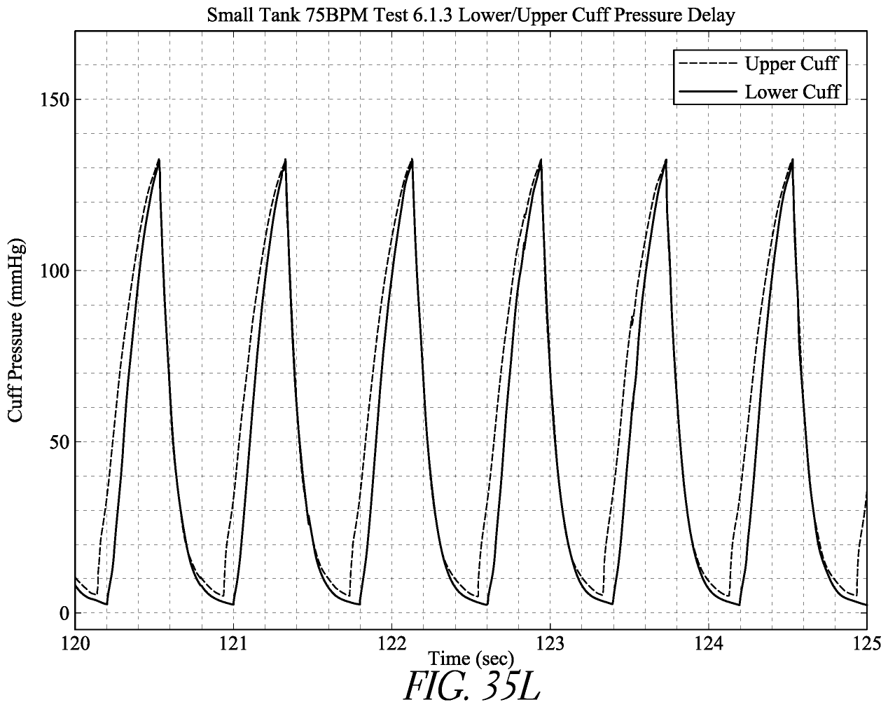

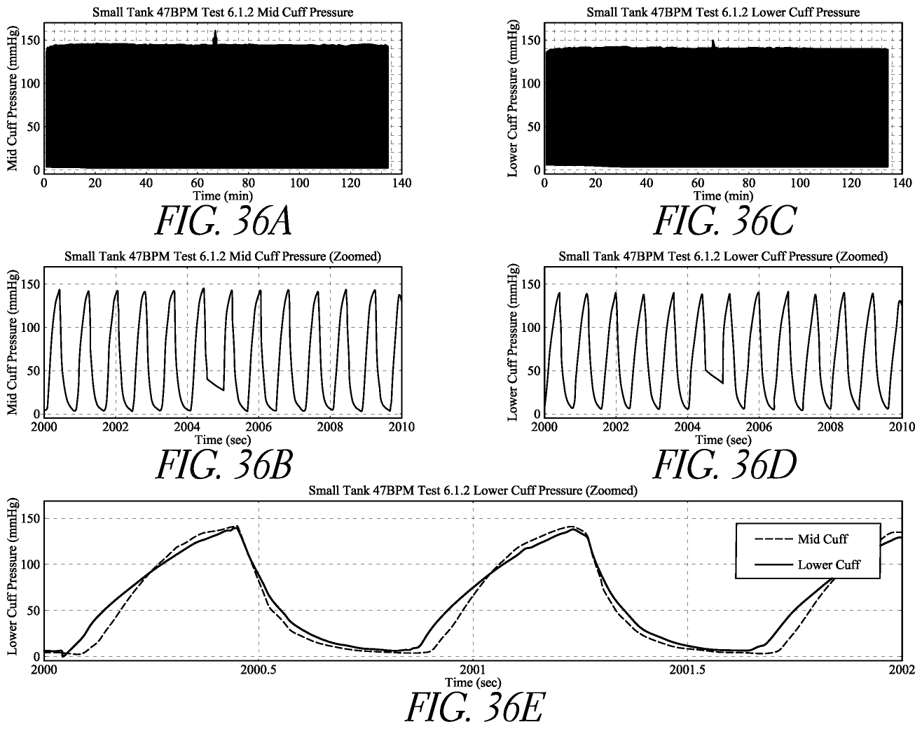

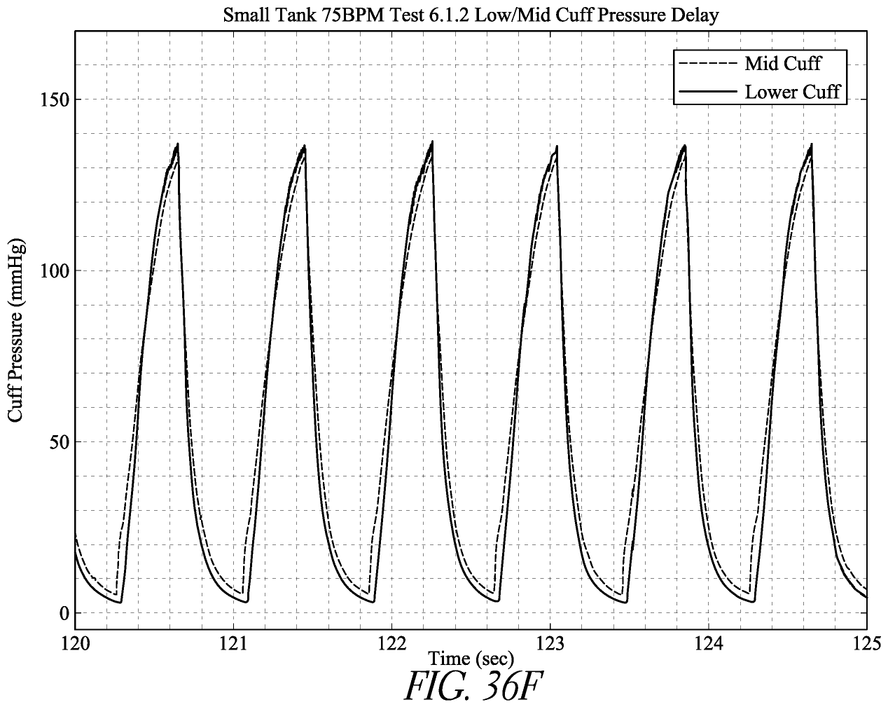

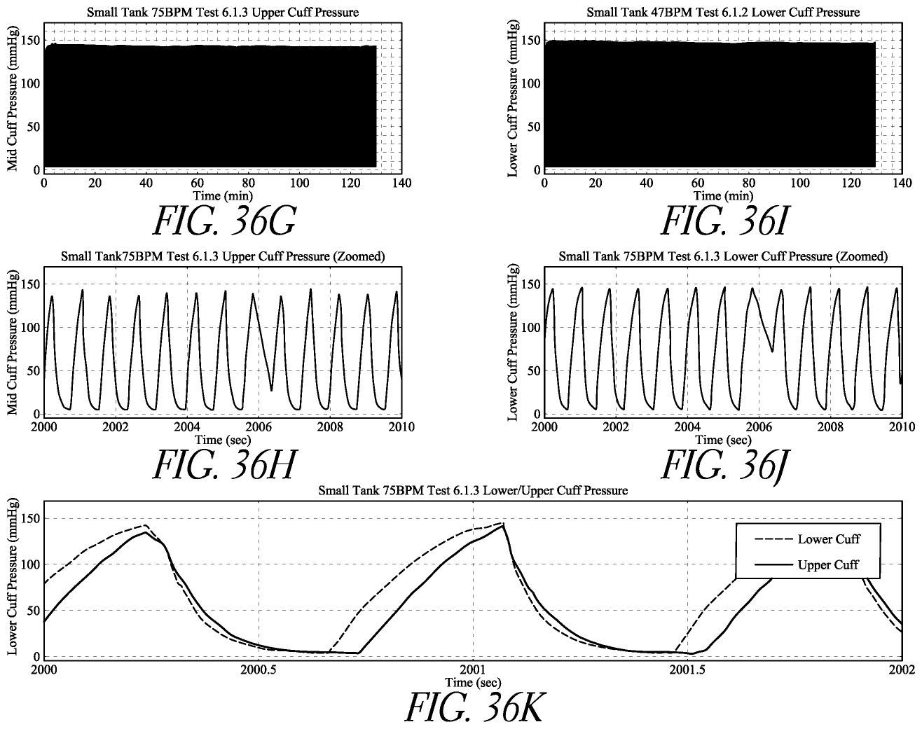

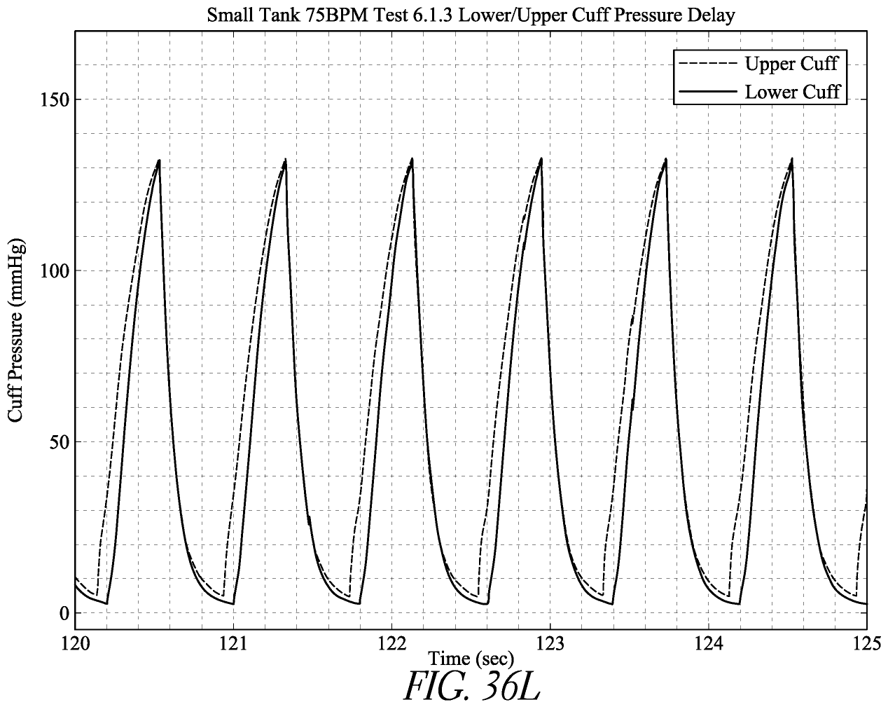

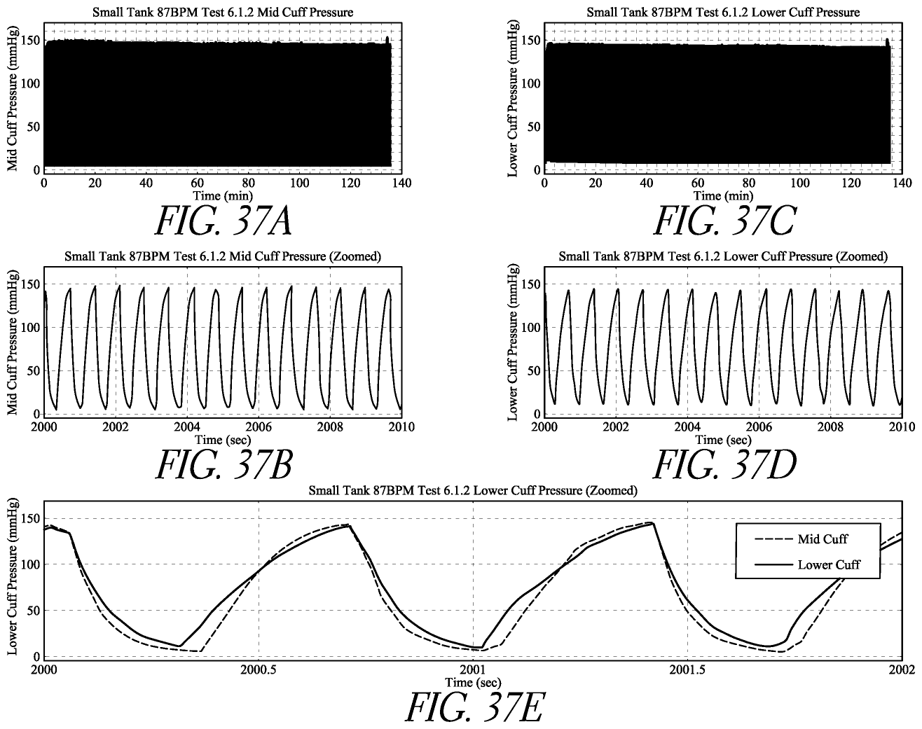

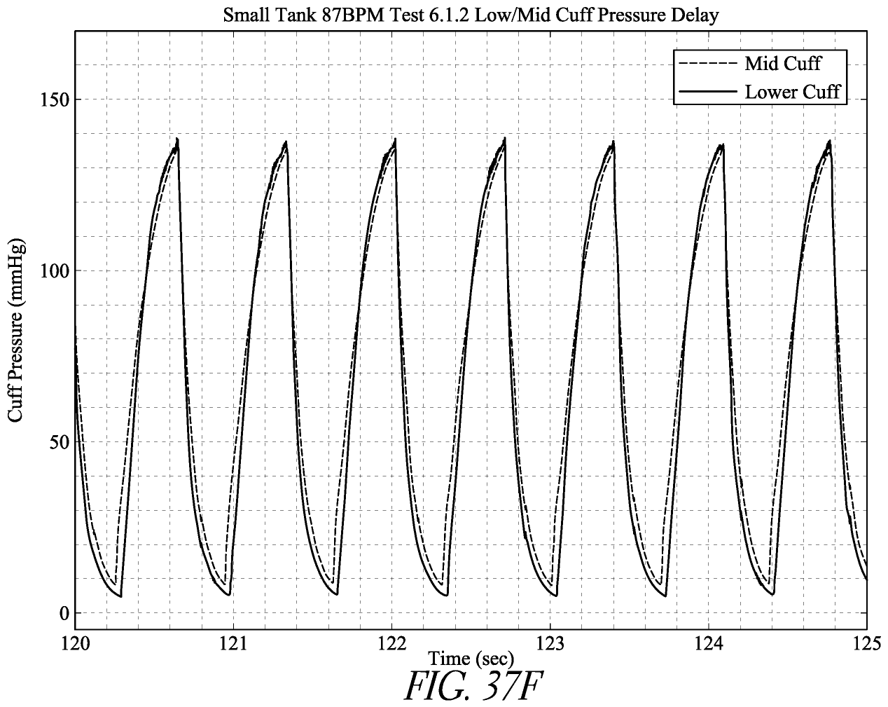

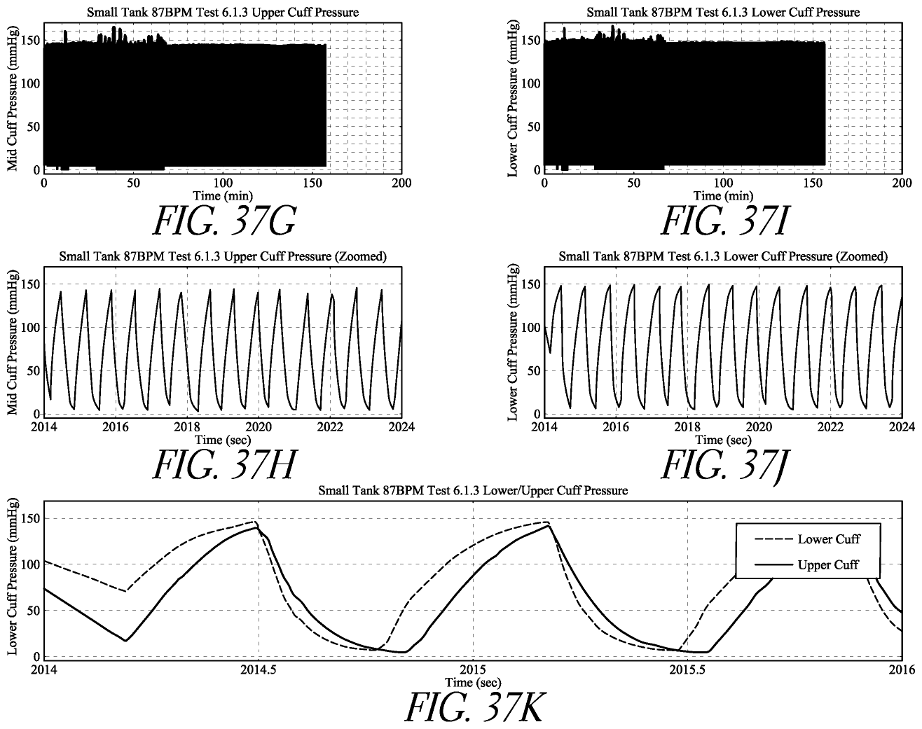

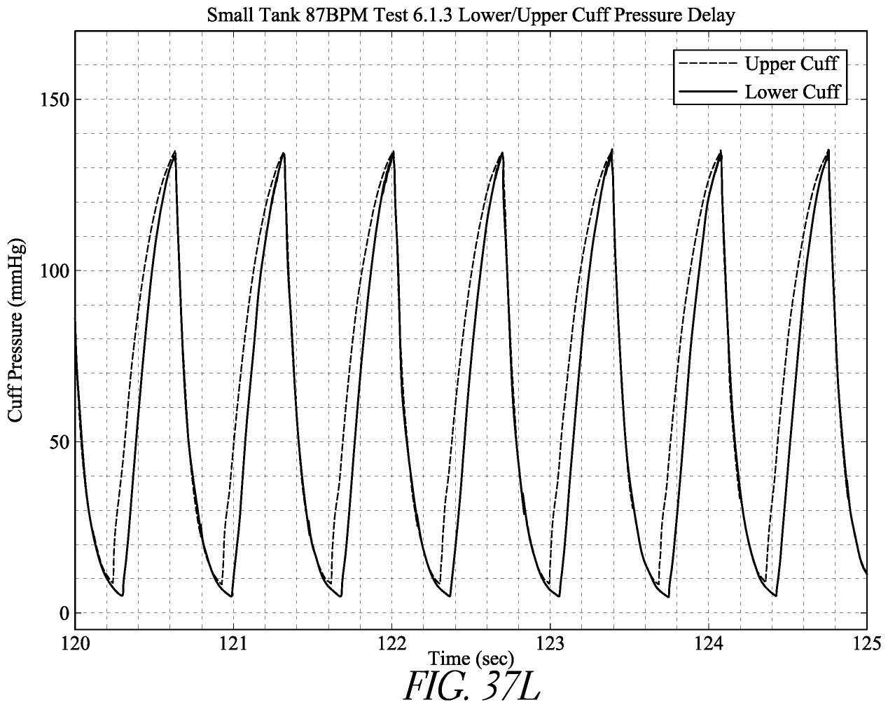

TABLE 1
Summary

| | Mid & Lower | Upper & Lower |
|---|---|---|
| | Cuff Pressure | Cuff Pressure |
| 45 bpm | FIGS. 34A-34F | FIGS. 34G-34L |
| (47 cycles/min) | | |
| 60 bpm | FIGS. 35A-35F | FIGS. 35G-35L |
| (60 cycles/min) | | |
| 75 bpm | FIGS. 36A-36F | FIGS. 36G-36L |
| (75 cycles/min) | | |
| 90 bpm | FIGS. 37A-37F | FIGS. 37G-37L |
| (87 cycles/min) | | |

Tables 2.1-2.5 provide a summary of the data generated from the tests conducted on the 2.6-gallon ECP system, intended to replicate the performance of the 2.6-gallon ECP system on a patient with a heart rate of 45 bpm, 60 bpm, 75 bpm, and 87 bpm.

Table 2.1 summarizes the peak pressure applied on the upper cuff, the middle cuff, and the lower cuff on the 2.6-gallon ECP system. As discussed above, the upper cuff can be placed on the buttocks, the middle cuff can be placed on the upper thigh, and the lower cuff can be placed on the lower thigh.

TABLE 2.1
Peak Pressure

| | Upper Cuff | Middle Cuff | Lower Cuff |
|---|---|---|---|
| | (Butt) | (Upper Thigh) | (Lower Thigh) |
| | [mmHg] | [mmHg] | [mmHg] |
| | | | FIGS. 34C-34D; |
| | FIGS. 34G-34H | FIGS. 34A-34B | 34I-34J |
| 45 bpm | 140 | 145 | 145 |
| (47 cycles/min) | | | |
| | | | FIGS. 35C-35D; |
| | FIGS. 35G-35H | FIGS. 35A-35B | 35I-35J |
| 60 bpm | 140 | 148 | 145 |
| (60 cycles/min) | | | |
| | | | FIGS. 36C-36D; |
| | FIGS. 36G-36H | FIGS. 36A-36B | 36I-36J |
| 75 bpm | 143 | 145 | 140 |
| (75 cycles/min) | | | |
| | | | FIGS. 37C-37D; |
| | FIGS. 37G-37H | FIGS. 37A-37B | 37I-37J |
| 90 bpm | 145 | 148 | 145 |
| (87 cycles/min) | | | |

In order to ensure consistent and reliable treatment, the ECP system should provide consistent pressure across the system. Table 2.1 illustrates that the peak pressure in each of the bladders on the upper cuff, the middle cuff, and the lower cuff were consistent and independent of heart rate. The data in Table 2.1 illustrates that, in the system tested, the pressures were very consistent within each of the bladders.

Table 2.2 summarizes the fill rate of each of the upper cuff, the middle cuff, and the lower cuff on the 2.6-gallon ECP system.

TABLE 2.2
Fill Rate

| | Upper Cuff | Middle Cuff | Lower Cuff |
|---|---|---|---|
| | (Butt) | (Upper Thigh) | (Lower Thigh) |
| | [mmHg] | [mmHg] | [mmHg] |
| | | | FIGS. 34C-34D; |
| | FIGS. 34G-34H | FIGS. 34A-34B | 34I-34J |
| 45 bpm | 0.395 | 0.375 | 0.375 |
| (47 cycles/min) | | | |
| | | | FIGS. 35C-35D; |
| | FIGS. 35G-35H | FIGS. 35A-35B | 35I-35J |
| 60 bpm | 0.411 | 0.381 | 0.341 |
| (60 cycles/min) | | | |
| | | | FIGS. 36C-36D; |
| | FIGS. 36G-36H | FIGS. 36A-36B | 36I-36J |
| 75 bpm | 0.398 | 0.405 | 0.320 |
| (75 cycles/min) | | | |
| | | | FIGS. 37C-37D; |
| | FIGS. 37G-37H | FIGS. 37A-37B | 37I-37J |
| 90 bpm | 0.379 | 0.381 | 0.335 |
| (87 cycles/min) | | | |

Table 2.2 illustrates that the system provides a consistent fill rate across the range of heart rates. The treatment is therefore applied consistently across the system as no set of cuffs are slower or faster than any other cuffs within the system.

Table 2.3 summarizes the exhaust rate of each of the upper cuff, the middle cuff, and the lower cuff on the 2.6-gallon ECP system.

TABLE 2.3
Exhaust Rate

| | Upper Cuff | Middle Cuff | Lower Cuff |
|---|---|---|---|
| | (Butt) | (Upper Thigh) | (Lower Thigh) |
| | [mmHg] | [mmHg] | [mmHg] |
| | | | FIGS. 34C-34D; |
| | FIGS. 34G-34H | FIGS. 34A-34B | 34I-34J |
| 45 bpm | 0.147 | 0.166 | 0.163 |
| (47 cycles/min) | | | |
| | | | FIGS. 35C-35D; |
| | FIGS. 35G-35H | FIGS. 35A-35B | 35I-35J |
| 60 bpm | 0.209 | 0.233 | 0.238 |
| (60 cycles/min) | | | |
| | | | FIGS. 36C-36D; |
| | FIGS. 36G-36H | FIGS. 36A-36B | 36I-36J |
| 75 bpm | 0.290 | 0.312 | 0.345 |
| (75 cycles/min) | | | |
| | | | FIGS. 37C-37D; |
| | FIGS. 37G-37H | FIGS. 37A-37B | 37I-37J |
| 90 bpm | 0.413 | 0.483 | 0.462 |
| (87 cycles/min) | | | |

Table 2.2 illustrates that the system provides a consistent exhaust rate across the range of heart rates. In spite of the compression placed on the bladders by the body (e.g., by the patient sitting on the cuffs), each of the bladders within the system were able to provide an exhaust rate that was similar in spite of the different locations each of the cuffs were placed on. Table 2.3 therefore illustrates that treatment is applied consistently at each heart rate. As shown, no set of cuffs exhausts slower or faster than any other cuffs within the system.

Table 2.4 summarizes the time delay between the bottom cuff and the middle cuff and the time delay between the bottom cuff and the top cuff on the 2.6-gallon ECP system.

TABLE 2.4
Time Delay

| | Lower Cuff to | Lower Cuff to |
|---|---|---|
| | Middle Cuff | Upper Cuff |
| | [ms] | [ms] |
| | FIGS. 34A-34F | FIGS. 34G-34L |
| 45 bpm | 32 | 60 |
| (47 cycles/min) | | |
| | FIGS. 35A-35F | FIGS. 35G-35L |
| 60 bpm | 30 | 64 |
| (60 cycles/min) | | |
| | FIGS. 36A-36F | FIGS. 36G-36L |
| 75 bpm | 32 | 64 |
| (75 cycles/min) | | |
| | FIGS. 37A-37F | FIGS. 37G-37L |
| 90 bpm | 32 | 64 |
| (87 cycles/min) | | |

In some embodiments, the time delay between initiating the filling of cells is expected to be 40 ms from the lowest cell (e.g., the lower cuff) to the middle cell (e.g., the middle cuff). In some examples, the time delay between the initiating of filling of cells is expected to be 80 ms from the lowest cell (e.g., the lower cuff) to the upper cell (e.g., the upper cuff). As seen in the data of Table 2.4, the time delays that can be less than the anticipated 40 ms and 80 ms—the time delay from the lower cuff to the middle cuff can be approximately 32 ms and the time delay from the lower cuff to the upper cuff can be approximately 64. As expected, the time delay from the lower cuff to the upper cuff is approximately two times the time delay from the lower cuff to the middle cuff.

While embodiments of this invention have been particularly shown and described with references to embodiments thereof, it will be understood by those skilled in the art that various changes in form and details may be made therein without departing from the scope of the invention. For all of the embodiments described above, the steps of the methods need not be performed sequentially.

It is to be understood that the term “embodiment” as used herein refers to an aspect or implementation of the invention disclosed herein, and that embodiments may be combined with one another.

Unless the context requires otherwise, use of the word “comprise” and variations thereof, such as, “comprises” and “comprising” in the description and claims is open ended and synonymous with “including” or “including but not limited to” and intended to also include the narrower terms “consisting of” and “consisting essentially of,” the latter term meaning that the scope is limited to the recited elements or steps and any others that do not materially affect the basic and novel characteristics of what is already recited.

1. A method for performing external counterpulsation comprising:
providing an external counterpulsation apparatus having a first compression member, a second compression member, and a third compression member;
attaching the first compression member, the second compression member, and the third compression member to three treatment locations on a patient;
pressurizing the first compression member for a first period of time;
depressurizing the first compression member for a second period of time and pressurizing the second compression member for a third period of time, wherein the second period of time is longer than the first period of time;
depressurizing the second compression member for a fourth period of time and pressurizing the third compression member, wherein the fourth period of time is longer than the third period of time; and
depressurizing the third compression member for a fifth period of time.

2. The method of claim 1, wherein pressurizing the second compression member can occur while the first compression member is pressurized, and wherein the third period of time of pressurizing the second compression member overlaps more with the second period of time of depressurizing the first compression member than the first period of time of pressurizing the first compression member.

3. The method of claim 1, wherein pressurizing the third compression member can occur while the second compression member is pressurized, and wherein the fifth period of time of pressurizing the third compression member overlaps more with the fourth period of time of depressurizing the second compression member than the third period of time of pressurizing the second compression member.

4. The method of claim 1, wherein pressurizing the second compression member can overlap with the first period of time of pressurizing the first compression member and with the fifth period of time of pressurizing the third compression member.

5. The method of claim 1, wherein at least two of the first, second, and third compression members are pressurized at the same time, and wherein at least two of the first, second, and third compression members are depressurized at the same time.

6-31. (canceled)

32. A method for performing external counterpulsation on a patient, the method comprising:
providing an external counterpulsation apparatus having a first compression member, a second compression member, and a third compression member;
attaching the first compression member on a lower thigh of the patient, attaching the second compression member on an upper thigh of the patient, and attaching the third compression member on a buttock of the patient;
pressurizing the first compression member for a first period of time;
depressurizing the first compression member for a second period of time and pressurizing the second compression member for a third period of time, wherein the second period of time is longer than the first period of time;
depressurizing the second compression member for a fourth period of time and pressurizing the third compression member, wherein the fourth period of time is longer than the third period of time; and
depressurizing the third compression member for a fifth period of time.

33. The method of claim 32, wherein pressurizing the second compression member can occur while the first compression member is pressurized, and wherein the third period of time of pressurizing the second compression member overlaps more with the second period of time of depressurizing the first compression member than the first period of time of pressurizing the first compression member.

34. The method of claim 32, wherein pressurizing the third compression member can occur while the second compression member is pressurized, and wherein the fifth period of time of pressurizing the third compression member overlaps more with the fourth period of time of depressurizing the second compression member than the third period of time of pressurizing the second compression member.

35. The method of claim 32, wherein pressurizing the second compression member can overlap with the first period of time of pressurizing the first compression member and with the fifth period of time of pressurizing the third compression member.

36. The method of claim 32, wherein at least two of the first, second, and third compression members are pressurized at the same time, and wherein at least two of the first, second, and third compression members are depressurized at the same time.

37. The method of claim 32, wherein a first delay interval exists between sequential inflation of the first compression member, wherein a second delay interval exists between sequential inflation of the second compression member, and wherein a third delay interval exists between sequential inflation of the third compression member.

38. The method of claim 32, wherein at least one of the first delay interval, the second delay interval, and the third delay interval is a percentage of the patient's heartrate.

39. The method of claim 38, wherein at least one of the first delay interval, the second delay interval, and the third delay interval changes with a decrease or increase of the patient's heartrate.

40. The method of claim 32, wherein the patient has a heart rate less than 90 beats per minute.

41. The method of claim 32, wherein the pressurization of the first compression member is to a pressure less than 240 mmHg.

42. The method of claim 32, wherein the pressurization of the second compression member is to a pressure less than 240 mmHg.

43. The method of claim 32, wherein the pressurization of the third compression member is to a pressure less than 240 mmHg.

44-61. (canceled)
